(19) United States
(12) Patent Application Publication
(10) Pub. No.: US 2024/0183076 A1
(43) Pub. Date: Jun. 6, 2024

(54) HIGH THROUGHOUT SCREENING IN DROPLETS

(71) Applicant: Novartis AG, Basel (CH)

(72) Inventors: Asitha Adrian ABEYWARDANE, Cambridge, MA (US); Tushar Dattu APSUNDE, Poway, CA (US); Gianluca Nicolas ETIENNE, Boston, MA (US); Alessia GAMBARDELLA, Basel (CH); James Kevin MAINQUIST, San Diego, CA (US); Andrew J. MEYER, Solana Beach, CA (US); Brian MINIE, North Grafton, MA (US); Steven PAULA, Boston, MA (US); Dwayne A. L. VICKERS, Oceanside, CA (US); Ken YAMADA, Chestnut Hill, MA (US)

(21) Appl. No.: 18/550,004

(22) PCT Filed: Mar. 9, 2022
(86) PCT No.: PCT/IB2022/052124

§ 371 Date: Sep. 11, 2023

Related U.S. Application Data
(60) Provisional application No. 63/160,641, filed on Mar. 12, 2021.
(60) Provisional application No. 63/291,637, filed on Dec. 20, 2021.

(51) Int. Cl. C40B 40/06; B01L 3/00; C08L 87/00

(52) U.S. Cl. CPC C40B 40/06; B01L 3/502761; B01L 3/502784; C08L 87/005; B01L 2200/0652; B01L 2300/0829; B01L 2400/0415

(57) ABSTRACT

The present disclosure generally relates to compositions, methods, sorters, systems, devices and uses for screening for bioactive substances in emulsion droplets. In some embodiments, the compositions are a continuous phase formulation for stable emulsions, In some embodiments, the methods are for preparing a monodisperse polyethylene glycol acrylamide (PEGA) co-polymer resin, or for preparing a core-shell bead. In some embodiments, the systems and devices include a sorter, comprising an inlet channel, first and second outlet channels meeting the inlet channel at a junction, and first and second electrodes proximate respective first and second sides of the junction sorter. In some embodiments, the systems and devices include a sorter, comprising a microwell array plate configured to host one microdroplet per microwell, a fluorescence microscope, an imager configured to automatically image assay droplets and identify desired droplets, and an automated microcapillary-based droplet sampling device configured to continuously deposit desired droplets to hit wells.

### FIELD

The present disclosure relates generally to methods, compositions, sorters, systems, uses, and devices for screening for bioactive substances in emulsion droplets. In particular, the present disclosure relates generally to methods, compositions, sorters, systems, uses and devices for emulsion formulation, encodable compound beads and high-throughput droplet selection, as individual components and as aggregate platform.

### BACKGROUND

The present disclosure relates generally to methods, compositions, sorters, systems, uses, and devices for screening of bioactive substances in emulsion droplets. The present disclosure also relates to microfluidic encapsulation, namely, a microencapsulated droplet containing a cell and a barcode compound bead. Such microencapsulated droplets have applications in diverse fields of research and analysis, which include, but are not limited to, high-throughput screening of compounds within a microencapsulated droplet, conducting a series of chemical reactions within a microencapsulated droplet and analyzing cell culture conditions.

In robotic-based high-throughput screening (HTS) to find bioactive substances, the screening compartment can be provided by microtiter well plates that can contain up to tens of microliters of reaction volume and can be easily tracked through plate maps and plate barcodes. However, the process can be expensive, and resource and time consuming, (Inglese et al. 2007; MacArron et al. 2011; Ross 2017). HTS of a large compound set is typically performed at a single dose due to the prohibitive cost, which can result in high false-positive rates and inability to distinguish non-hits from weak but robust hit molecules.

The massively miniaturized, picoliter compartments realized by droplet microfluidics can reduce the scale of compound screening to the size of single cells, thereby addressing many of the issues with robotic-based high-throughput screening stated above. Cellular assays in HTS can require development of biological assays in artificial immortalized cell lines to provide sufficient quantity, requiring downstream hit triaging utilizing more disease relevant assays such as with induced pluripotent stem cell (iPSC) derived or primary diseased state cells that are difficult to scale. There are reports of cellular screens performed in micro-droplets of picoliter volume. However, such methods almost invariably have been reported in cases where the diversity source is biological molecules such as proteins, peptides, oligonucleotides and even whole organisms such as bacteria that are inherently hydrophilic. Droplet based cellular screens with diversity sources such as libraries of more hydrophobic organic compounds are less common, due to challenges such as retention of compounds for the duration of the assay, delivery of a barcoded compound library, for example, a fluorogenically silent barcoded compound library, at high efficiency, and reliable selection of hit droplets at high frequency. As such, it is important that in the cellular assay context compounds can be retained in the droplets, and that compound beads are introduced efficiently into droplets in cell-compatible assay media.

Precise delivery of individual library members into single encoded droplets can be challenging. Converting plate-based compound collection into encoded compound droplets can present inherent challenges with scalability and/or compound retention. Alternatively, DNA-encoded one-bead one-compound library loaded through a releasable linker can deliver an individual library member into a single droplet (MacConnell, Price, and Paegel 2017; MacConnell et al. 2015). The method can substantially reduce the requirement for compound retention from the point of in-situ release until the point of assay readout, while at the same time harnessing the power of combinatorics and achieving droplet and compound encoding. However, these platforms have technological challenges in the pharmaceutical context. To date, no library beads have been demonstrated to simultaneously satisfy the following properties for cellular compound screening in droplets: 1) monodispersity, 2) biocompatibility, 3) suspendability and compressibility in aqueous media, 4) low background auto-fluorescence, and 5) compatibility with a wide range of library chemistries in organic phase.

TentaGel® (Rapp Polymere) is a PEG-grafted polystyrene-backbone polymer that has been utilized in previous reports of DNA-encoded one-bead one-compound library (MacConnell et al., 2015, 2017). It has also been widely employed in solid-phase organic synthesis (Toy, 2004). However, it is also known for its autofluorescence (Townsend et al., 2010) and can aggregate as clumps in aqueous media particularly when loaded with organic molecules that are relatively hydrophobic.

PEGA resin is PEG cross-linked polyacrylamide backbone hydrogel beads. PEGA can share the non-fluorescent, hydrophilic properties of the polyacrylamide, while also exhibiting excellent swelling in organic solvents and broader organic reaction compatibility of the PEG-based polymer resins. The first compositions of PEGA resins were reported by Meldal and colleagues in 1990s (Auzanneau et al., 1995; Meldal, 1992). At least one composition of PEGA resin with various functional handles is commercially available (Novabiochem/Merck-Millipore). However, this commercially available resin does not meet the criteria as a compound delivery matrix for screening in droplets of 10-200 micron in diameter, including their relatively large size (150-300 micron in diameter) and polydispersity.

Droplet-based microfluidics can include fluorescence-activated droplet sorting (FADS). FADS can have advantages over traditional FACS approaches. For example, FADS can include integration of assays involving single-cell manipulation, real time analysis of single cells or sequential cell treatments and final detection, or a combination thereof (Caen, O. et al, 2019). Furthermore, FADS also can allow for implementation of complex cell assays and can reduce sample amounts and eliminate waste. To date there have been a variety of different FADS approaches such as pneumatic, acoustic, thermal, magnetic and electric actuation (Xi, H. et al). However, to date, there is no off-the-shelf droplet sorter that is able to perform cellular compound screening in droplets reliably under continuous operation, to achieve robust high-throughput screens, and have flexibility for multiple wavelength readouts and the corresponding ratiometric sorting.

In addition to FADS, arraying droplets can provide an additional flexibility for assay readout. Further manipulation and selecting of desired droplets remains unexploited.

Hence, there is a need in the art to provide an improved droplet platform with sufficient compound retention for cellular assays in HTS, as well as a suitable library bead format for efficient encapsulation in droplets for higher throughput, and, reliable and efficient sorting method for the hit droplets.

The present disclosure overcomes previous shortcomings in the art by providing new methods, compositions, sorters, systems, uses, and devices for screening for bioactive substances in emulsion droplets.

### BRIEF SUMMARY

It is an object to provide a droplet platform that allows for efficient cellular compound screening in droplets. This capability, coupled with established detection methods, provides an important tool for precise, cellular analysis at single cell scale that can reveal new biological mechanisms and responses at unprecedented sensitivities and/or scale that can be studied, tuned and utilized in the pharmaceutical industry. An additional object is to provide a droplet platform which allows for efficient cellular compound screening in droplets without excessive use of reagents or cells. This is of particular importance for screens using rare cells in screening of a large compound library.

The present disclosure is based on the findings that a significantly higher compound retention in droplets is achieved by using a continuous phase formulation as described herein. In particular, the continuous phase formulation comprises at least one fluorous dispersion oil, wherein the fluorous dispersion oil has an average fluorine content of about 70 wt % or more; and a droplet stabilizer comprising an emulsifier selected from the group consisting of a triblock copolymer, a diblock copolymer, a fluorinated silica nanoparticle, and a combination thereof.

Provided herein are compositions, methods, sorters, devices, uses and systems that can be used to screen compound libraries. In some embodiments, the methods, systems and devices can be used to screen an individual cell, or a plurality of individual cells. In some embodiments, the methods, systems and devices can be used to screen a compound library. In some embodiments, the methods and devices provided herein can be used to screen a compound library delivered as encoded beads. In some embodiments, the methods, systems and devices provided herein can be used to screen a compound library delivered as encoded beads and released in picoliter droplet compartments, which can scale down plate-based high-throughput screens by many orders of magnitude (FIGS. 1A and 1B). In some examples, the systems and devices can include an overall platform and/or individual components.

In some embodiments, assay compartments can be generated as either water-in-oil (w/o) single emulsions or water-in-oil-in-water (w/o/w) double emulsions. FIGS. 2A and 2B representationally depict a water-in-oil (w/o) single emulsion droplet (FIG. 2A) and a water-in-oil-in-water (w/o/w) double emulsion droplet (FIG. 2B). As illustrated in FIG. 2A, a water-in-oil (w/o) single emulsion droplet (189) can include an aqueous phase (180), an oil continuous phase (181), and an aqueous-oil interface (182). Aqueous phase (180) can include assay mixture (183), and barcoded compound bead (184). As illustrated in FIG. 2B, a water-in-oil-in-water (w/o/w) double emulsion droplet (199) can include an aqueous phase in the core (190), surrounded by an oil phase (192), which is in turn surrounded by an outer aqueous continuous phase (191). Aqueous phase (190) can include assay mixture (193) and barcoded compound bead (194). For cellular assays, the droplet size can be such that sufficient nutrient is available for the encapsulated cell or cells for the duration of the assay; for example, between 10-200 micron in diameter for screening human cells that range from 5 to 100 micron in diameter. For bacterial, cell-free or biochemical assays, the droplet size can be selected from a wider range, for example from 1 to 200 micron in diameter.

In some embodiments of compositions, methods, uses, devices, sorters, and systems provided herein, the continuous phase can be any oil that is immiscible with water, such as mineral oil, hydrocarbon oil, silicone oil or fluorous oil. In some embodiments, the continuous phase can be a blend of fluorous oil, which can achieve optimal compound retention while maintaining sufficient oxygen permeability, biocompatibility and mechanical stability for a given assay buffer system. Examples of fluorous oil include, but are not limited to; perfluorocarbons such as perfluorooctane, perfluoroheptane, perfluorohexane (FC-72), perfluoro-1,3-dimethyl-cyclohexane, octadecafluorodecahydronaphthalene (perfluorodecalin); perfluorinated oils such as perfluoro 2-butyltetrahydrofuran, perfluoro-N-methylmorpholine (FC-3284), perfluorotripentylamine (FC-70), perfluorotributylamine (FC-43), perfluorotripropylamine (FC-3283), a perfluorotributylamine and perfluoro(dibutylmethylamine) mixture (FC-40); and hydrofluoroethers such as 2-(trifluoromethyl)-3-ethoxydodecafluorohexane (HFE-7500), ethyl perfluorobutyl ether (HFE-7200), 3-methoxyperfluoro(2-methylpentane) (HFE7300), a methyl perfluoroisobutyl ether/methyl perfluorobutyl ether mixture, a mixture of methoxynonafluorobutane and methoxynonafluoroisobutane (HFE7100), methoxy-nonafluorobutane and methoxyheptafluoropropane (HFE7000).

Droplets can be stabilized by any emulsifier that is soluble in the continuous phase. In some embodiments, the alkyl modified, branched silicone emulsifier KF-6038 (lauryl PEG-9 polydimethylsiloxyethyl dimethicone) can be present in a continuous phase that is silicone/mineral or squalene oil. In some embodiments, the emulsifier is a di- and/or tri-block co-polymer such as those consisting of perfluorinated polyether (PFPE) and polyethylene glycol (PEG) and/or polypropylene glycol (PPG). The di- and tri-block co-polymers can be optionally blended. In some embodiments, the emulsifier can be a partially fluorinated silica nanoparticle. In some embodiments, the emulsifier can be any combination of emulsifiers described herein. For example, the emulsifier described herein can be optionally blended with partially fluorinated silica nanoparticles to enhance its properties.

In some embodiments, provided herein are compositions, methods, uses, sorters, systems and devices for reducing droplet cross-contamination. In some embodiments, droplet cross-contamination can be reduced after droplet generation. In some embodiments, droplet cross-contamination can be reduced by exchanging a emulsifier loaded fluorinated oil continuous phase with a emulsifier-free fluorinated oil continuous phase, a pickering emulsifier loaded fluorinated oil continuous phase, or a combination thereof.

It is understood that, as described herein, an “emulsifier” can be, or can include, a surfactant, such as a surfactant described herein.

An “emulsion” as used herein, is a stable mixture of at least two immiscible liquids. In general, immiscible liquids tend to separate into two distinct phases. An emulsion is thus stabilized by the addition of a “droplet stabilizer” or “surfactant” or “emulsifier” which functions to reduce surface tension between the at least two immiscible liquids and/or to stabilize the interface. In some embodiments, emulsion described herein includes a discontinuous or disperse phase (i.e., the isolated phase stabilized by a surfactant) formed of an aqueous substance. The continuous phase may be formed of a fluorous dispersion oil (e.g., a fluorocarbon). The present disclosure provides, in some embodiments, a water-in-oil (w/o) single emulsion or a water in oil-in-water (w/o/w) double emulsion having a disperse aqueous phase and a fluorocarbon continuous phase. In some particular embodiments, the emulsions described herein are mircoemulsions. In some cases, the microemulsion may include droplets having an average diameter of about 10-200 micrometer, or in some instances 50-100 micrometer.

As used herein “droplet” means an isolated aqueous phase within a continuous phase having any shape, for example cylindrical, spherical, ellipsoidal, irregular shapes, etc. Generally, in emulsions of the invention, aqueous droplets are spherical or substantially spherical in a fluorocarbon, continuous phase.

As used herein, “emulsifier” or “surfactant” defines a molecule that, when combined with a first component defining a first phase, and a second component defining a second phase, will facilitate and/or stabilize assembly of separate first and second phases. The emulsifier may be a triblock copolymer, a diblock copolymer, a fluorinated silica nanoparticle or a mixture thereof. The diblock and triblock copolymers typically comprise one or more main fluorophilic chain(s) where one or both ends of the chain is soluble in the continuous phase of the emulsion and one or more chains that are not soluble in the continuous phase of the emulsion (e.g. those chains may be soluble in the aqueous phase). For instance, a surfactant may be a multi-block surfactant (e.g., ABABABA . . . ), where one component of the chain (e. g., “A”) is soluble in the fluorous phase and another component of the chain (e. g., “B”) is soluble in the aqueous phase.

As used herein, a multi-block surfactant is a surfactant having an alternating copolymeric structure or an (A-B) structure, i.e., ABA, ABAB, ABABA, ABABABA, etc.). In some cases, one block may be soluble in the fluorous phase of the emulsion and one block may be soluble in the aqueous phase of the emulsion. In still other cases, additional components may be present within the surfactant. For example, a multi-block surfactant may have other groups present within its polymeric structure, for example, linking moieties connecting A and B, e. g., (A-X-B-)ₙ, (A-X¹-B-X²)ₙ, or the like, where “X” represents a covalent bond or a linking moiety, as described below, and X¹ and X², where present, may be the same or different.

As used herein, and unless stated otherwise, a “fluorophilic” component or chain, e.g. in the context of an emulsifier as defined above, comprises any fluorinated compound such as a linear, branched, cyclic, saturated, or unsaturated fluorinated hydrocarbon, ether or amine. The fluorophilic component can optionally include at least one heteroatom (e.g., in the backbone of the component, e.g. O). In some cases, the fluorophilic component may be highly fluorinated, i.e. at least 30%, at least 50%, at least 70%, at least 90%, or at least 99% of the hydrogen atoms of the component are replaced by fluorine atoms. In some embodiments, 100% of the hydrogen atoms of the component are replaced by fluorine atoms, i.e. it is perfluorinated, i.e. the component contains fluorine atoms but contains no hydrogen atoms. The fluorophilic component may comprise a fluorine to hydrogen ratio of, for example, at least 0.2:1, at least 0.5:1, at least 1:1, at least 2:1, at least 5:1, or at least 10:1. Fluorophilic components compatible with the present disclosure may have low toxicity, low surface tension, and the ability to dissolve and transport gases. Examples of fluorophilic components are described herein.

As used herein, a “stable emulsion” means that at least about 95% of the droplets of the emulsion do not coalesce, e.g., to form larger droplets over these periods of time. Compositions of the disclosure are, according to some embodiments, stable for at least about 1 minute, at least about 5 minutes, at least about 10 minutes, at least about 20 minutes, at least about 30 minutes, at least about 40 minutes, at least about 1 hour, at least about 2 hours, at least about 6 hours, at least about 12 hours, at least about 1 day, at least about 1 week, at least about 1 month, or at least about 2 months, at a temperature of about 25 degrees to 40 degrees, or to 95 degrees Celsius and a pressure of 1 atm.

As used herein, the terms “thin-shell PEG” and “PEG coating” can be used interchangeably, and mean that long PEG polymers are grafted on the surface of the core-bead that bear the compound and encoding DNA. Long PEG can be, for example, 5 KDa or grater, 10 KDa or greater, or 40 KDa or greater. The PEG group can be grafted onto the core-bead using chemistry known in the art, such as but not limited to, strain-promoted azide-alkyne click chemistry, copper-catalysed azide-alkyne click chemistry, amide coupling, carbamolyation, urea or thiourea formation, sulfonamide formation, alkylation, reductive amination, etc.

Compounds and/or corresponding encoding barcodes can be introduced as covalently barcoded compound beads. In some embodiments, compounds and/or corresponding encoding barcodes can be introduced as reversibly covalently barcoded compound beads. In some embodiments, compounds and/or corresponding encoding barcodes can be introduced through encoded one-bead one-compound library technology. Compounds and/or barcodes can be directly attached to beads, or can be attached by a linker, such as a cleavable linker (e.g., a photocleavable linker), e.g., see FIG. 2C.

Dual-barcoding for the compound and the droplet can be independently achieved, for example, by oligonucleotide encoding, color encoding, fluorescent dye encoding, RFID encoding, or spatial arrangement of fluorescent beacons (Meldal & Christensen, 2010) within a bead, or any combination thereof. In some embodiments, barcoding for the compound and droplet can be achieved by DNA encoding. In all encoding schemes, each bead can have a bead specific barcode that can act as a droplet barcode for replicate count and a compound specific barcode for the compound identity.

Aqueous droplets of single aqueous droplet water-in-oil (w/o) emulsions that co-encapsulate cells and encoded compound beads can be generated at high frequency by adopting standard practice in the droplet microfluidics field. Compressible hydrogel beads can enable flexible, quantitative adjustment of encapsulation efficiency, in some embodiments at or about at 1:1 encapsulation, in other embodiments multiplets per droplet, and in yet other embodiments efficiency below 1:1 encapsulation. In some embodiments, in addition to compound bead(s), a single cell can be co-encapsulated. In some other embodiments, multiple cells, such as multiple cells of the same type, can be co-encapsulated. In other embodiments, two or more different cell types can be co-encapsulated.

In some embodiments, single (w/o) emulsions can be generated with co-encapsulated cells and encoded compound beads as described herein. In some embodiments, double water-in-oil-in-water (w/o/w) emulsions can be generated. In some embodiments, single (w/o) emulsions can be converted into double (w/o/w) emulsions. In some embodiments, single (w/o) emulsions can be converted into double water-in-oil-in-water (w/o/w) emulsions prior to hit droplet selection. In some embodiments, cells and encoded compound beads can be directly encapsulated in double emulsion droplets.

Beads as described herein can be made of any material that can be suspended in aqueous buffer. In some examples, beads can be hard beads, such as polystyrene, polystyrene-PEG hybrid such as TentaGel® (Rapp Polymere), or hydrogels. Hydrogels can be selected from among PEG (ChemMatrix), polyethylene glycol-acrylamide (PEGA) (Auzanneau et al., 1995; Meldal, 1992), agarose, alginate, collagen and polyacrylamide (PA). In some examples beads can be compressible hydrogels. In some examples, beads can be compressible hydrogels that lack autofluorescence. In some examples, beads can be PEGA, which can have excellent swelling properties in both aqueous and organic solvents, enabling versatile microfluidic handling while offering full compatibility with a wide range of organic reactions.

It is also understood that, as described herein, “beads” can include capsules.

Provided herein are a monodisperse polyethylene glycol acrylamide (PEGA) resin, and methods of preparing a monodisperse polyethylene glycol acrylamide (PEGA) resin. In some embodiments, PEGA resin (e.g., polydisperse PEGA resin) can be generated in bulk. In some embodiments, size distribution of polydisperse PEGA resin can be adjusted by passing the polydisperse PEGA resin through at least one filter. In some examples, the at least one filter is at least one cell strainer. In some examples, size distribution of polydisperse PEGA resin can be adjusted by passing polydisperse PEGA resin through a series of filters (for example, a series of cell strainers). For example, to obtain beads of a diameter in the 20-40 micron range, one can filter away beads larger than 40 micron using a 40 micron mesh strainer, and then load the filtrate on a 20 micron mesh filter to remove beads smaller than 20 micron.

In some embodiments, monodisperse PEGA resin can be generated in microdroplets of a desired droplet size. The size of the PEGA resin can be adjusted to correspond to the size of the screening droplet and the required compound loading capacity. In some embodiments, PEGA resin can be between 1-100 micron in diameter. In some embodiments, screening droplets can be 10-200 micron in diameter. The loading capacity of the PEGA resin can be such that maximal concentration of the released ligand in the droplet can be above 0.1 μM, preferably above 1 μM, more preferably above 10 μM. The resin can carry compounds at a fixed dose, or correspondingly encoded descending doses from the maximum loading. In some examples, the resin can carry compounds that are screened by quantitative high-throughput screening (qHTS) (Inglese et al., 2006). In some examples, the qHTS is through controlled partial release of the ligands from the beads, and/or through preparation of dose-response beads with the corresponding encoding.

In some embodiments, hydrogel beads (for example, PEGA resin) can be magnetic. Hydrogel resin, such as, for example, PEGA resin, can be made magnetic, for example, by co-encapsulation of appropriately coated magnetic microparticles or nanoparticles. In some examples, coatings of magnetic microparticles or nanoparticles can be selected based on biocompatibility, chemical resistance for organic synthesis, background fluorescence, mechanical stability, or any combination thereof. In some embodiments, examples of magnetic microparticles include, for example, but are not limited to, microparticles in polystyrene coated DynaBeads (InVitrogen, USA) or TurboBeads (TurboBeads LLC, Switzerland), or silica coated BOCA beads (BOCA Scientific INC, USA). Magnetic microparticles can be spatially entrapped, or covalently bonded through acrylamide surface modification. Magnetic hydrogels can be advantageous in bead handling during library preparation and post screen bead processing, and/or can enhance microfluidic handling such as allowing separation of bead encapsulated droplets in bulk or on microfluidic chips.

In some embodiments, an encodable compound loading resin described herein can be encapsulated in a hydrogel matrix. In some examples, an encapsulating hydrogel matrix can be, for example, PEG, PEGA, polyacrylamide, alginate, collagen or agarose, or any combination thereof. Encapsulation in a hydrogel matrix can enhance microfluidic handling properties, such as, for example, hydrophilicity or compressibility or both. In some embodiments, encapsulation in a hydrogel matrix can increase droplet encapsulation efficiency. In some embodiments, the hydrogel matrix can comprise cavities that can act for example as a cell carrier (Di Carlo et al., 2019). In some embodiments, hard beads can be encapsulated in a hydrogel matrix. The hard beads can be 1 to 50 micron in diameter, and the hydrogel shell can be sufficiently larger than the hard beads to allow sufficient compressibility, for example 30 or 70 micron polyacrylamide gel for encapsulation of 10 micron beads, such as TentaGel® library beads. In some embodiments, soft-shell beads described herein can be enriched by FACS. For example, soft-shell beads can be purified by FACS and gating for a suitable library bead loading per hydrogel, typically, but not limited to, in 1:1 ratio. In case of autofluorescent hard-shell beads, such as, for example, polystyrene, or polystyrene-PEG hybrid such as TentaGel®, corresponding soft-shell beads with the desired amount of bead loading can be enriched.

In some embodiments, surface properties of the beads can be modified. For example, beads can be coated, for example with hydrophilic material(s) such as, but not limited to, PEG, PPG, hyaluronic acid, polylactic acid, and other hydrophilic polymers, or hydrogels such as, but not limited to; polyacrylamide, PEG, alginate, agarose, or collagen, or a combination of any of the foregoing. Modification of surface properties can improve properties of beads. For example, modifications described herein, such as core shell beads and hydrogel beads, can minimize bead aggregation in aqueous media and enhance microfluidic handling.

In some embodiments, a compound can be released from a bead. For example, a compound can be released from a bead within a droplet. In some embodiments, a compound not attached by a linker (“linker-less compound”) can be released within a droplet upon at least one stimulus, such as, but not limited to, electromagnetic irradiation (e.g., light, UV, UVA such as, for example about 365 nm), enzyme cleavage, pH change, reducing agents, or a combination thereof. In some embodiments, the stimulus can be electromagnetic irradiation. A stimulus for release (for example, enzyme(s), pH trigger(s), reducing agent(s), or a combination thereof) can be included in the assay media or introduced through a separate channel or introduced by way of injection (for example, pico-injection). In some embodiments, a stimulus for release (for example UV irradiation) can be exposed on-chip for inline, or in bulk for off-line treatment, or a combination thereof. A stimulus for release can include any combination of stimuli described herein.

Assays described herein, such as bioassays, can be performed with a co-encapsulated barcoded compound bead with assay reagents in an aqueous droplet water-in-oil (w/o) or aqueous droplet water-in-oil-in-water (w/o/w), thereby providing an assay compartment. Compounds can be released by a stimulus to release a compound, such as a linker-less compound. Release can achieve a desired concentration of the compound, such as a linker-free compound, within the droplet. The droplets can be assayed, for example by incubation for a duration of assay. Results can be determined as described herein, for example by hit droplet selection methods described herein.

In some embodiments, assay droplets can be incubated in-line in an integrated chip design, or off-line in an incubation chamber. In some embodiments, droplets can be re-injected into the device for hit droplet selection and/or decoding.

Assays can be biochemical assays, in-vitro transcription translation (IVTT) assays, cellular assays, whole organism assays, or a combination thereof. Biochemical assays can include, but are not limited to, fluorescent intensity (FLINT), fluorescence resonance energy transfer (FRET), time-resolved FRET (TR-FRET), fluorescence polarization, fluorescence lifetime, ELISA, and combinations thereof. IVTT assay formats can include, but are not limited to, two-hybrid systems, split-GFP reporter assays, and combinations thereof. Cellular assays can include, but not limited to, intracellular reporter assays (for example, gain or loss of fluorescent protein or fluorescence coupled enzyme), secreted reporter and/or secreted enzyme coupled assays, marker (e.g., cytokine marker) secretion assays, live-dead assays, cell-cell interaction assays, viral induction assays, and combinations thereof. In some examples, assays described herein can be performed with detection beads. For example, marker (e.g., cytokine marker) secretion assays, or ELISA assays can be performed with detection beads. Encoded compound beads can optionally act simultaneously as detection beads. For example, in an ELISA assay, encoded compound beads can act simultaneously as detection beads. Viral induction assays can include, but are not limited to retrovirus assays (e.g., lentivirus, adeno-associated virus (AAV)).

In some preferred embodiments, cellular assays can be performed with cell tracker(s) and/or internal reference fluorescent protein(s). Cell tracker(s) and/or internal reference fluorescent protein(s) can correct for the number of multiplets within a droplet, the relative expression level of reporter genes and/or proteins, or a combination thereof.

In some preferred embodiments, the assays can be in “mix-and-read” format, in which assay pre-mix is co-encapsulated with the barcoded compounds and assay results can be determined without further manipulations. In other embodiments, the assays can include adding assay reagent(s) (e.g., a detection antibody) to determine assay results. Assay reagent(s) (e.g., a detection antibody) can be added sequentially, for example through pico-injection, droplet merging, or a combination thereof.

In some preferred embodiments, hit droplets can be selected by fluorescence activated droplet sorting (FADS). In some preferred embodiments, FADS can include sorting with a sorter described herein, such as a dual electrode sorter described herein. Sorting with a dual electrode sorter, such as a dual electrode sorter described herein can enhance speed and/or reliability of the sorting.

In some embodiments, droplets can be selected by FACS. In some embodiments, droplets can be selected by FACS at a frequency of 12-14 kHz (Brower et al., 2019, 2020). In some embodiments, the droplets selected by FACS can be w/o/w double emulsion droplets.

In some embodiments, assay droplets containing compound beads and the bioassay generated with the preferred emulsion formulations described herein can be turned into a hydrogel bead by introducing biocompatible polymers and/or their precursors, such as but not limited to agarose, alginate, collagen, polyacrylamide, PEG and the corresponding initiators, or any combination thereof, as needed. The assay hydrogels thus formed can be isolated in aqueous buffer while keeping the compound beads and cells on bead for off-droplet sorting using traditional flow cytometers (Duarte et al., 2017; Yanakieva et al., 2020).

In some embodiments, the core-shell bead containing a member of the encoded library can have a cavity to accommodate cells, turned into water-in-oil droplets with the preferred emulsion formulations described herein, compound released and incubated within the discrete droplet compartment, bead and cell bearing hydrogel extracted in aqueous buffer for off-droplet sorting using traditional flow cytometers (Di Carlo et al., 2019; Joseph de Rutte, Robert Dimatteo, Mark van Zee, Robert Damoiseaux, 2020).

In some embodiments, single or double emulsion droplets can be arrayed onto a microwell plate, such as a 1536 well plate. The bottom of each well of the microwell plate can further comprise an array of smaller wells, where each well is of a size similar to the size range of the emulsion droplets, such as a 100 micron grid. In some embodiments, each well of the array of smaller wells can contain one droplet. In some embodiments, the droplets can sediment in wells. For example, in some further embodiments, w/o/w double emulsion droplets sediment in wells. In some further embodiments, w/o/w double emulsion droplets sediment in wells with a continuous phase formulation described herein as the continuous phase. In some embodiments, w/o/w double emulsion droplets sediment in wells with a continuous phase formulation that comprises at least one fluorous dispersion oil. In further embodiments, the fluorous dispersion oil can have an average fluorine content of about 70 wt % or more. In yet further embodiments, the continuous phase formulation can further include a droplet stabilizer comprising an emulsifier that is a triblock copolymer, a diblock copolymer, a fluorinated silica nanoparticle, or a combination thereof. In some embodiments w/o single emulsion droplets sediment in wells. In some further embodiments, w/o single emulsion droplets sediment in wells with a continuous phase oil with a density lower than the density of the aqueous phase. In yet some further embodiments, the continuous phase oil is a mineral oil, squalene oil any other hydrocarbon based oil.

In embodiments provided herein in which droplets sediment (i.e., sink) into wells of the array of smaller wells, the droplets can be analyzed. Hit droplets can be separated, for example, for hit deconvolution. For example, droplets can be analyzed by imaging techniques, such as fluorescence, luminescence, or a combination thereof. In some examples, hit droplets can be analyzed and automatically aspirated from the population for hit deconvolution. Picking can be fully automated. For example, picking can be performed by a robotic micromanipulator such as automated cell picker.

In embodiments in which droplets are assayed by a cellular assay, the droplets can be w/o/w double emulsion droplets. In further embodiments, the w/o/w double emulsion droplets can be in a continuous phase formulation that comprises at least one fluorous dispersion oil. In yet further embodiments, the fluorous dispersion oil has an average fluorine content of about 70 wt % or more. In yet further embodiments, the continuous phase formulation further includes a droplet stabilizer comprising an emulsifier that is a triblock copolymer, a diblock copolymer, a fluorinated silica nanoparticle, or a combination thereof. This format of droplet selection can allow for versatile assay readouts including but not limited to phenotypic imaging based readouts, fluorescent based readouts, bioluminescence based readouts, and combinations thereof.

In some embodiments, hit droplets, and optionally non-hit droplets, can be analyzed. For example, droplets can be analyzed by decoding the compound barcode and/or the droplet barcode. In some embodiments, hit molecules can be deconvoluted. For example, deconvoluting hit molecules can include counting the number of positive droplets per compound. In some further embodiments, the number of positive droplets per compound can be compared to the number of negative droplets for the same compound. In some preferred embodiments, DNA-encoded one-bead-one-compound library or compound bead with both bead and compound specific barcode can be employed. In further embodiments, decoding barcodes can comprise sequencing, such as Next Generation Sequencing.

In the compositions, methods, assays, sorters, uses, and systems described herein, the droplets can be single emulsion format as described herein or double emulsion format as described herein.

Accordingly, the present technique provides methods, sorters, uses and devices in which substances, such as bioactive substances, can be screened in emulsion droplets.

In accordance with some embodiments, a continuous phase formulation for stable emulsions is described. The continuous phase formulation includes at least one fluorous dispersion oil, wherein the fluorous dispersion oil has an average fluorine content of about 70 wt % or more (e.g., 75 wt % or more, 80 wt % or more); and a droplet stabilizer comprising a emulsifier selected from the group consisting of a triblock copolymer, a diblock copolymer, a fluorinated silica nanoparticle, and a combination thereof.

In accordance with some embodiments, a continuous phase formulation for stable emulsions is described. The continuous phase formulation includes a plurality of two or more fluorous dispersion oils, wherein the plurality of fluorous dispersion oils has an average fluorine content of about 70 wt % or more; and a droplet stabilizer comprising a plurality of two or more emulsifiers selected from the group consisting of a triblock copolymer, a diblock copolymer, a fluorinated silica nanoparticle, and a combination thereof.

In accordance with some embodiments, a method of reducing cross-contamination between microdroplets (e.g. greater than 1, greater than 2, greater than 3, greater than 4, greater than 5, greater than 6, greater than 7 or greater than 8 days of compound retention) (e.g., water-in-oil (w/o) single emulsion), is described. The method includes: forming (e.g., with syringe pumps) at least one aqueous microdroplet in an first continuous phase formulation, wherein the continuous phase formulation comprises an emulsifier selected from the group consisting of a triblock copolymer, a diblock copolymer, a fluorinated silica nanoparticle, and a combination thereof. In some examples, the method includes exchanging the first continuous phase formulation with a fluorous dispersion oil (e.g., exchanging and then re-exchanging with fluorous dispersion oil for a total of 2, 3, 4, 5 times or more), to provide the aqueous microdroplet suspended in the fluorous dispersion oil, wherein the fluorous dispersion oil has an average fluorine content of>70 wt % and does not contain an emulsifier.

In some embodiments, the method of reducing cross-contamination between microdroplets further includes exchanging the first fluorous dispersion oil with a second continuous phase formulation (e.g., that increases droplet stability for further droplet manipulation), to provide the aqueous microdroplet suspended in the second continuous phase formulation, wherein the second continuous phase formulation is a continuous phase formulation described herein.

In accordance with some embodiments, a method of reducing cross-contamination between microdroplets is described. The method includes: forming at least one aqueous microdroplet in a first continuous phase formulation described herein; exchanging the first continuous phase formulation with a first fluorous dispersion oil to provide the aqueous microdroplet suspended in the first fluorous dispersion oil; exchanging the first fluorous dispersion oil with a second fluorous dispersion oil, to provide the aqueous microdroplet suspended in the second fluorous dispersion oil. In some examples, the first fluorous dispersion oil has an average fluorine content of>70 wt %, and contains a Pickering emulsifier (e.g., 8% wt fluorinated silica nanoparticle (100 nm) of formula

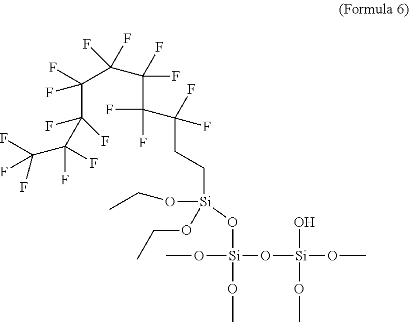 [SMILES: CCO[Si](CCC(F)(F)C(F)(F)C(F)(F)C(F)(F)C(F)(F)C(F)(F)C(F)(F)C(F)(F)F)(OCC)O[Si](OC)(OC)O[Si](O)(OC)OC]

dispersed in a mixture of perfluoro 2-butyltetrahydrofuran and 2-(trifluoromethyl)-3-ethoxydodecafluorohexane (HFE-7500)). In some examples, the second fluorous dispersion oil has an average fluorine content of>70 wt % and does not contain an emulsifier.

In some embodiments, the method further includes exchanging the second fluorous dispersion oil with a second continuous phase formulation (e.g., for increased droplet stability for further droplet manipulation), to provide the aqueous microdroplet suspended in the second continuous phase formulation. In such embodiments, the second continuous phase formulation is a continuous phase formulation described herein.

In accordance with some embodiments, a method of preparing a monodisperse polyethylene glycol acrylamide (PEGA) co-polymer resin is described. The method includes: dispersing a plurality of monomers into an aqueous buffer (e.g. TBSET (10 mM TBS (pH 8.0), 137 mM NaCl, 2.7 mM KCl, 10 mM EDTA, 1% Tween)); combining the aqueous buffer and the plurality of monomers with a continuous phase formulation comprising an oil and a emulsifier (e.g., a emulsifier at a concentration of about 0.5%, about 1%, about 1.5%, about 2%, about 2.5%, about 0.5%-1.5%, about 0.5% to about 2.0%, about 0.5% to about 2.5%); forming at least one microdroplet (e.g., 1-200 micron, 10-200 micron, 1-100 micron, 5-90 micron, 10-80 micron, 20-70 micron, 20-50 micron) from the aqueous buffer and plurality of monomers; and polymerizing (e.g., with an initiator (e.g., tetramethylene diamine (TEMED) and ammonium persulfate); temperature at about 20° C., 30° C., 40° C., 50° C., about 55° C., about 60° C., about 65° C., about 70° C., about 75° C., about 60-70° C., or about 55 to 75° C.; polymerization overnight) the monomers in the at least one microdroplet to form a PEGA co-polymer resin. In some examples, the oil is selected from the group consisting of a fluorous oil, hydrocarbon oil, mineral oil, and silicone oil. In some examples, the monomers of the plurality of monomers comprise an acrylamide (e.g., acrylamide or N,N-dimethylacrylamide); a bis-acrylamide PEG; and a mono-acrylamide PEG comprising a functionalization handle, and/or a mono-acrylamide diamine comprising a functionalization handle. In some examples, the monomers of the plurality of monomers comprise an acrylamide (e.g., acrylamide or N,N-dimethylacrylamide); a bis-acrylamide PEG; a mono-acrylamide PEG comprising a functionalization handle, and a mono-acrylamide diamine comprising a functionalization handle. In some examples, the monomers of the plurality of monomers comprise an acrylamide (e.g., acrylamide or N,N-dimethylacrylamide); and a bis-acrylamide PEG; and a mono-acrylamide PEG comprising a functionalization handle. In some examples, the monomers of the plurality of monomers comprise an acrylamide (e.g., acrylamide or N,N-dimethylacrylamide); a bis-acrylamide PEG; and a mono-acrylamide diamine comprising a functionalization handle.

In some embodiments, the PEGA resin is mechanically stable under reaction conditions typically employed in solid-phase organic chemistry (e.g., such as elevated temperatures and/or acidic or basic conditions, and stable towards pipetting, shaking, sonication, centrifugation, filtration and handling in microfluidic devices; e.g., stability measured by percentage bead recovery after handling protocols, such as pipetting, centrifugation, filtration, chemical treatment, uv irradiation, droplet encapsulation, droplet breakage and recovery, sorting in flow cytometer; e.g., stable at 100° C. for at least 1 hour, stable towards acid (e.g., TFA) or base (e.g., DIPEA) treatment for at least 1 hr, or shaking at 1500 rpm for at least 24 hours, or centrifugation at 8000 rcf for at least 3 min); and the PEGA resin is sufficiently biocompatible (e.g., co-incubation with cells for 24 hrs results in viability of>90% or more when compared with no bead control) such that co-incubation and/or co-encapsulation in droplets with biological systems (e.g., such as cells, IVTT mix and/or recombinant proteins) does not compromise integrity of the PEGA resin for the duration of the assay. In some embodiment the PEGA resin is sufficiently biocompatible (e.g., co-incubation with cells for 24 hrs results in viability of>90% or more when compared with no bead control). In some examples, the PEGA resin is capable of swelling (e.g., at least 5 ml/g, at least 6 ml/g, at least 7 ml/g, at least 8 ml/g, at least 9 ml/g, at least 10 ml/g, at least 11 ml/g, at least 12 ml/g, at least 13 ml/g, at least 14 ml/g, at least 15 ml/g, at least 16 ml/g,) in aqueous buffered solution and organic solvents to allow efficient chemical reactions on the entire resin, effective exchange of solvents and suspendability and handling. In some examples, the PEGA resin is sufficiently compressible (e.g., achieve a reversible, reduction in diameter without breakage when a force is applied, wherein the reduction in diameter is >10%, >15%, >20%, >25% or>30%) to allow packing of the hydrogel beads in microfluidic channels, such that the beads are encapsulated into the at least one microdroplet with super-Poisson encapsulation efficiency (e.g., characterized by analyzing the droplets in a hemocytometer/microscopy chamber slide (e.g. iBidi or Countess), for example comparing (e.g., by observation under a microscope) the number of encapsulated vs empty droplets, such as droplets in a close packed monolayer).

In some embodiments, the at least one microdroplet is formed in a microfluidic device (e.g., a microfluidic chip, a device optionally comprising a droplet splitter). In some examples, forming the at least one microdroplet comprises forming, in parallel, a plurality of monodisperse microdroplets.

In accordance with some embodiments, a method of preparing a monodisperse polyethylene glycol acrylamide (PEGA) co-polymer resin is described. The method includes: dispersing a plurality of monomers into an aqueous buffer; polymerizing the monomers to form a polydisperse PEGA co-polymer resin; and passing the polydisperse PEGA co-polymer resin through a plurality of cell strainers to obtain a PEGA co-polymer resin with a defined size distribution (e.g., 1-200 micron, 10-200 micron, 1-100 micron, 5-90 micron, 10-80 micron, 20-70 micron, 20-50 micron, 20-40 micron). In some examples, the monomers of the plurality of monomers comprise: an acrylamide (e.g., acrylamide or N,N-dimethylacrylamide); a bis-acrylamide PEG; and a mono-acrylamide PEG comprising a functionalization handle, and/or a mono-acrylamide diamine comprising a functionalization handle

In accordance with some embodiments, a method of preparing a core-shell bead is described. The method includes: dispersing a plurality of monomers and at least one core bead into an aqueous buffer; forming at least one microdroplet from the aqueous buffer, plurality of monomers, and core bead, wherein the at least one microdroplet comprises the at least one core bead; and polymerizing the monomers in the at least one microdroplet to form a hydrogel (e.g., PEGA, poly-acrylamide, alginate, agarose, collagen, or a combination thereof) encapsulating the bead to form a core-shell bead (e.g., the thickness of the PEGA co-polymer is greater than the radius of the bead).

In accordance with some embodiments, a method of preparing thin-shell PEG coated bead is described. The method includes grafting a hydrophilic coating on the compound loaded, encoded bead. In some examples, the hydrophilic polymer coating consists of PEG. In some examples, PEG is attached by acetylene-azide click chemistry

In accordance with some embodiments, a sorter is described. The sorter includes: an inlet channel; first and second outlet channels meeting the inlet channel at a junction; and first and second electrodes proximate to respective first and second sides of the junction. In some embodiments, the first and second electrodes are configured to have: a first state, in which the first electrode receives more voltage than the second electrode, that causes one or more target compositions flowing through the junction to enter the first outlet channel; and a second state, in which the second electrode receives more voltage than the first electrode, that causes one or more target compositions flowing through the junction to enter the second outlet channel. In some embodiments, the sorter comprises a controller configured to switch the first and second electrodes between the first state and the second state.

In accordance with some embodiments, a system (e.g., a device; a device while in operation) for performing high throughput screening is described. The system includes a continuous phase formulation, a solid support, and a sorter. In some examples, the continuous phase formulation comprises a droplet stabilizer and at least one fluorous dispersion oil. In some examples, the fluorous dispersion oil has an average fluorine content of about 70 wt % or more. In some examples, the droplet stabilizer comprises an emulsifier selected from the group consisting of a triblock copolymer, a diblock copolymer, a fluorinated silica nanoparticle, and a combination thereof. In some examples, the solid support is selected from the group consisting of a monodisperse polyethylene glycol acrylamide (PEGA) co-polymer resin and a core-shell bead. In some examples, the monodisperse polyethylene glycol acrylamide (PEGA) co-polymer resin is prepared by: dispersing a first plurality of monomers into a first aqueous buffer; combining the first aqueous buffer and the first plurality of monomers with a continuous phase formulation comprising an oil and an emulsifier; forming at least one first microdroplet from the first aqueous buffer and first plurality of monomers; and polymerizing the monomers in the at least one first microdroplet to form a PEGA co-polymer resin. In other examples, the thin-shell bead is prepared by grafting a hydrophilic coating on the solid support. In some examples, the hydrophilic polymer coating consists of PEG. In some examples, PEG is attached by acetylene-azide click chemistry. In some examples, the oil is selected from the group consisting of a fluorous oil, hydrocarbon oil, mineral oil, and silicone oil. In some examples, the monomers of the first plurality of monomers comprise: an acrylamide; a bis-acrylamide PEG; and a mono-acrylamide PEG comprising a functionalization handle, and/or a mono-acrylamide diamine comprising a functionalization handle. In some examples, the core-shell bead is prepared by: dispersing a second plurality of monomers and at least one core bead into a second aqueous buffer; forming at least one second microdroplet from the second aqueous buffer, second plurality of monomers, and core bead; and polymerizing the monomers in the at least one second microdroplet to form a hydrogel encapsulating the core bead to form a core-shell bead. In some examples, the at least one second microdroplet includes the at least one core bead. In some examples, the sorter includes an inlet channel, first and second outlet channels meeting the inlet channel at a junction, and first and second electrodes proximate to respective first and second sides of the junction. In some examples, the first and second electrodes are configured to have: a first state, in which the first electrode receives more voltage than the second electrode, that causes one or more target compositions flowing through the junction to enter the first outlet channel; and a second state, in which the second electrode receives more voltage than the first electrode, that causes one or more target compositions flowing through the junction to enter the second outlet channel. In some examples, the sorter comprises a controller configured to switch the first and second electrodes between the first state and the second state.

In accordance with some embodiments, a system for performing high throughput screening is described. The system includes a continuous phase formulation, a solid support, and a sorter. In an embodiment, the solid support is in the form of an encoded compound bead as described herein. In some examples, the continuous phase formulation comprises a droplet stabilizer and at least one fluorous dispersion oil. In some examples, the fluorous dispersion oil has an average fluorine content of about 70 wt % or more. In some examples, the droplet stabilizer comprises an emulsifier selected from the group consisting of a triblock copolymer, a diblock copolymer, a fluorinated silica nanoparticle, and a combination thereof. In some examples, the solid support is selected from the group consisting of a monodisperse polyethylene glycol acrylamide (PEGA) co-polymer resin and a core-shell bead. In some examples, the monodisperse polyethylene glycol acrylamide (PEGA) co-polymer resin is prepared by dispersing a first plurality of monomers into a first aqueous buffer; combining the first aqueous buffer and the first plurality of monomers with a continuous phase formulation comprising an oil and an emulsifier, forming at least one first microdroplet from the first aqueous buffer and first plurality of monomers; and polymerizing the monomers in the at least one first microdroplet to form a PEGA co-polymer resin. In other examples, the thin-shell bead prepared by grafting hydrophilic coating on the solid support. In some examples, the hydrophilic polymer coating consists of PEG. In some examples, PEG is attached by acetylene-azide click chemistry. In some examples, the oil is selected from the group consisting of a fluorous oil, hydrocarbon oil, mineral oil, and silicone oil. In some examples, the monomers of the first plurality of monomers comprise: an acrylamide; a bis-acrylamide PEG; and a mono-acrylamide PEG comprising a functionalization handle, and/or a mono-acrylamide diamine comprising a functionalization handle. In some examples, the core-shell bead is prepared by: dispersing a second plurality of monomers and at least one core bead into a second aqueous buffer; forming at least one second microdroplet from the second aqueous buffer, second plurality of monomers, and core bead; and polymerizing the monomers in the at least one second microdroplet to form a hydrogel encapsulating the core bead to form a core-shell bead. In some examples, the at least one second microdroplet includes the at least one core bead. In some examples, the sorter comprises: a microwell array plate configured to host one microdroplet per microwell; a fluorescence microscope; an imager configured to automatically image assay droplets and identify desired droplets, and an automated microcapillary-based droplet sampling device configured (e.g., configured to allow access to droplets in microwells, or in a grid; with one or more capillary properties selected from among size, angle and height selected to accommodate droplets and/or dividers) to continuously select (e.g., sequentially select; bulk selection; high throughput selection, such as about 1-3 cells per second, or about 2 cells per second; selection by aspiration) multiple desired droplets and deposit them to hit wells.

Thus, compositions, methods, sorters, systems, uses and devices are provided for high-throughput screening in droplets. Such methods, compositions, sorters, systems, uses, and devices can complement or replace other methods, compositions, sorters, systems, uses, and devices for high-throughput screening in droplets. In some embodiments, the compositions, methods, sorters, systems, uses, and devices, and combinations thereof provided herein can be used to perform one or more analyses selected from among biochemical assays, cell-free assays, cellular reporter assays, and cellular phenotypic assays with fluorescent or bioluminescent and/or next generation sequencing readout and hit compounds deconvoluted by next generation sequencing.

### DESCRIPTION OF THE FIGURES

The patent or application file contains at least one drawing executed in color. Copies of this patent or patent application publication with color drawing(s) will be provided by the Office upon request and payment of the necessary fee.

For a better understanding of the various described embodiments, reference should be made to the Description of Embodiments below, in conjunction with the following drawings in which like reference numerals refer to corresponding parts throughout the figures.

FIGS. 1A and 1B illustrate an embodiment miniaturization from 1536 well plates to about 500 picoliter encoded assay compartments. In a 1536 well plate (e.g., 651 plates for approximately 1 million wells), 5 μL of assay media can be held in 1.7 mm diameter microwells (FIG. 1A), whereas in droplets about 500 picoliters of assay media can be held in 100 micron diameter droplets (e.g., 1 million droplets in a single tube) that are encoded (FIG. 1B).

FIGS. 2A and 2B illustrate a water-in-oil (w/o) single emulsion droplet (FIG. 2A) and a water-in-oil-in-water (w/o/w) double emulsion droplet (FIG. 2B).

FIG. 2C illustrates compounds and barcodes attached to a compound loading bead. Ligands and barcodes can be optionally linked to a common functionalization handle on beads through a split linker (FIG. 11A).

FIGS. 2D and 2E illustrate compound loading beads 160 encapsulated in a hydrogel matrix 161 (FIG. 2D) and in a hydrophilic coating 162 (FIG. 2E).

FIG. 2F illustrates a core-shell bead where the compound loading bead 160 is encapsulated in hydrogel shell 162, which has a cavity 163 to accommodate cells.

FIG. 2G illustrates a dual electrode droplet sorting device in accordance with some embodiments.

FIG. 2H illustrates microarray grid hosting one droplet per well and isolation of hit droplets and/or beads in accordance with some embodiments.

FIG. 3 depicts a microfluidic droplet generation device in accordance with some embodiments.

FIG. 4 shows monodisperse PEGA resin generated in microfluidic droplet generation device in accordance with some embodiments.

FIGS. 5A-5C illustrate encoded compound loading beads without (FIG. 5A) and with (FIGS. 5B-5C) hydrophilic polymer shell.

FIGS. 5D-5E illustrate core shell beads coated with a hydrophilic shell through acylation or azide-acetylene click chemistry or by grafting hydrophilic polymer such as PEG (FIG. 5D and 5D-1) and through on-surface polymerization (FIG. 5E) with hydrophilic polymer mix such as polyacrylamide in accordance with some embodiments.

FIG. 5F illustrates encapsulation of a compound loading core bead in a layer of hydrogel in accordance with some embodiments.

FIG. 6A-6B illustrate compound loading hydrogel beads with magnetic microparticles non-covalently attached (FIG. 6A) and covalently attached (FIG. 6B) in accordance with some embodiments.

FIG. 7A-7H show comparative molecular retention of fluorescein (FIGS. 7A-7D) and resorufin (FIGS. 7E-7H) in w/o single emulsions generated with various commercially available continuous phase formulations at 1 hr time point.

FIGS. 8A-8D shows molecular retention of fluorescein (green) and resorufin (red) in droplets generated with continuous phase oil compositions in accordance with some embodiments.

FIGS. 8E-8G show droplet stability and dye retention 5 days after exchange with emulsifier-free continuous phase oil blend (20% HFE-7500, 20% FC-72 and 60% Perfluoroctane containing emulsifiers (Formula 1 (n is about 38, and m is about 9): Formula 2 (i and k are about 38, and j is about 9) 1:1, 2 wt %)). FIG. 8E shows the bright field, FIG. 8F shows 100 μM resorufin and FIG. 8G shows 100 μM fluorescein. Approximately 1 in 10 droplets contain the dye mixture to monitor cross-contamination across droplets. The image is taken with droplets in ibidi imaging slides with 100 micron height chambers.

FIGS. 8H-8J show a representative flow cytometry gating strategy to identify viable cells as seen by low red fluorescence (FIG. 8H)

FIG. 8K shows percent viable cells after co-encapsulation in, and subsequent recovery from, 100 micron droplets with certain di- and tri-block copolymers, respectively.

FIGS. 9A-9F show in-droplet fluorescein release from 10 micron TentaGel® beads (FIGS. 9A and 9B), 33 micron PEGA resin (FIGS. 9C and 9D), 10 micron TentaGel® in 33 micron polyacrylamide shell (FIGS. 9E and 9F) before (FIGS. 9A, 9C and 9E) and after (FIGS. 9B, 9D and 9F) UV irradiation to cleave a photocleavable linker.

FIG. 9G-9I show FACS enrichment of TentaGel® in polyacrylamide. The crude TentaGel® encapsulated population is 6% (FIG. 9G). After FACS enrichment based on sub population of events that have significantly higher fluorescence in the FITC and PE channels, the encapsulated population is increased to 75% (FIG. 9H). FIG. 9I shows the scatter plot and gated population.

FIG. 10A shows compressibility of polyacrylamide (PAA) vs. PEGA 1×rods as measured by texture analyzer. FIG. 10B shows tight packing of PEGA 1×resin in one channel and quantitative 1:1 encapsulation into droplets in accordance with some embodiments.

FIGS. 10C and 10D show FACS results for biocompatibility of 33 micron PEGA resin as measured by cell viability after 24 hours in 37° 5% CO2 incubator.

FIGS. 11A-11C depict exemplary DNA-encoded bead library linker and DNA barcode designs in accordance with some embodiments. FIG. 11A depicts an azidolysine that provides a click handle for DNA tag conjugation while the N-term is used for further linker elaboration with a photo cleavable motif such as an orthonitrobenzyl group. FIG. 11B depicts an exemplary DNA barcode design in which headpieces are followed by bead specific barcode (BSB) and, for example, 3 positions for encoding various building blocks, followed by a library tag and an experiment specific tag. FIG. 11C depicts an example of dose response beads in which the split linker can be capped with acetyl group to reduce the photocleavable linker functionalization handle and DNA encoded so that the dose-response beads can be pooled for synthesis and screening.

FIGS. 12A-C depict embodiments in which mix-and-read fluorescence reporter assays that result in either gain or loss of signal can be configured on the droplet-based screening platform to illuminate the whole droplet (FIG. 12A), a single or multiple cells and/or beads in the droplet (FIG. 12B) or secreted reporter from a single or multiple cells to illuminate the whole droplet (FIG. 12C).

FIG. 13 depicts exemplary fluorescent reporters that can be used for cell-based assays. FIG. 13 depicts: i) Fluorescent proteins that can be detected on the drop sorter. For example, detection can be effected by prompt detection of fluorescence or sorting via a ratio (for example GFP/RFP ratio where one fluorescent reporter reports on the biological response and another reports is used to normalize expression and cell numbers. ii) Fluorescent reporter enzymes. For example, β-lactamase that can be used as a reporter enzyme to report on cellular responses using a FRET-based substrate. This can also be multiplexed with a toxicity dye via a red-fluorescent cell stain (ToxBlazer™, Thermo Fisher Scientific). Alternatively, the enzyme β-galactosidase can be used as reporter in either native or split forms to enable monitoring a variety of cell-based events. The use of the β-galactosidase substrate DDAO galactoside (9H-(1,3-Dichloro-9,9-Dimethylacridin-2-One-7-yl) β-D-Galactopyranoside) provides for far-red fluorescent emission that is well separated from typical background autofluorescence is observed when the enzyme is expressed. iii) Secreted forms of a FP or secreted enzymes such as secreted alkaline phosphatase (SEAP) that can be used for detection of cellular responses with green fluorescent readouts. Illustrated is a fluorescent detection system for SEAP.

FIGS. 14A-14E depict droplet sorting in accordance with some embodiments. FIG. 14A illustrates droplet flow in which no field is applied. FIG. 14B depicts an example of random droplet flow in which no field is applied. FIG. 14C illustrates droplet sorting in which an electric field is applied to select for a non-hit stream path. FIGS. 14D and 14E illustrate droplet sorting in which an electric field to select for a hit stream is applied.

FIG. 15A shows detection and sorting of fluorescent droplets by applying an electric field in accordance with some embodiments. FIGS. 15B-15E show detection and sorting of droplets by alternating voltage potential in accordance with some embodiments.

FIG. 16 shows double emulsion droplets in an imaging flow cytometer in accordance with some embodiments.

FIGS. 17A-17F illustrate emulsion sorting by picking hit droplets from a microwell plate in accordance with some embodiments. FIG. 17A illustrates a microwell plate in which dimensions of the microwells are chosen in the same size scale as emulsion drops to for one drop per well. FIG. 17B illustrates emulsion drops loaded onto a micro well plate so that each well contains one emulsion drop. FIG. 17C illustrates microwell plates in which single and multiple hit group positions are identified. FIG. 17D illustrates microwell plates in which single and multiple hit groups are mechanically removed from the specific wells. FIG. 17E illustrates single and multiple hit groups collected for analysis. FIG. 17F is a microscope image of double emulsion drops with and without fluorescent dye arrayed in a microwell plate.

FIGS. 18A-18D are microwell plates from which a double emulsion is removed in accordance with some embodiments. FIG. 18A is a microwell plate containing a double emulsion. FIG. 18B is a microwell plate containing a double emulsion and a capillary that is slightly bigger than the double emulsion. FIGS. 18C and 18D show a defined volume aspirated to remove the double emulsion from the well.

FIG. 19A shows Quantitative PCR of PEGA resin, TentaGel® resin and TentaGel® in polyacrylamide resin. 3 samples are analyzed: a blank made of MilliQ Water (curves “C”), a control sample (beads that were mixed with DNA tags without T4 DNA ligase-curves “B”) and sample beads (fully encoded beads-curves “A”). Curves “D” correspond to calibration curves

FIG. 19B: PCR of TentaGel® resin with and without thin-shell PEG40K-coating (PEG chain of average molecular weight of 40 KDa). Curves “A” are from the null library bead without PEG4OK coating. Curves “B” are from the library bead with PEG 40K coating. Curves “C” are MilliQ Water (negative control). The sample beads with the 40K PEG have equal amplification with the control beads which have the same DNA tags but no PEG. The overlapping curves clearly indicate that the conjugation of 40K PEG post synthesis does not impact the amplification of the DNA tags when compared with the control samples with no PEG. The 2 samples with beads were run 5 times and the MiliQ water was run in triplicate.

FIGS. 20A-B illustrate the effect of PEG-coated thin-shell on dispersity of compound loaded TentaGel® beads in aqueous cell culture media. The comparative bead dispersion 4 days after complete dispersion with probe sonication is shown, FIG. 20A without PEG coating and FIG. 20B with 40K PEG coating. The beads are loaded with fluorescein through a photocleavable linker as described in FIG. 11A. After 4 days of standing, large bead clumps are observed for the beads without PEG coating, whereas the beads are mostly dispersed as singlets in the beads with 40K PEG coating.

FIG. 21 illustrates the effect of magnetic beads in PEGA beads. The timecourse of the attraction of magnetic PEGA beads to the side is shown from the left, at time 1 second, 18 seconds, and 180 seconds. At 180 seconds, most of the magnetic PEGA beads are collected on the side of the tube.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for compositions, methods, devices and systems that improve screening of libraries in droplets. For example, there is a need for compositions that increase molecular retention in droplets for compounds with a range of physiochemical properties. There also is a need for droplets that can achieve 1:1 or about 1:1 encapsulation efficiency. There also is a need to improve droplet imaging. There also is a need to improve monodispersity, biocompatibility, suspendability and compressibility in aqueous media, low background auto-fluorescence, compatibility with a wide range of library chemistries in organic phase, and any combinations thereof.

For cellular screens of biologics in droplets, the continuous phase can be a fluorinated oil, due to its gas permeability, low cell toxicity and chemical inertness (C. Holtze et al. 2008). Emulsifiers to stabilize water in fluorinated oil emulsions include di- and tri-block co-polymers (US2010105112; Li et al. 2020; Christian Holtze et al. 2008). Retention of hydrophobic organic molecules relevant to drug screening can be challenging (Etienne et al. 2018; Janiesch et al. 2015). Leakage into the carrier oil and cross-contamination across the droplet compartments can obfuscate the assay results, particularly if longer incubation times are needed for cellular screens, and/or if compound loaded bead encapsulation efficiency (lambda, see (MacConnell and Paegel 2017)) is high.

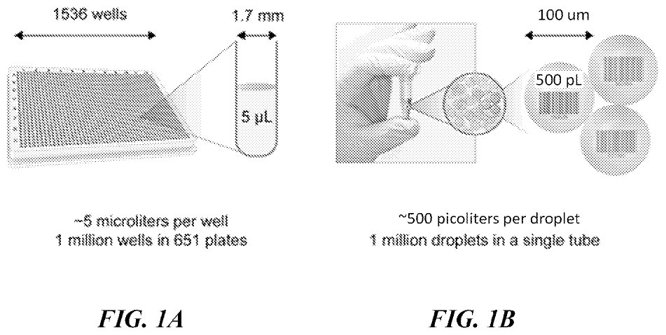

FIGS. 1-19 provide a description of exemplary compositions, devices, methods, sorters, uses, and systems for performing high-throughput screening in microdroplets.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used in the specification and claims, the term “fluorous dispersion oil” refers to a fluorinated oil in which microdroplets can be dispersed.

As used in the specification and claims, the term “perfluorocarbon” refers to a compound consisting wholly of fluorine and carbon.

As used in the specification and claims, the term “perfluorinated compound” refers to a compound containing carbon, fluorine, and preferably at least one heteroatom, and does not contain a C—H bond on the main chain.

As used in the specification and claims, the term “perfluorinated oil” refers to a perfluorocarbon, perfluoroether or partially fluorinated fluoroethers, perfluoroamine or partially fluorinated perfluoroamine.

As used in the specification and claims, the term “hydrofluoroether” refers to an ether compound containing at least one hydrogen and at least one fluorine.

As used in the specification and claims, the term “linked” or “linking” refers to direct and/or indirect linkages. A linkage can include a covalent linkage, or a noncovalent linkage, such as a hydrogen bond or ionic bond. A linkage can be reversible (e.g. photo-cleavable linker) or irreversible.

The term “functionalization handle” as used herein refers to an attachment point that allows linkage of one or more molecules, such as a barcode and/or compound (e.g., small molecule). The barcode may be a protein, a peptide, an enzyme, a nucleic acid, or any other substance which may act as a barcode to allow identification of the bead (bead specific barcode, BSB) and the compound loaded on the bead (compound specific barcode, CSB). In an embodiment, the nucleic acid is DNA.

Provided herein are continuous phase formulations that stabilize and/or increase molecular retention in droplet emulsions. In some examples, the continuous phase formulation contains a fluorous dispersion oil and a droplet stabilizer comprising an emulsifier. In some embodiments, the fluorous dispersion oil can have an average fluorine content of about 70 wt % or more. In some embodiments, the emulsifier can be selected from the group consisting of a triblock copolymer, a diblock copolymer, a fluorinated silica nanoparticle, and a combination thereof.

Nanoparticles have been reported to stabilize droplets by coating the droplet interface forming a pickering emulsion (Gai et al., 2017; Tang et al., 2016). Such nanoparticles can be further modified to attain compatibility with fluorinated oil of higher fluorine content than 2-(trifluoromethyl)-3-ethoxydodecafluorohexane (HFE-7500) to improve molecular retention while attaining sufficient droplet stability for microfluidic screening operations, and can be used alone or in combination with known emulsifiers, such as FluoSurf (Emulseo), 008-FluoroSurfactant (RAN Biotechnologies), and PicoSurf (Sphere Fluidics, Ltd.)

In some embodiments, a triblock or diblock copolymer, or a combination thereof, described herein, can be present in the continuous phase formulation at a concentration of, for example 0.1%-10% w/w, 0.2%-8% w/w, 0.3%-6% w/w, 0.4%-5% w/w, or 0.5%-3% w/w. In some embodiments, the triblock or diblock copolymer, or a combination thereof, can be present in the continuous phase formulation at a concentration of 0.3% -4% w/w, such as 2% w/w. In some embodiments, the copolymers described herein are polydisperse copolymers.

In some embodiments a nanoparticle described herein can be present in the continuous phase formulation. In some further embodiments, the nanoparticle is a partially derivatized silica nanoparticle. In yet some further embodiments, the nanoparticle is present in the continuous phase formulation at a concentration of, for example 0.1-15% w/w, 0.5-10% w/w, 1%-9% w/w, or 2%-8% w/w. In some embodiments, the nanoparticle is a partially derivatized silica nanoparticle and is present in the continuous phase formulation at a concentration of 2-8% w/w.

In some embodiments, the fluorous dispersion oil can contain a perfluorocarbon, a perfluorinated oil, a hydrofluoroether, or any combination thereof. In some embodiments, the fluorous dispersion oil comprises one or more oils selected from the group consisting of perfluorocarbons and perfluorinated oils; and/or one or more hydrofluoroethers. In some embodiments, the fluorous dispersion oil comprises one or more oils selected from the group consisting of perfluorocarbons and perfluorinated oils; and one or more hydrofluoroethers. In some embodiments, the fluorous dispersion oil comprises one or more oils selected from the group consisting of perfluorocarbons and perfluorinated oils; or one or more hydrofluoroethers. In some embodiments, the fluorous dispersion oil comprises one or more oils selected from the group consisting of perfluorocarbons and perfluorinated oils. In some embodiments, the fluorous dispersion oil comprises one or more oils selected from one or more hydrofluoroethers. In some embodiments, the total concentration of perfluorocarbon(s) and/or perfluorinated oils in the fluorous dispersion oil is about 50% w/w or more. In some embodiments, the total concentration of the perfluorocarbon(s) and/or perfluorinated oil(s) in the fluorous dispersion oil is about 50% w/w or more; and/or the concentration of the one or more hydrofluoroethers in the fluorous dispersion oil is about 50% w/w or less.

In some embodiments, the total concentration of the perfluorocarbon(s) and the perfluorinated oil(s) in the fluorous dispersion oil is about 50% w/w or more; and the concentration of the one or more hydrofluoroethers in the fluorous dispersion oil is about 50% w/w or less.

In some embodiments, the total concentration of the perfluorocarbon(s) or the perfluorinated oil(s) in the fluorous dispersion oil is about 50% w/w or more; and the concentration of the one or more hydrofluoroethers in the fluorous dispersion oil is about 50% w/w or less.

In some embodiments, the total concentration of the perfluorocarbon(s) or the perfluorinated oil(s) in the fluorous dispersion oil is about 50% w/w or more; or the concentration of the one or more hydrofluoroethers in the fluorous dispersion oil is about 50% w/w or less.

In some embodiments, the concentration of the one or more hydrofluoroethers in the fluorous dispersion oil is about 50% w/w or less. Selection of particular fluorous dispersion oils, triblock and/or diblock copolymers, and fluorinated silica nanoparticles, and their respective concentrations, if present, can be adjusted for specific buffer systems in a screening biochemical/cellular assay(s).

The following are exemplary continuous phase formulations for use in the compositions, sorters, uses, methods, devices, and systems provided herein:
A: A triblock and/or diblock copolymer (0.5%-3% w/w) dispersed in a mixture of perfluorocarbons and/or perfluorinated oils (50% w/w or more) and hydrofluoroether (0-50% w/w);
B: Nanoparticles (e.g., a partially fluorinated silica nanoparticle) (2-8% wt) dispersed in a mixture of perfluorocarbons and/or perfluorinated oils (50% w/w or more) and hydrofluoroether (0-50% w/w); and
C: A triblock and/or diblock copolymer (0.5-3 w/w) and a Pickering Emulsifier (2-8% w/w) dispersed in a mixture of perfluorocarbons and/or perfluorinated oils (50% w/w or more) and hydrofluoroether (0-50% w/w).

The following are exemplary continuous phase formulations for use in the compositions, sorters, uses, methods, devices, and systems provided herein:
A: A triblock and a diblock copolymer (0.5%-3% w/w) dispersed in a mixture of perfluorocarbons and/or perfluorinated oils (50% w/w or more) and hydrofluoroether (0-50% w/w);
B: Nanoparticles (e.g., a partially fluorinated silica nanoparticle) (2-8% wt) dispersed in a mixture of perfluorocarbons and/or perfluorinated oils (50% w/w or more) and hydrofluoroether (0-50% w/w); and
C: A triblock and a diblock copolymer (0.5-3 w/w) and a Pickering Emulsifier (2-8% w/w) dispersed in a mixture of perfluorocarbons and/or perfluorinated oils (50% w/w or more) and hydrofluoroether (0-50% w/w).

The following are exemplary continuous phase formulations for use in the compositions, sorters, uses, methods, devices, and systems provided herein:
D: A triblock and a diblock copolymer (0.5%-3% w/w) dispersed in a mixture of perfluorocarbons and perfluorinated oils (50% w/w or more) and hydrofluoroether (0-50% w/w);
E: Nanoparticles (e.g., a partially fluorinated silica nanoparticle) (2-8% wt) dispersed in a mixture of perfluorocarbons and perfluorinated oils (50% w/w or more) and hydrofluoroether (0-50% w/w); and
F: A triblock and a diblock copolymer (0.5-3% w/w) and a Pickering Emulsifier (2-8% w/w) dispersed in a mixture of perfluorocarbons and perfluorinated oils (50% w/w or more) and hydrofluoroether (0-50% w/w).

The following are exemplary continuous phase formulations for use in the compositions, sorters, uses, methods, devices, and systems provided herein:
G: A triblock and a diblock copolymer (0.5%-3% w/w) dispersed in a mixture of perfluorocarbons or perfluorinated oils (50% w/w or more) and hydrofluoroether (0-50% w/w);
H: Nanoparticles (e.g., a partially fluorinated silica nanoparticle) (2-8% wt) dispersed in a mixture of perfluorocarbons and perfluorinated oils (50% w/w or more) and hydrofluoroether (0-50% w/w); and
I: A triblock and a diblock copolymer (0.5-3% w/w) and a Pickering Emulsifier (2-8% w/w) dispersed in a mixture of perfluorocarbons or perfluorinated oils (50% w/w or more) and hydrofluoroether (0-50% w/w).

The following are exemplary continuous phase formulations for use in the compositions, sorters, uses, methods, devices, and systems provided herein:
J: A triblock or a diblock copolymer (0.5%-3% w/w) dispersed in a mixture of perfluorocarbons and/or perfluorinated oils (50% w/w or more) and hydrofluoroether (0-50% w/w);
K: Nanoparticles (e.g., a partially fluorinated silica nanoparticle) (2-8% wt) dispersed in a mixture of perfluorocarbons and/or perfluorinated oils (50% w/w or more) and hydrofluoroether (0-50% w/w); and
L: A triblock or a diblock copolymer (0.5-3% w/w) and a Pickering Emulsifier (2-8% w/w) dispersed in a mixture of perfluorocarbons and/or perfluorinated oils (50% w/w or more) and hydrofluoroether (0-50% w/w).

The following are exemplary continuous phase formulations for use in the compositions, sorters, uses, methods, devices, and systems provided herein:
M: A triblock or a diblock copolymer (0.5%-3% w/w) dispersed in a mixture of perfluorocarbons and perfluorinated oils (50% w/w or more) and hydrofluoroether (0-50% w/w);
N: Nanoparticles (e.g., a partially fluorinated silica nanoparticle) (2-8% wt) dispersed in a mixture of perfluorocarbons and perfluorinated oils (50% w/w or more) and hydrofluoroether (0-50% w/w); and
O: A triblock or a diblock copolymer (0.5-3 w/w) and a Pickering Emulsifier (2-8% w/w) dispersed in a mixture of perfluorocarbons and perfluorinated oils (50% w/w or more) and hydrofluoroether (0-50% w/w).

The following are exemplary continuous phase formulations for use in the compositions, sorters, uses, methods, devices, and systems provided herein:
P: A triblock or a diblock copolymer (0.5%-3% w/w) dispersed in a mixture of perfluorocarbons or perfluorinated oils (50% w/w or more) and hydrofluoroether (0-50% w/w);
Q: Nanoparticles (e.g., a partially fluorinated silica nanoparticle) (2-8% wt) dispersed in a mixture of perfluorocarbons or perfluorinated oils (50% w/w or more) and hydrofluoroether (0-50% w/w); and
R: A triblock or a diblock copolymer (0.5-3% w/w) and a Pickering Emulsifier (2-8% w/w) dispersed in a mixture of perfluorocarbons or perfluorinated oils (50% w/w or more) and hydrofluoroether (0-50% w/w).

### Diblock Copolymers

In some embodiments, the diblock copolymer comprises a fluorophilic component. In other embodiments, the diblock copolymer comprises a fluorophilic component and a PEG group. In a further embodiment, the diblock copolymer comprises a perfluorinated polyether (PFPE) and a PEG group. The fluorophilic component of the diblock copolymer described herein typically comprises a fluorophilic chain at least C₈ in length (i.e., contains at least 8 carbon atoms). In some embodiments, the fluorophilic chain is at least C₁₀ in length, at least C₁₅ in length, at least C₂₀ in length, at least C₂₅ in length, or at least C₃₀ in length. In other embodiments, the fluorophilic chain is at least C₅₀ in length, at least C₇₅ in length, at least C₁₀₀ length, or greater. As a non-limiting example, a fluorophilic component having the structure —(C₃F₆O)₁₀— has 30 carbons equivalent to a C₃₀ chain. The fluorophilic component may be linear, branched, cyclic, saturated, unsaturated, etc.

In some embodiments, the fluorophilic component of the diblock copolymer includes a heteroatom (e.g., a non-carbon such as oxygen (e.g., divalent oxygen), sulfur (e.g., divalent or hexavalent sulfur), nitrogen (e.g., trivalent nitrogen), etc.) in the structure of the component. Such heteroatoms may be bonded, for example, to carbon atoms in the skeletal structure of the component. Additionally and/or alternatively, the fluorophilic component may include one or more branches extending from the main chain of the structure.

In some embodiments, the diblock copolymer for use in the compositions, methods, sorters, uses, devices, and systems provided herein can include those as described in US 2010/0105112 A1.

In some embodiments, the diblock copolymer is a copolymer of the following Formula 1, or a combination thereof

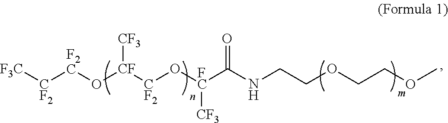

wherein in Formula 1, n and m are exact values or average values of polydisperse building blocks, n is from 35-45, and m is from 2-24. In some embodiments, the exact or average molecular weight of the copolymer of Formula 1 is between 1,000-10,000 Da. In some embodiments, n is about 38 and m is about 17. In some embodiments, n is about 38 and m is about 9.

### Triblock Copolymers

In some embodiments, the triblock copolymer comprises a fluorophilic component. In some embodiments, the triblock copolymer comprises at least one fluorophilic component, e.g. two fluorophilic components. In other embodiments, the triblock copolymer comprises at least one fluorophilic component, e.g. two fluorophilic components, and a PEG group. In a further embodiment, the triblock copolymer comprises at least one perfluorinated polyether (PFPE) chain, e.g. two perfluorinated polyether (PFPE) chains, and a PEG group. The fluorophilic component of the triblock copolymer described herein typically comprises a fluorophilic chain at least C₈ in length (i.e., contains at least 8 carbon atoms). In some embodiments, the fluorophilic chain is at least C₁₀ in length, at least C₁₅ in length, at least C₂₀ in length, at least C₂₅ in length, or at least C₃₀ in length. In other embodiments, the fluorophilic chain is at least C₅₀ in length, at least C₇₅ in length, at least C₁₀₀ length, or greater. As a non-limiting example, a fluorophilic component having the structure —(C₃F₆O)₁₀— has 30 carbons equivalent to a C₃₀ chain. The fluorophilic component may be linear, branched, cyclic, saturated, unsaturated, etc.

In some embodiments, the fluorophilic component of the triblock copolymer includes a heteroatom (e.g., a non-carbon such as oxygen (e.g., divalent oxygen), sulfur (e.g., divalent or hexavalent sulfur), nitrogen (e.g., trivalent nitrogen), etc.) in the structure of the component. Such heteroatoms may be bonded, for example, to carbon atoms in the skeletal structure of the component. Additionally and/or alternatively, the fluorophilic component may include one or more branches extending from the main chain of the structure.

In some embodiments, the triblock copolymer for use in the compositions, methods, sorters, uses, devices, and systems provided herein can include those as described in US 2010/0105112 A1.

In some embodiments, the triblock copolymer is a copolymer of the following Formula 2, a copolymer of the following Formula 3, or a combination thereof:

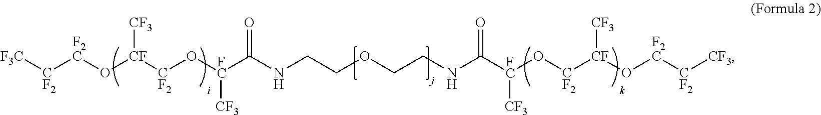

wherein in Formula 2, i, j and k are exact values or average values of polydisperse building blocks, and wherein i and k are independently from 35-45, and j is 1-23. In some embodiments, the exact or average molecular weight of the copolymer of Formula 2 is between 2,000-20,000 Da. In some embodiments, i and k are independently about 38 and j is about 9, about 10, or about 11; and

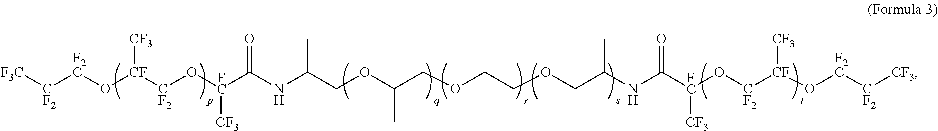

wherein in Formula 3, p, q, r, s and t are exact values or average values of polydisperse building blocks, and wherein p and t are independently from 35-45, r is 1-23; q and s are each greater than zero, and the exact or average of the sum q+s is 3-6. In some embodiments, p and t are independently about 38, r is about 12.5, q and s are greater than zero, and the exact or average of the sum q+s is about 6. In some embodiments, p and t are independently about 38, r is about 39, q and s are each greater than zero, and the sum q+s is about 6. In some embodiments, the exact or average molecular weight of the copolymer of Formula 3 is between 2,000-20,000 Da.

### Partially Fluorinated Silica Nanoparticles

Increasing surface fluorophilicity of silica nanoparticles can improve dispersion in perfluorocarbons. In some embodiments, the fluorinated silica nanoparticle is partially derivetized. In some embodiments, the fluorinated silica nanoparticles can have a size of about 100 nm, for example 110 nm with a distribution from 80-130 nm. Examples of fluorinated silica nanoparticles for use in the compositions, methods, uses, sorters, devices, and systems provided herein include a partially fluorinated silica nanoparticle of the following Formula 4, and a partially fluorinated silica nanoparticle of the following Formula 5:

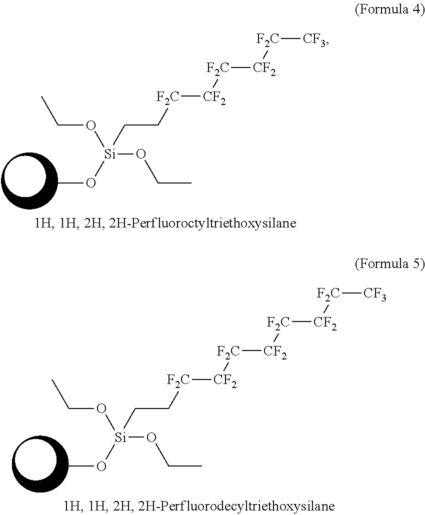 [SMILES: CCO[Si](CCC(F)(F)C(F)(F)C(F)(F)C(F)(F)C(F)(F)C(F)(F)F)(OC)OCC ; CCO[Si](CCC(F)(F)C(F)(F)C(F)(F)C(F)(F)C(F)(F)C(F)(F)C(F)(F)C(F)(F)F)(OC)OCC]

### Fluorous Dispersion Oils

In some embodiments, exemplary fluorous dispersion oils for use in the compositions, sorters, uses, methods, devices, and systems provided herein include the oils set forth in Table 1 below, and combinations thereof:

TABLE 1
Fluorous dispersion oils

| | | | Perfluoro-1,3 | | Perfluoro 2- | |
|---|---|---|---|---|---|---|
| | Perfluro- | Perfluoro- | Dimethyl- | Perfluoro- | butyltetra- | |
| Oils | octane | hexane | Cyclohexane | tripropylamine | hydrofuran | HFE-7500 |
| MW | 438 | 338 | 400 | 521 | 416 | 414 |
| Formula | C₈F₁₀ | C₆F₁₄ | C₈F₁₆ | C₉F₂₁N | C₈F₁₆O | C₉H₅F₁₅O |
| Fluorine | 82 | 78 | 76 | 76 | 73 | 66 |
| content (%) | | | | | | |
| Density | 1.77 | 1.68 | 1.83 | 1.82 | 1.77 | 1.61 |

In some embodiments, the continuous phase formulations comprise a fluorous dispersion oil and a droplet stabilizer comprising an emulsifier that is a diblock copolymer, a triblock copolymer, or a combination thereof. In some embodiments, the fluorous dispersion oil can be selected from among the following:
a mixture of perfluorohexane(FC-72):perfluorooctane: 2-(trifluoromethyl)-3-ethoxydodecafluorohexane (HFE-7500) in a 1:1:1 w/w ratio or about a 1:1:1 w/w ratio, respectively;
a mixture of perfluorohexane(FC-72):perfluorooctane: 2-(trifluoromethyl)-3-ethoxydodecafluorohexane (HFE-7500) in a 2:2:1 w/w ratio or about a 2:2:1 w/w ratio, respectively; and
a mixture of perfluorohexane(FC-72):perfluorooctane: 2-(trifluoromethyl)-3-ethoxydodecafluorohexane (HFE-7500) in a 1:3:1 w/w ratio or about a 1:3:1 w/w ratio, respectively,
   and the emulsifier is the following combination of diblock and triblock copolymers:
a diblock copolymer of Formula 1 as described herein; and
a triblock copolymer selected from the group consisting of compounds of Formula 2 and
Formula 3 as described herein, and combinations thereof.

In some embodiments, a continuous phase formulation described herein can include a Pickering emulsifier, such as a fluorinated silica nanoparticle. In further embodiments, the Pickering emulsifier is a 8% wt fluorinated silica nanoparticle (100 nm) of the following Formula 6:

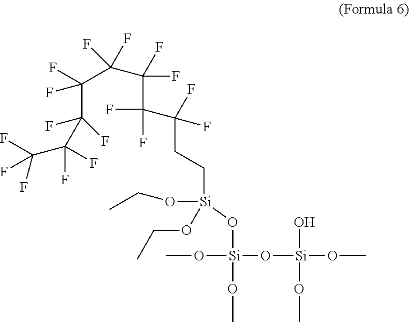 [SMILES: CCO[Si](CCC(F)(F)C(F)(F)C(F)(F)C(F)(F)C(F)(F)C(F)(F)C(F)(F)C(F)(F)F)(OCC)O[Si](OC)(OC)O[Si](O)(OC)OC]

Provided herein are methods of reducing cross-contamination between microdroplets. In some embodiments, the methods can comprise generating droplets in a continuous phase formulation, such as a continuous phase formulation comprising an oil and an emulsifier as described herein. In some embodiments, the emulsifier can be present at a concentration of about 0.3% to about 4% w/w, or about 2% w/w. In some embodiments, the emulsifier can be present at a concentration of about 0.3%, about 0.5%, about 1%, about 1.5%, about 2%, about 2.5%, about 3%, about 3.5%, about 4%, about 0.3% to about 2%, about 0.5% to about 2%, about 1% to about 2%, about 1% to about 1.5%, or about 1.5% to about 2%. In some embodiments, the oil can be a fluorous oil, a mineral oil, a silicone oil or any other water immiscible oil. In some embodiments, the oil can be a hydrocarbon based oil such as mineral oil, hexadecane, silicone oil, sunflower oil, light mineral oil, kerosene, decane, undecane, dodecane, octane, cyclohexane, hexane, or the like In some embodiments, droplets can be generated with a syringe pump.

After droplets are generated, droplets can be collected, (e.g., in an Eppendorf tube). The continuous phase can be exchanged with a fluorous dispersion oil, such as a mixture of perfluorohexane(FC-72):perfluorooctane: 2-(trifluoromethyl)-3-ethoxydodecafluorohexane (HFE-7500) in a 1:3:1 ratio. In some examples the volume of the second fluorous dispersion oil can be about the same as the volume of droplets (for example, for 20 μL of droplets, 20 μL of the fluorous dispersion oil can be used). Exchange with the fluorous dispersion oil can be performed more than once (for example, a total of 2, 3, 4, 5 times or more). The droplets can achieve prolonged compound retention, for example, greater than 1, greater than 2, greater than 3, greater than 4, greater than 5, greater than 6, greater than 7 or greater than 8 days of compound retention. In some embodiments, droplets can be incubated for 30-60 min between one or more exchange steps. In some embodiments of methods of reducing cross-contamination between microdroplets, the continuous phase can be exchanged with a first fluorous dispersion oil, to provide the aqueous microdroplet suspended in the first fluorous dispersion oil. In some embodiments, the first fluorous dispersion oil can be exchanged with a second fluorous dispersion oil, to provide the aqueous microdroplet suspended in the second fluorous dispersion oil. In some embodiments, the first fluorous dispersion oil can have an average fluorine content of>70 wt %, and contain a Pickering emulsifier. In some further embodiments, the Pickering emulsifier can be a fluorinated silica nanoparticle, such as a fluorinated silica nanoparticle of Formula 6

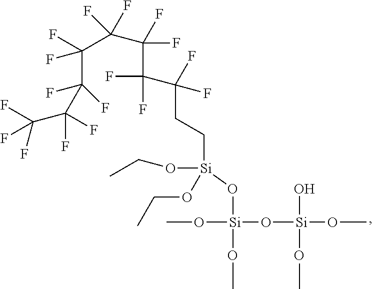 [SMILES: CCO[Si](CCC(F)(F)C(F)(F)C(F)(F)C(F)(F)C(F)(F)C(F)(F)C(F)(F)C(F)(F)F)(OCC)O[Si](OC)(OC)O[Si](O)(OC)OC]

for example, an 8% wt fluorinated silica nanoparticle (100 nm) of Formula 6

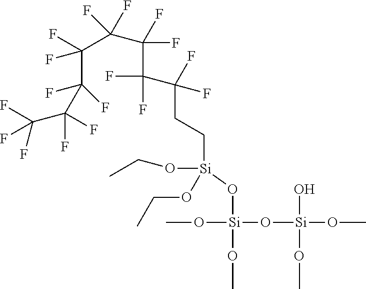 [SMILES: CCO[Si](CCC(F)(F)C(F)(F)C(F)(F)C(F)(F)C(F)(F)C(F)(F)C(F)(F)C(F)(F)F)(OCC)O[Si](OC)(OC)O[Si](O)(OC)OC]

dispersed in a mixture of perfluoro 2-butyltetrahydrofuran and 2-(trifluoromethyl)-3-ethoxydodecafluorohexane (HFE-7500). In some embodiments, the second fluorous dispersion oil can have an average fluorine content of>70 wt % and not contain an emulsifier. In some examples the volume of the fluorous dispersion oil can be about the same as the volume of droplets (for example, for 20 μL of droplets, 20 μL of the fluorous dispersion oil can be used). Exchange with the fluorous dispersion oil can be performed more than once (for example, a total of 2, 3, 4, 5 times or more). The droplets can achieve prolonged compound retention, for example, greater than 1, greater than 2, greater than 3, greater than 4, greater than 5, greater than 6, greater than 7 or greater than 8 days of compound retention. In some embodiments, droplets can be incubated for 30-60 min between one or more exchange steps. In some embodiments, the second dispersion oil can be further exchanged with a third dispersion oil with emulsifiers described above to provide stability for further droplet manipulations.

### Compound Library Matrix

In the compositions, methods, uses, sorters, devices, and systems provided herein in which an encoded library member is delivered into a single droplet. A matrix such as a bead can be utilized as a carrier for the compounds and the corresponding barcodes. Examples of matrices include hydrogel beads, core-shell beads, hydrogel-shell beads, magnetic hydrogel beads, and capsules. In some embodiments, the beads are monodisperse.

### Monodisperse Hydrogel Beads

In some embodiments, the compound library matrix, e.g., beads, resin or hydrogels, can be a composition of polyethylene glycol acrylamide co-polymer (PEGA), which can exhibit excellent swelling properties in both aqueous and organic solvents, chemical compatibility and stability towards a broad range of organic reactions, loading capacity to achieve the target compound concentration in a droplet, dispersity in aqueous media when loaded with hydrophobic library compounds, compressibility to achieve quantitative 1:1 encapsulation into droplets in microfluidic devices, and low background autofluorescence to minimize assay interference in droplet based screens. Quantitative (1:1) encapsulation of compressible compound beads enhances the screening throughput. Without wishing to be bound by any theory, the screening throughput enhancement is achieved by reducing the statistics from double Poisson to single Poisson, meaning that with compressible beads up to every droplet will contain the assay relevant compound bead, whereas with non-compressible compound beads, which cannot be packed in the microfluidic channel, results in many empty droplets for the down-stream sorter to process thereby decreasing the screening throughput. Furthermore, having a bioassay that can tolerate multiple cells per droplet in combination with compressible beads will result in more droplets that are assay relevant since most of them contain at least one cell.

Provided herein are methods in which monodisperse PEGA resin is prepared via in-droplet polymerization. In some embodiments, the methods can be performed with microfluidic devices that can generate monodisperse droplets of desired size. In some embodiments, the monodisperse droplets can be generated at a very high throughput. Mono-dispersity can improve consistency of compound loading capacity that can determine intra-droplet compound concentration and hence screening data for droplet based screens. In the methods provided herein, the size distribution of droplet generated PEGA resin can be within 10%, 9%, 8%, 7%, 6%, 5%, 4%, 3%, 2% or 1%. In some embodiments, the size distribution of droplet generated PEGA resin can be within 5%.

In some embodiments, the throughput of in-droplet polymerization can be increased by having one or more droplet splitters in the microfluidic chip design, so that many droplets are generated in parallel.

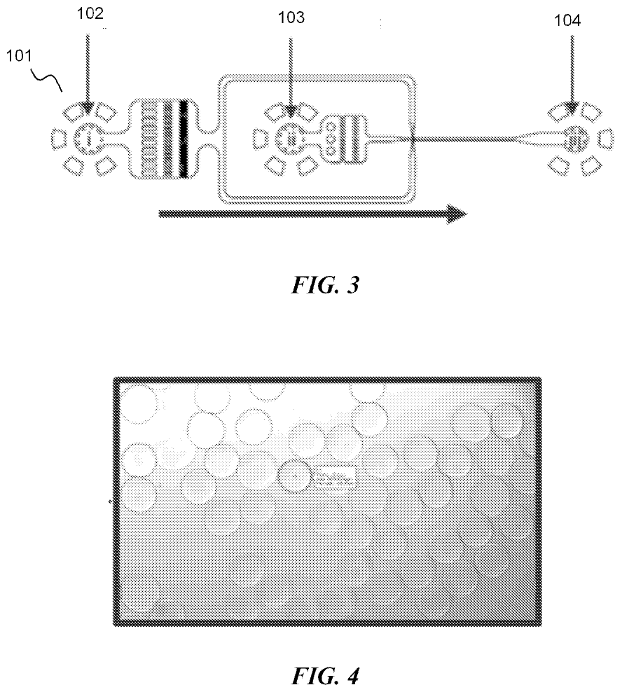

FIG. 3 representationally depicts an exemplary microfluidics device (i.e., a chip) for generating droplets. In some embodiments, a droplet generation chip 101 can include a continuous phase formulation input 102, and an input 103 for an aqueous buffer containing a plurality of monomers of PEGA resin. In some embodiments, the monomers of PEGA resin can be introduced into micro-droplets using microfluidics device 101 through input 103. The droplets can exit the device at droplet output 104. In some embodiments, the monomers of PEGA resin can undergo in-situ polymerization. In-situ polymerization can be initiated by a polymerization initiator, such as TEMED in the continuous phase, and ammonium persulfate (APS) in the aqueous phase. The PEGA resin can have three components: 1) acrylamide (e.g., an acrylamide backbone), 2) bis-acrylamide PEG, and 3) mono-acrylamide PEG with a functionalization handle and/or a mono-acrylamide diamine comprising a functionalization handle. In some embodiments, the functionalization handle can be, but is not limited to: free amine, a protected amine (e.g., a Boc protected amine or an Fmoc protected amine), or a protected or unprotected alcohol, acid or ester, azide, acetylene or tetrazine. FIG. 4 shows monodisperse PEGA resin prepared using a droplet generation chip depicted in FIG. 3.

In some embodiments, monomer components of the PEGA resin exemplified in this disclosure are listed below. Described herein are exemplary compositions and methods for preparing amino-modified PEGA resin. It is understood that monomers can be used containing other functional groups, such as other functional groups described herein. It also is understood that methods described herein can be applied to preparation of other PEGA resins, such as PEGA resins containing other functional groups.

In some embodiments, an acrylamide monomer for use in the compositions, methods, uses, sorters, devices, and systems provided herein, can include acrylamide (i.e., CH₂═CHC(O)NH₂), N-methylacrylamide, N,N-dimethylacrylamide, and combinations thereof. In some embodiments, the acrylamide monomer is N,N-dimethylacrylamide. In some embodiments, a bis-acrylamide PEG for use in the compositions, methods, uses, sorters, devices, and systems provided herein can include a compound of the following Formula 7:

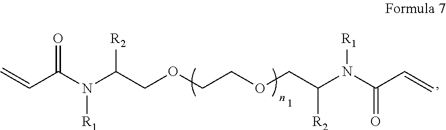

wherein in Formula 7, R₁ and R₂ are independently H or —CH₃, n₁ is an exact value or average value, and n₁ is 1-108. In some embodiments, n₁ is selected so that the bis-acrylamide PEG has an average molecular weight from 250-5000 Daltons, and in further embodiments, n₁ is selected so that the bis-acrylamide PEG has an average molecular weight from 800-2000 Daltons.

In some embodiments, a mono-acrylamide PEG for use in the compositions, methods, uses, sorters, devices, and systems provided herein is a compound of Formula 8:

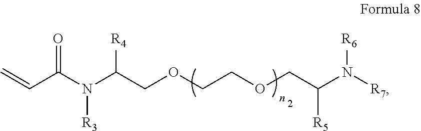

wherein in Formula 8, R₃-R₆ are independently H or —CH₃, R₇ is hydrogen, Boc or Fmoc, n₂ is an exact value or average value, and n₂ is 1-109. In some embodiments n₂ is selected so that the mono-acrylamide PEG has a molecular weight from 158-5000 Daltons. In some embodiments, n₂ is 4.

In some embodiments, the mono-acrylamide ethylene diamine for use in the compositions, methods, uses, sorters, devices, and systems provided herein is a compound of Formula 9:

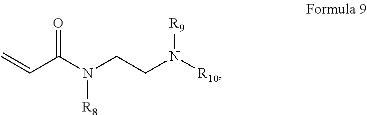

wherein in Formula 9, R₈, R₉ are independently H or —CH₃, and R₁₀ is selected from the group consisting of H, Boc, and Fmoc.

In some embodiments, the PEGA resin has a structure shown in Formula 10:

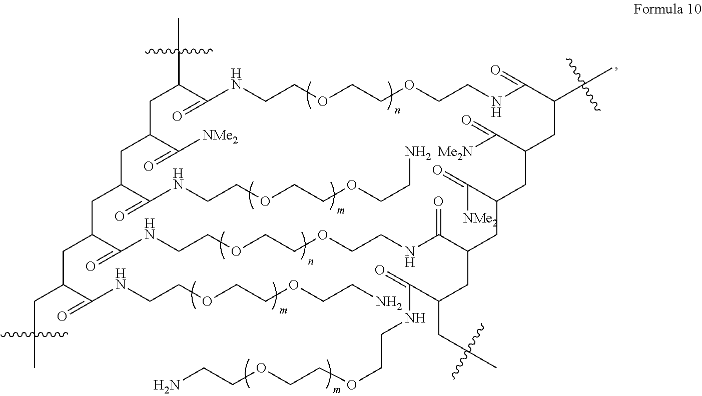

wherein in Formula 10, each NH₂ can independently be a functionalization handle for compound/DNA loading.

In some embodiments, the example monomer molar ratio can be: N,N-dimethylacrylamide: Bis-PEG-acrylamide(2000D):Boc-amino-PEG-acrylamide=44:1:7 or about 44:1:7.

In some embodiments, PEGA resin beads can be prepared via bulk emulsion methods to prepare the hydrogel beads in poly-disperse manner, which can then be passed through several cell strainers with different mesh sizes to obtain resins with a defined size distribution.

### Hydrogel-Shell Beads

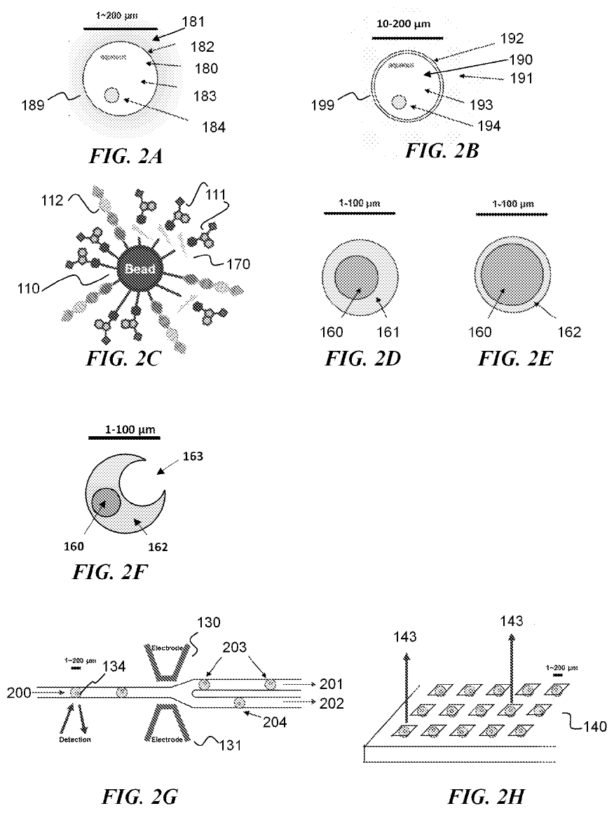

FIG. 2D representationally depicts a compound loading bead 160 encapsulated in a hydrogel matrix 161. FIG. 2E representationally depicts a compound loading bead 160 coated in a hydrophilic polymer 162.

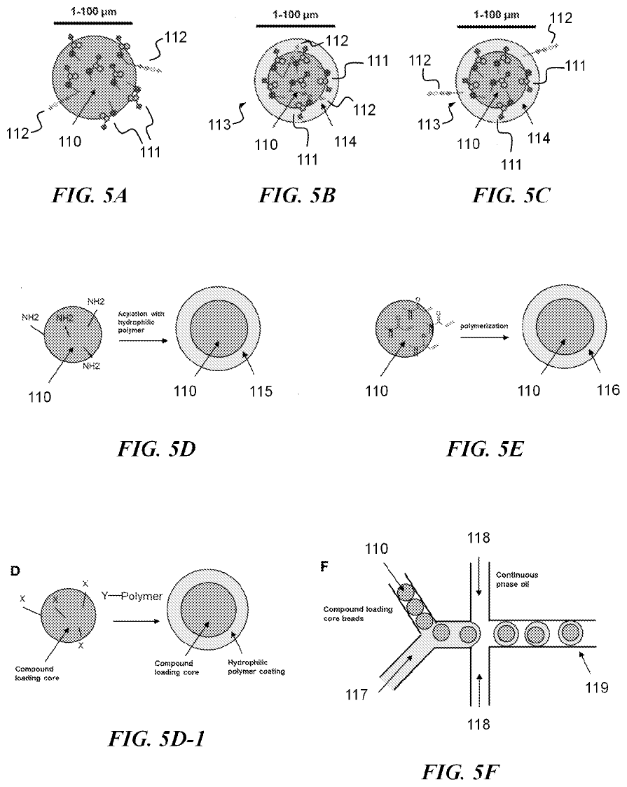

FIGS. 5B-C illustrate different embodiments in which a compound loading bead, such as any hydrogel bead or polystyrene core bead described herein (FIG. 5A) can be modified to improve the physicochemical properties to facilitate bead handling for both library preparation and droplet microfluidics. Such modification can provide the same hydrophilic outer layer regardless of the types of linkers and ligands loaded on the beads, minimizing the compound dependency of the bead behavior such as aqueous suspendability depending on the linker and ligand loaded on the hydrogel bead or polystyrene core bead. FIG. 5A depicts an embodiment in which a compound loading bead 110 is linked to ligands 111 and barcodes 112. FIG. 5B depicts an embodiment in which a core-shell bead 113 includes a compound loading core 110, and a hydrophilic shell 114. Ligands 111 and barcodes 112 are linked to the compound loading core. In some embodiments, the barcode is DNA. FIG. 5C depicts an embodiments in which a core shell bead 113 includes a compound loading core 110, and a hydrophilic shell 114. Ligands 111 are linked to the compound loading core 110, and barcodes 112 are linked to the hydrophilic shell 114. In some embodiments, barcode is DNA.

FIG. 5D illustrates an embodiment in which a compound loading core 110, such as an amino modified hydrogel described herein such as PEGA or TentaGel® beads (FIG. 5D-1), can be modified (for example, partially modified) with installment of a hydrophilic polymer coating 115 to provide a hydrophilic surface (e.g., containing hydrophilic motifs) that can shield hydrophobic ligands from exposure. In some embodiments, the modification can be acylation. In other embodiments, the modification can be azide-acetylene click chemistry. In some further embodiments, the modification can be acylation with a hydrophilic polymer. In further embodiments, the modification can be azide acetylene click chemistry with azide on the solid-support and DBCO (dibenzocyclooctyne) functionalized hydrophilic polymer. Hydrophilic motifs can be, but are not limited to, PEG, PPG, polylactic acid, or a combination thereof.

In some embodiments, a compound library can be built on the compound loading core, such as amino-modified PEGA resin 110 or TentaGel® beads, prior to modification with a hydrophilic surface, for example prior to formation of dual-layer hydrogel beads or PEGylated TentaGel® beads. In such instances, a remaining azido handle on the split linker can be used as a handle, for example through click reaction with PEG conjugated alkyne or through reduction of the azide followed by amide coupling with PEG conjugated acid or activated acids thereof.

FIG. 5E illustrates an embodiment in which a compound loading core 110, such as an amino modified hydrogel described herein such as PEGA, can be modified (for example, partially modified) with a monomer, such as acrylamide to seed polymer shell formation, such as, for example, acrylamide based polymer shell formation. The polymer shell 116, for example, an acrylamide based polymer, can be, but is not limited to, polyacrylamide and PEGA.

FIG. 5F illustrates an embodiment in which a hydrogel compound loading core bead 110, such as amino modified hydrogel described herein, such as PEGA, can be entrapped in another layer of hydrogel such as PEGA. In some embodiments, entrapment can occur in a microfluidic chip. In some embodiments, entrapment can occur at 1:1 encapsulation efficiency. The compound loading core bead 110, such as amino-modified PEGA resin can be introduced into a droplet with shell monomers 117, such as naive PEGA monomers, to form a shell, physically entrapping the library beads. A continuous phase formulation, such as a continuous phase oil 118 is flowed through, to form core-shell beads. Polymerization can be effected by an initiator, such as APS in the aqueous phase and TEMED in the continuous phase. In some embodiments, polymerization can start when droplets are generated. TEMED in the continuous phase can initiate the process in the aqueous droplets. In some embodiments, polymerization can be accelerated by heating.

In another embodiment, amino-functionalized core naive-PEGA shell dual layer beads can be produced in a single microfluidic device where substrates for amino-modified PEGA resin can be introduced into the core of the droplet and the naive PEGA resin without functionalization handle is introduced into the periphery, and the layers are rapidly polymerized with TEMED to give core shell structure in a single experiment.

### Core Shell Beads

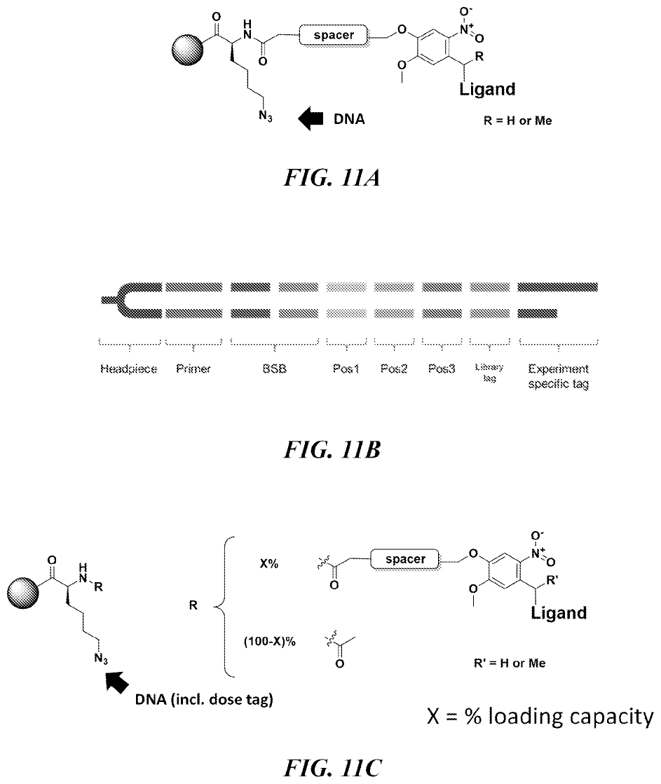

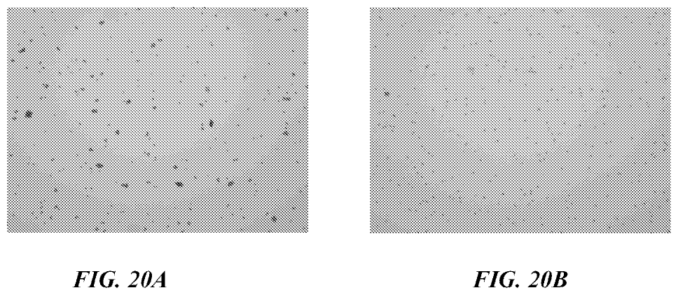

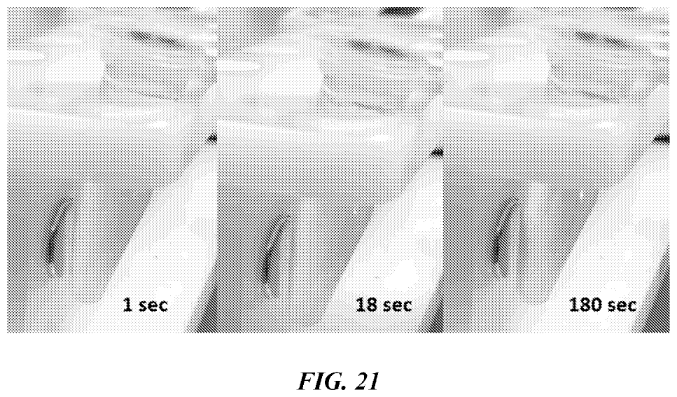

Provided herein are compositions, methods, uses, sorters, systems, and devices in which beads are encapsulated in a compressible hydrogel shell. In some embodiments, beads are encapsulated by in-droplet hydrogel formation. In some embodiments, in-droplet hydrogel formation is performed by a microfluidic device as described herein, such as a microfluidic device for preparing monodisperse PEGA resin. In some embodiments, Poisson statistics of bead encapsulation and/or clumping in aqueous media are improved by encapsulation. In some embodiments, the Poisson statistics of bead encapsulation and clumping in aqueous media of polystyrene-PEG hybrid beads, such as TentaGel® beads, can be improved. In some further embodiments, Poisson statistics of bead encapsulation and clumping in aqueous media, can be improved by encapsulation of polystyrene-PEG hybrid beads, such as TentaGel® beads, in a compressible hydrogel shell using in-droplet hydrogel formation utilizing microfluidic device as described herein, such as a microfluidic device for monodisperse PEGA resin preparation. In some embodiments, the hydrogel can be, for example, PEGA, polyacrylamide, alginate, agarose, collagen, or a combination thereof. In some further embodiments, the hydrogel can be polyacrylamide. Beads can be suspended in hydrogel monomers, encapsulated into the hydrogel in a microfluidic device. For example, 10 micron polystyrene-PEG hybrid beads, such as amino polystyrene-PEG hybrid (e.g. TentaGel®) library beads can be suspended in polyacrylamide hydrogel monomers, encapsulated into polyacrylamide in a microfluidic device to give a hydrogel shell, such as a 30 micron hydrogel shell or about a 30 micron hydrogel shell. FIGS. 20A-B illustrate the efect of PEG-coated thin-shell on dispersity of compound loaded TentaGel® beads in aqueous cell culture media. The comparative bead dispersion 4 days after complete dispersion with probe sonication is shown, FIG. 20A without PEG coating and FIG. 20B with 40K PEG coating. The beads are loaded with fluorescein through photo cleavable linker as described in FIG. 11A. After 4 days of standing, large bead clumps are observed for the beads without PEG coating, whereas the beads are mostly dispersed as singlets in the beads with 40K PEG coating.

Hydrogel encapsulated library beads, such as hydrogel encapsulated polystyrene-PEG hybrid library beads can achieve flexibility of performing combinatorial chemistry and DNA ligation under conventional methods (see, e.g., (MacConnell et al., 2015, 2017), while having flexibility of compressible hydrogel beads so that hydrogel encapsulated beads can encapsulate 1:1 or about 1:linto droplets (e.g., microdroplets). Encapsulation can be measured, for example, by analyzing the droplets in a hemocytometer/microscopy chamber slide (e.g. iBidi or Countess), which can make a close packed monolayer of droplets to observe under microscope, where the number of encapsulated vs empty droplets can be compared.

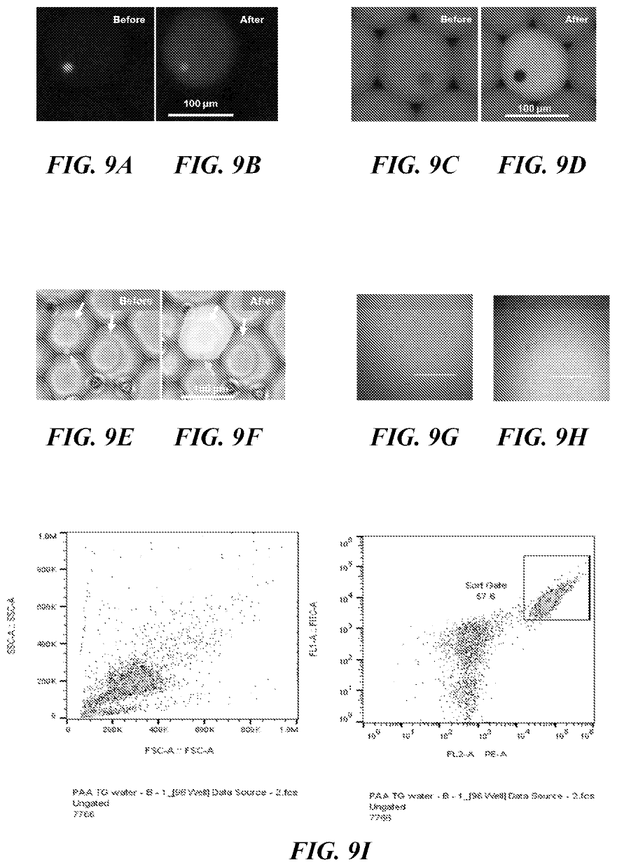

In some embodiments, the Poisson distribution of bead (e.g., polystyrene-PEG hybrid beads, such as TentaGel®) encapsulation into a hydrogel shell can be further improved by sorting hydrogel encapsulated beads, such as hydrogel encapsulated polystyrene-PEG hybrid beads prepared using droplet microfluidics, using standard FACS to enrich for hydrogel encapsulated beads containing only one or desired number of core bead(s) (e.g., only one polystyrene-PEG hybrid bead, such as TentaGel®), for example based on particular scatter or fluorescence signatures. FIG. 9G-9H show example of such enrichment process, where the crude TentaGel® in polyacrylamide population is 6% (FIG. 9G), while after FACS enrichment based on sub population of events that have significantly higher fluorescence in the FITC and PE channels (FIG. 9I), the TentaGel® encapsulated population is increased to 75% (FIG. 9H).

Poisson statistics of bead encapsulation and clumping can be improved for any bead described herein, such as, for example, polystyrene-PEG hybrid beads, such as M30102 TentaGel® M NH₂, Rapp Polymere GmbH. Hydrogels in which beads can be encapsulated include hydrogels described herein, such as PEGA, poly-acrylamide, alginate, agarose, collagen, or a combination thereof. In some embodiments, the hydrogel is a polyacrylamide hydrogel composition formed by polymerization of acrylamide and bis-acrylamide (Zilionis et al., 2017). In some embodiments, the acrylamide and bis-acrylamide have the following structures:
acrylamide-

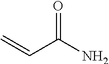

and bis-acrylamide-

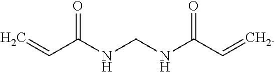

In some embodiments the hydrogel has the following structure:

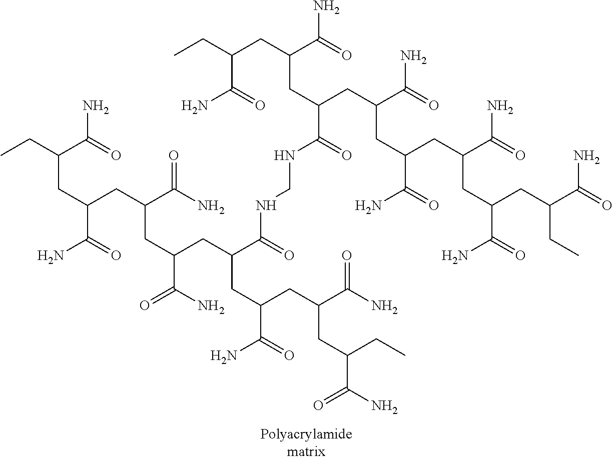 [SMILES: CCC(CC(CC(CC(CC(CC(CC(CC(CC)C(N)=O)C(N)=O)C(=O)NCNC(=O)C(CC(CC(CC(CC)C(N)=O)C(N)=O)C(N)=O)CC(CC(CC(CC(CC)C(N)=O)C(N)=O)C(N)=O)C(N)=O)C(N)=O)C(N)=O)C(N)=O)C(N)=O)C(N)=O]

### Magnetic Monodisperse Hydrogel Beads

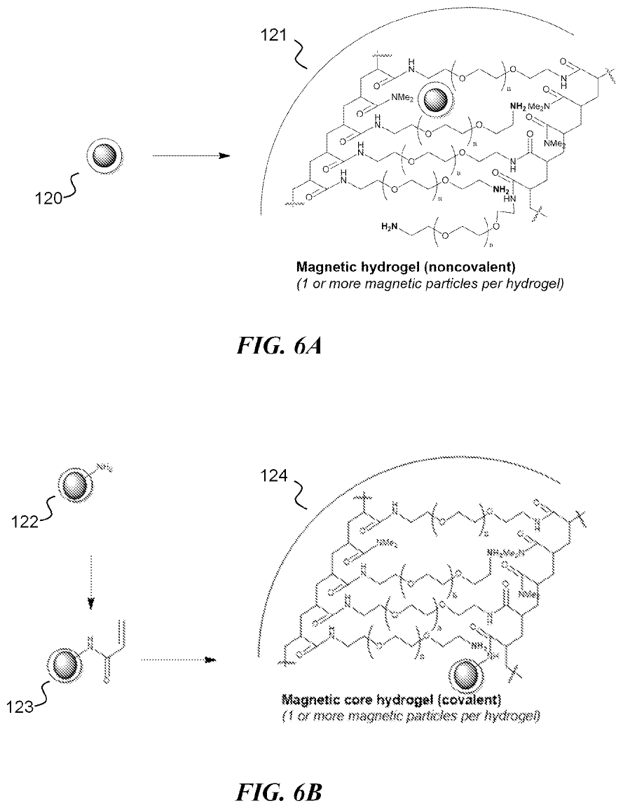

FIGS. 6A and 6B illustrate embodiments in which a hydrogel bead described herein can contain magnetic microparticles, such as magnetic core beads. In some embodiments, magnetic beads can be suspended in a hydrogel generation mixture and droplets can be generated as described herein. FIG. 6A depicts an embodiment in which a coated magnetic bead 120 is physically encapsulated in a hydrogel bead 121. The coated magnetic bead can be suspended in a hydrogel generation mixture, and droplets can be generated in which the coated magnetic bead is encapsulated in, but not covalently linked to, the hydrogel, to provide magnetic hydrogel bead 121. FIG. 6B depicts an embodiment in which a coated magnetic bead 122 containing amine group(s) is functionalized with acrylamide to form an acryl magnetic core bead 123. The acryl magnetic core bead 123 can be suspended in a hydrogel generation mixture, and droplets can be generated in which the coated magnetic bead is encapsulated in, and covalently linked to, the hydrogel to provide magnetic core hydrogel bead 124.

In some examples, the magnetic core beads can be coated, which can prevent side reactions. In some embodiments, the coating encapsulates the magnetic core beads. Hydrogel beads that contain magnetic core bead(s) can be manipulated, isolated and/or separated by magnetic forces, thus, for example, increasing the efficiency by which screening can be performed by enriching for bead encapsulated droplets. For example, in bead washing steps, such as in compound synthesis and encoding phase, beads can be separated by a magnetic force, thus replacing more cumbersome separation steps, such as filtration or centrifugation (Rana et al., 1999). In some embodiments, magnetic bead encapsulated droplets can be separated from non-encapsulated droplets, which can reduce the number of droplets sorted (Ofner et al., 2017). In some embodiments, magnetic core beads described herein can be fluorescent and their relative position in the three dimensional hydrogel grid can encode beads (Meldal & Christensen, 2010).

In some embodiments, polystyrene-coated magnetic beads, such as amino-modified, polystyrene-coated magnetic beads (e.g., DynaBeads (1 micron, amino-modified, Thermo Fisher)) functionalized with acrylamide can be suspended in a hydrogel generation mixture. Droplets can be generated as described herein. In some embodiments, the beads (e.g., polystyrene-coated magnetic beads) can possess some level of autofluorescence. In some further embodiments beads that possess some level of autofluorescence can act as an encoding tag.

In some embodiments, silica magnetic beads can be suspended in a hydrogel generation mixture. Droplets can be generated as described herein. In some embodiments, the silica magnetic beads can be amino modified. In some further embodiments, amino modified silica magnetic beads can be functionalized with acrylamide. In some embodiments, amino modified silica magnetic beads are 1 micron, amino modified beads (BOCA Scientific). Beads can be suspended in a hydrogel generation mixture. Droplets can be generated as described herein. Silica magnetic beads can have a low level of autofluorescence.

In yet another embodiment, carbon coated cobalt nanoparticles (e.g., TurboBeads) (Grass et al., 2007) (TurboBeads Llc, Zurich, Switzerland) can be embedded into hydrogels as in the description herein. TurboBeads can have notably high magnetism, which can provide advantage(s) in handling.

In yet another embodiment, iron oxide magnetic nanoparticles (e.g., TurboBeads) (Grass et al., 2007) (TurboBeads Llc, Zurich, Switzerland) can be embedded into hydrogels as described herein.

### Dissolvable Monodisperse Hydrogel Beads

In some embodiments, the cross-linker for the compound loading and/or hydrogel-shell beads can be selected for degradability upon certain triggers, such as but not limited to electromagnetic (e.g. light), enzyme, pH, temperature and/or redox sensitive linkers. Such degradable polymers are well known in the field of controlled drug delivery (Gillies, 2020). In some further embodiments, the PEG bis-acrylamide cross-linker of monodisperse PEGA resins exemplified herein can be replaced with photolabile cross likers described in the literature (Kloxin et al., 2009; Raman et al., 2020) to produce monodisperse photolabile PEGA resin for encoded bead library synthesis and screen systems described herein.

In some embodiments of the compositions, methods, uses, sorters, systems, and devices provided herein, loading capacity of a resin can be determined by loading a known fluorophore (e.g., fluorescein) to the resin through a cleavable linker, such as a photocleavable linker. Beads can be individually encapsulated in single droplets of a known volume. The fluorophore can be released from the beads within the droplets. The fluorescence intensity of the droplet can be determined by calibrating against reference droplets with known fluorescein concentrations.

### Encoded One-Bead One-Compound Library

In some embodiments, a compound library can be assembled on encoded beads. In some embodiments, a compound library can be assembled combinatorically on encoded beads. Methods of assembling compound libraries are described in (MacConnell et al., 2015). In an encoded one-bead one-compound (eOBOC) library, each bead can have attomoles to femtomoles of the same compound loaded through a cleavable linker, preferably a photocleavable linker, and a unique tag, preferably a DNA tag, for the bead itself (bead specific barcode, BSB) and for the combinatorically generated compounds themselves (compound barcode). The cleavable linkers can alternatively be, but are not limited to, enzyme cleavable or pH sensitive or reduction sensitive (disulfide) linkers. The tags can alternatively be, but are not limited to, RFID, fluorescent dye and/or beads, or peptide mass tags, or a combination thereof.

FIG. 2C representationally depicts embodiments for compounds and barcodes attached to a bead. Compound loading bead (110) is linked to ligands (111) and barcodes (112). Compounds (111) are linked by photocleavable linker (170). Ligands and barcodes are optionally linked to a common functionalization handle on beads through split linker (FIG. 11A).

FIGS. 11A-11C representationally depicts embodiments for DNA-encoded bead library linker and DNA barcode design. FIG. 11A depicts an embodiment in which a split linker for compound loading through photocleavable linker and DNA encoding can contain: 1) azidolysine for loading DNA headpiece through strain-promoted click chemistry; and 2) ortho-nitrobenzyl linker for photocleavage at 365 nm wavelength. FIG. 11B depicts an embodiment in which DNA encoding can be achieved in a manner by which the DNA headpiece with forward primer can be clicked onto the compound beads, then the first and second barcode for the bead-specific barcode is ligated, followed by the standard split-pool combinatorial chemistry in microtiter well plates accompanied by the ligation for the building block encoding duplex oligonucleotide, a few more identifier sequences and finally closing with the reverse primer (see, e.g., Paegel et al (MacConnell et al., 2015, 2017).

The encoded bead library described herein can be optionally prepared at different compound loading and/or different compound combinations to enable dose-response screen against the entire library (qHTS). This method can add flexibility in addition to a photo dose-response method (see, e.g., Paegel et al. (Price et al., 2016)) and can be especially useful in cases where partial cleavage of the release linker can be difficult, such as enzyme or pH labile linkers.

FIG. 11C depicts embodiments in which linkers bearing the compound loading sites can be blocked at different doses and encoded for different dosing capacities. This dose encoding strategy can enable pooling of dose response beads for the preparation of the library as well as for the screening, thereby adding tremendous amount of structure activity resolution while maintaining the ease of pooled synthesis and screening.

### Assays

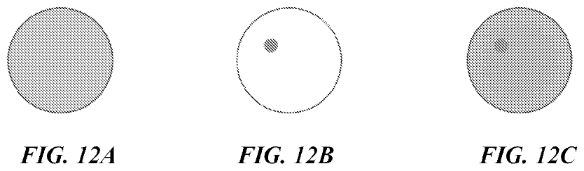

FIGS. 12A-C depict embodiments in which typical mix-and-read fluorescence reporter assays that result in either gain or loss of signal can be configured on the droplet-based screening platform using a variety of reporters. In some embodiments, the assays are biochemical or IVTT assay in a drop (FIG. 12A), fluorescent cell or bead in a drop (FIG. 12B), secreted fluorescent reporter from cell in a drop (FIG. 12C), or a combination thereof. Assays include but are not limited to biochemical assays, cell-free assays, cellular reporter assays, and cellular phenotypic assays with fluorescent and/or next generation sequencing readouts. The platform can support both compound screening and genetic screening assay methodologies. The signal can be either diffused across the droplet (for example either biochemical cell-free assays, and cell-based assay utilizing a secreted reporter system), contained within the cellular compartment detected through a secondary reporter bead (e.g. cytokine secretion assays).

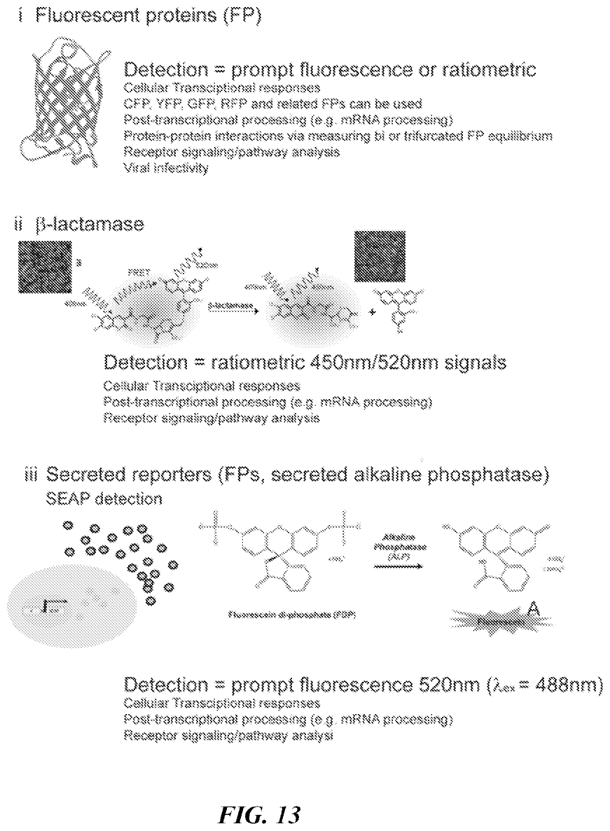

FIG. 13 depicts examples of reporters, such as fluorescent proteins (e.g., CFP, YFP, GFP, RFP, and related FP's (FIG. 13, Section i) or fluorescent reporter enzymes such as β-lactamase providing ratiometric detection via a FRET substrate or β-galactosidase providing far-red-shifted fluorescence, limiting interference by auto-fluorescent components, (FIG. 13, Section ii) that can be used to report on compounds that modulate expression through either transcriptional or post-transcriptional processes, or in the form of secreted reporters (FIG. 13, Section iii).

In some embodiments, compounds that degrade a protein of interest (POI) can be assayed on the platform by fusing the POI to GFP. In the assay, either suspension cells (e.g. K562, KG1, U937, or Jurkat cells, for example) or adherent cells (e.g. HEK293) can be engineered to express a GFP-POI-P2A-RFP reporter. This reporter expresses the GFP-POI fusion and unfused RFP reporter at nearly equal levels in cells as separate proteins using a ribosomal skipping sequence incorporated between the two genes (P2A). If the POI contains a degron such as a IKZF3-tag (Sievers et al., 2018), then addition of compounds such as lenalidomide can induce degradation of the GFP fusion with loss of signal.

In the case of secreted reporters, the reporter, such as GFP, can be constructed as secreted proteins or the reporter can be a secreted enzyme such as secreted alkaline phosphatase (SEAP). The use of a secreted reporter can have an advantage as the signal is diffused throughout the droplet rather than in a focal point (cell), rendering data processing and hence sorting can be more straightforward and robust.

In another example, viral infectivity in cells can be screened for examining either anti-virus agents or agents that increase the efficiency of virus-based therapies.

In some embodiments, the compositions, methods, uses, sorters, systems, and devices provided herein can be used to screen for agents that modulate protein-protein interactions, for example utilizing a trifurcated GFP system (Cabantous et al., 2013).

In some embodiments, the compositions, methods, uses, sorters, devices, and systems provided herein can be used to perform a fluorescent-based biochemical displacement assay such as a biochemical displacement assay that was configured using a probe to a POI that contains a quencher of GFP fluorescence. Similar type of assays can be configured using fluorescent polarization as the readout (Hackler et al., 2020).

In some embodiments, the compositions, methods, uses, sorters, devices, and systems provided herein can be used to perform UV photo-cleavage and image acquisition and/or the methods provided herein can include UV photo-cleavage and/or image acquisition. Example 20 describes UV photo-cleavage and image acquisition.

The flexibility of this platform with the IVTT system can allow assays to be performed that multiplex many compounds vs. many proteins and/or many targets. An example of such an assay is selective translation inhibition, in which sequences encoding for proteins, to be screened for translation inhibition, are added on a bead next to the barcoding sequence. In some embodiments, the assay includes selective stalling of human translation through small-molecule engagement of the ribosome nascent chain (see, e.g., Lintner et al. (2017) PLOS Biol. 15(3):e 2001882). Protein expression can be achieved via IVTT. When a positive result is achieved and protein translation is inhibited, the identity of the compound and of the protein can be determined via one shot next generation sequencing of the compound barcode and the gene encoding for the protein.

Additional assays that can be performed include standard reporter gene assays, protein-protein interaction (PPI) assays using split reporter systems or system such as TANGO probing GPCR function (ThermoFisher Scientific), or a combination thereof. Detection of secreted proteins, such as cytokines, from cells co-encapsulated with beads that capture the proteins for detection using fluorescently labeled antibodies can be achieved.

Any drop-based assays can be applied to the screening of encoded compound libraries or genetic screens (e.g., CRISPR), or a combination thereof. Table 2 provides an overview of assay types that can be performed with a drop-based screening platform.

TABLE 2
Examples of assays that can be performed
with drop-based screening

| Format | Assay Readouts | Biological mechanism |
|---|---|---|
| Cell- | Fluorescent protein reporters | Pathways & signaling |
| based* | Fluorescent enzyme reporters | PPI |
| | (e.g., β-lactamase, SEAP) | Post-translational |
| | FLINT | Transcriptional |
| | PCA | Second messenger |
| | RNAseq | RNA splicing and regulation |
| | Fluorescent biosensors | miRNA activity |
| | | Proliferation |
| Cell-free | Fluorescent protein reporters | PPI |
| | Fluorescent enzyme reporters | Target fishing |
| | FLINT | Enzyme evolution |
| | FRET | Translational Inhibition |
| | PCA | Targeted Protein Degradation |
| | Fluorescent biosensors | Antibody Profiling |
| Bio- | FLINT | PPI & protein-nucleic acid |
| chemical | FRET | Binding |
| | TR-FRET | Enzymatic products/ |
| | FP | modifications |

*Cells include cell lines, primary cells, induced pluripotent stem cell derived cells, in either homogenous or co-culture formats. PCA, protein complementation assay; FLINT, fluorescent intensity; FRET, Förster resonance energy transfer; TR-FRET, time resolved Förster resonance energy transfer; FP, fluorescent polarization. PPI, protein-protein interactions.

### Droplet Sorting

### Fluorescence Activated Droplet Sorter (FADS)

Provided herein are methods, systems and devices for sorting droplets. FIG. 2G illustrates an exemplary embodiment of a sorter in which droplets 134 can flow in path (200) between two sets of electrodes (130 and 131) that can independently apply an electric field, that can sort droplets 203 to sorting channel 201 and droplets 204 to sorting channel 202. Droplets 134 can be detected and identified as hit droplets or non-hit droplets before passing between sets of electrodes (130 and 131).

The droplet sorter as described herein is based on the surprising finding that sorting with a dual electrode sorter, such as a dual electrode sorter described herein, can enhance speed and/or reliability of the sorting.

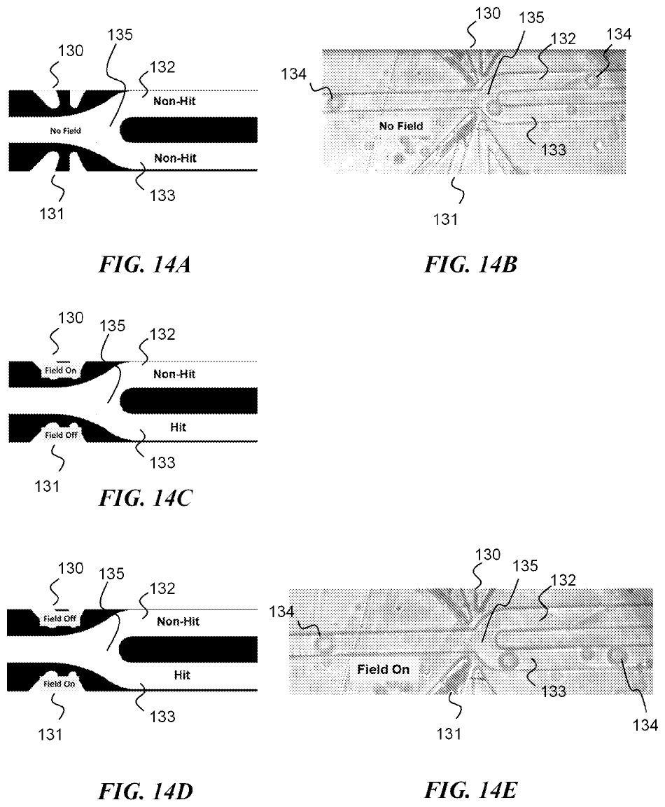

FIGS. 14A-14E illustrate an exemplary embodiment, in which two sets of electrodes 130 and 131 are present. In some embodiments, the sets of electrodes can be present just before the droplet pathway splits into two sorting channels 132 and 133. In some further embodiments, at least two sets of electrodes can be on different sides of a droplet stream. The sorting can be high frequency sorting. FIGS. 14A-14B illustrate an embodiment in which, without an applied force, such as from an electric field, droplets 134 can go to random channels 132 or 133. Without an applied forces acting on the droplets, the droplets can travel randomly to fluid paths with equal or about equal resistance (FIG. 14B). FIG. 14C illustrates embodiments, in which an electric field(s) for a non-hit stream is applied. In some embodiments, the electric field can be applied until a target droplet to be sorted arrives at junction 135 in which the droplet stream splits.

FIGS. 14D and 14E depict an embodiment in which addition of an applied force, such as from an electric field(s), for example, from electrode pair 131, can guide droplets 134 into a stream to flow through sorting channel 133 (FIGS. 14D and 14E). When a target droplet arrives, a field for the hit stream can be activated at electrode pair 131. In some embodiments, the field for the non-hit stream can be deactivated at electrode pair 130. As shown in FIG. 14E, activation of the field for the hit stream upon arrival of the target droplet can divert the target droplet 134 to that stream 133. This system can be performed with droplets described herein, droplet generation oils and emulsifiers described herein, and combinations thereof. Droplet flow can be controlled, for example, by pressure pumps, syringe pumps, or any combination thereof.

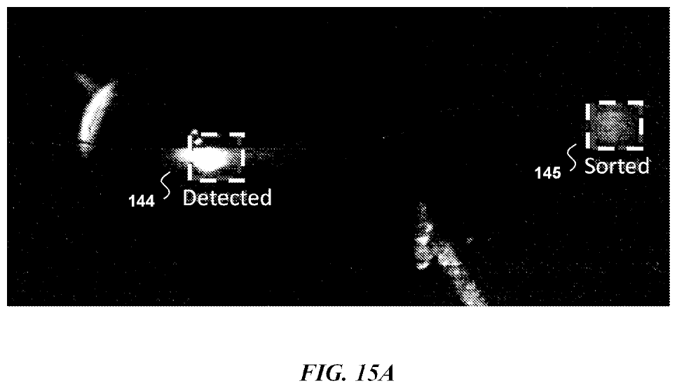

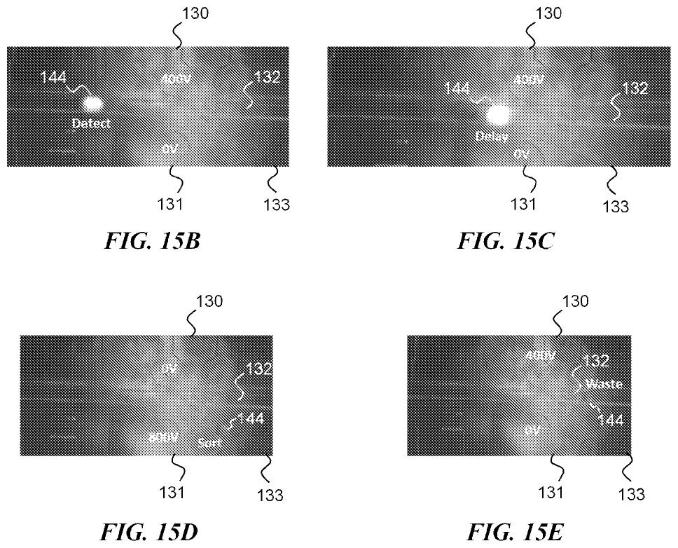

FIGS. 15A-15E show examples in which fluorescent droplets are detected and sorted. As shown in FIG. 15A, a droplet 144 was detected, for example by fluorescence detection, and sorted 145, for example, by application of an electric field. FIGS. 15B-15E show an example in which a droplet 144 was detected and sorted. As shown in FIG. 15B, droplet 144 was detected in a sorter that flows to a non-hit path 132 and a “hit” path 133. Electrode pair 130 applied an electric field (for example, resulting from 400 V). Electrode pair 131 applied no electric field. As shown in FIG. 15C, after detection, a delay occurred before sorting. A delay (e.g., milliseconds) can be introduced to match the time required for the detected droplet to arrive at a sorting junction. Sorting after a delay can minimize false positives, for example embodiments in which bystander droplets are directed to a hit path. In some embodiments, an evaluation algorithm can make a decision whether to apply an electric field within this timeframe. As shown in FIG. 15D, droplet 144 was identified as a hit, and an electric field (for example, resulting from 800 V) was applied to electrode pair 131, and electrode pair (130) had no electric field, sorting sort droplet 144 into channel 133. As shown in FIG. 15E, droplet 144 was not identified as a hit, and, the droplet was sorted into non-hit stream 132.

In the methods, systems, and devices provided herein for sorting droplets, droplets can be sorted by application of an electric field, a magnetic field, by changing flow, or any combination thereof. In some embodiments, two or more electromagnets can be located in positions described herein for electrodes. In some embodiments, droplets are sorted by changing applied electric field. A dual sorting system has been developed in which voltage can divert droplets. Non-hit droplets flow in a straight path with a lower voltage keeping them from diverting into the side path. For sorting the side path, voltage turns on while the non-hit path voltage switches off.

Hydrogel Bead Sorting with FACS

In some embodiments, assay droplets containing compound beads and the bioassay generated with the preferred emulsion formulations described herein can be turned into a hydrogel bead by introducing biocompatible polymers and/or their precursors, such as but not limited to agarose, alginate, collagen, polyacrylamide, PEG and the corresponding initiators, or any combination thereof, as needed. The assay hydrogels thus formed can be isolated in aqueous buffer while keeping the compound beads and cells on bead for off-droplet sorting using traditional flow cytometers (Duarte et al., 2017; Yanakieva et al., 2020).

In some embodiments, the core-shell bead containing a member of the encoded library can have a cavity to accommodate cells, turned into water-in-oil droplets with the preferred emulsion formulations described herein, compound released and incubated within the discrete droplet compartment, bead and cell bearing hydrogel extracted in aqueous buffer for off-droplet sorting using traditional flow cytometers (Di Carlo et al., 2019; Joseph de Rutte, Robert Dimatteo, Mark van Zee, Robert Damoiseaux, 2020).

Double Emulsion Sorting with FACS

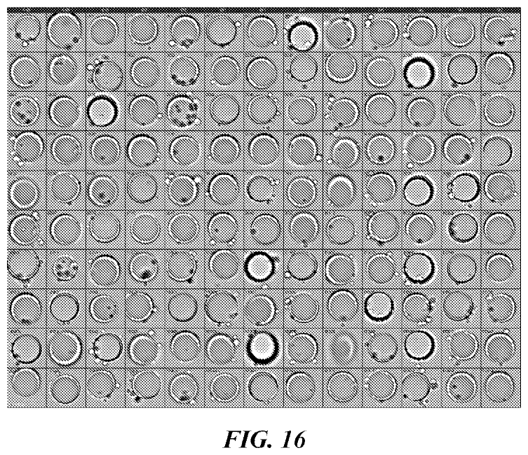

In some embodiments, water-in-oil-in-water (w/o/w) double emulsion droplets can be sorted. In some embodiments, sorting can be performed to screen droplets. For example, fluorescence can be used to sort droplets. Droplets, such as double emulsion droplets, can be sorted by FACS. This method of sorting can be performed with droplets described herein, droplet generation oils and emulsifiers described herein, and combinations thereof. Commercial FACS machines can be used to sort double emulsion droplets at 10-12 kHz frequencies (Brower et al., 2019). FIG. 16 shows water-in-oil-in-water (w/o/w) double emulsion droplets in an imaging flow cytometer (Amnis ImageStream X MkII, Luminex Corporation). In some embodiments, the imaged double emulsion droplets are monodisperse double emulsion droplets.

### Sorting of Arrayed Droplets

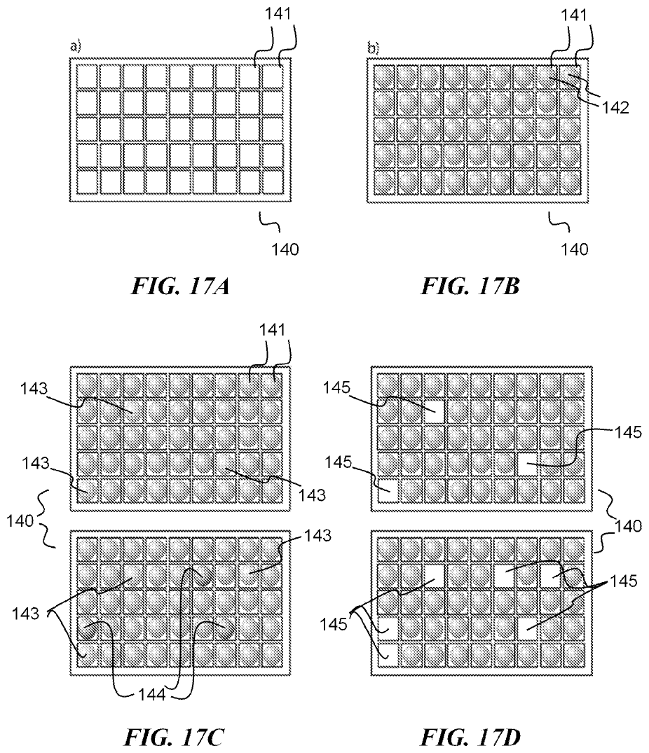

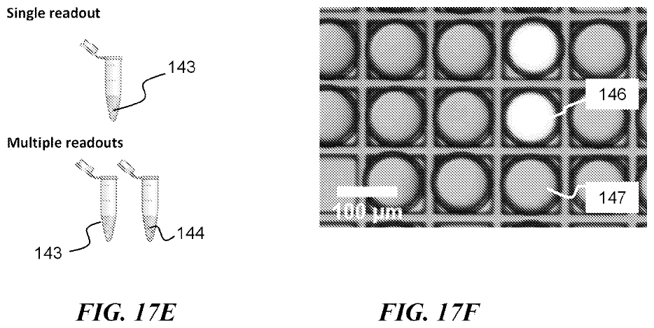

FIGS. 17A-17F depict embodiments in which emulsion droplets can be detected and/or sorted in an automated manner. FIG. 17A depicts a grid 140 of partitions (e.g., a microwell plate containing wells 141), in which each partition (e.g., well) 141 is equal to, or about equal to, the size range of emulsion drops. FIG. 17B depicts a grid 140 in which emulsion drops 142 are arrayed in wells 141 in the grid. In some embodiments, one drop is arrayed in each partition or well 141. By arraying emulsion drops, the drops can be spatially trapped. Compared to the flow-based of FADS, this spatial control can result in a much broader range of readout possibilities such as bright field, fluorescent or luminescent readout, or any combination thereof, over a given time frame. In addition to standard live and dead cell stains readouts and fluorescent biosensors, the spatial control enables high-resolution imaging for phenotypic readouts such as cell or organelle morphology, localization of protein of interest, etc. FIG. 17C depicts grids 140 containing drops 141. After one or more parameters are applied (e.g., compound release from encoded beads through triggers such as electromagnetic irradiation, (such as light, UV, UVA such as, for example about 365 nm), or enzymatic cleavage, incubation for expression of peptides/proteins using in-vitro transcription translation, or simple incubation for a reporter, pH change, reducing agents, or a combination thereof), the assay can be analyzed and hit droplets 143 and 144 can be identified. As illustrated in FIG. 17D, after defining single or multiple desired groups, hit droplets can be removed (e.g., mechanically removed) from wells 145 of the micro well plate 140. FIG. 17E depicts analysis of the single and multiple hit group droplets 143 and 144, respectively. In some embodiments, removal of droplets can be automated. Droplets can be removed, for example, by a micromanipulator (e.g., an automated robotic micromanipulator), by irradiation, or by a combination thereof. FIG. 2H representationally depicts embodiments in which hit droplets 143 are identified in a microwell plate 140.

In some embodiments, an automated robotic micromanipulator can remove defined emulsion droplets. Removed droplet(s) can be deposited in a defined position. In some embodiments, droplets can be removed by irradiation (e.g., electromagnetic irradiation), which can result in a burst of droplets releasing their content(s) to the surrounding phase, which can be analyzed for its content. In some further embodiments, the irradiation is with a laser.

In some embodiments described herein, droplets (e.g., arrayed droplets) for use in the sorting methods, devices, and systems described herein can be denser than the continuous phase in which droplets are suspended. In some embodiments, droplets can be denser than an oil phase in which the droplets are suspended. If droplets are denser than the liquid in microplates, then droplets can sediment to the bottom of wells, which can facilitate imaging and/or analysis. In some embodiments, droplets can be denser than the oil phase by using water in fluorinated oil in water double emulsion drops, or using water in oil drops in which the oil phase is less dense than water. In an exemplary workflow, arrayed emulsion droplets can be arrayed, automatically imaged, based on criteria the hits defined, and hit droplets automatically removed from the array for further analysis. FIG. 17F shows a microscope image of an array in which double emulsion drops with a fluorescent dye 146 and without a fluorescent dye 147 are arrayed in a microwell plate.

In some embodiments, barcodes associated with encoded beads can be identified. Identification of barcodes can include, for example, fluorescence microscopy/counter, RFID reader, mass spectrometry, DNA sequencing, or any combination thereof. In some embodiments, next generation sequencing and data science can be used to deconvolute hits. In some embodiments, sequence DNA barcodes from encoded beads can be sequenced. For example, in some embodiments, PCR can be directly performed on DNA linked to a bead.

In the screening context with droplets sorting with NGS readout, the enrichment of representation of unique bead specific barcodes (BSBs) per compound specific barcode (CSB) can be compared between the assay hits sorted into the ‘hit sort’ (compound active on the in-droplet assay) and the ‘non-hit sort’ and appropriate statistical models can be applied to evaluate the significance of enrichment. Dataset randomization can be used to estimate the enrichment background above which to call hits.

The droplet sorting methods, systems, uses, devices described herein (e.g., FADS, double emulsion sorting with FACS, sorting of arrayed droplets), can include a black-hole quencher assay, a secreted reporter assay, or a combination thereof. In some embodiments, droplet based screening/sorting can include use of an automated cell picker. In some embodiments, the automated cell picker can include a microwell array plate (for hosting one microdroplet per microwell), a fluorescence microscope, an imaging setup that automatically images the assay droplets and identifies the desired droplets, a microcapillary-based droplet sampling device that automatically picks and deposits the desired droplets to the hit wells, or any combination thereof. In some embodiments, a continuous phase formulation includes: a) one or more oils selected from the group consisting of perfluorocarbons and perfluorinated oils; and/or b) one or more hydrofluoroethers.

In some embodiments, the total concentration of the perfluorocarbon(s) and/or perfluorinated oil(s) in the fluorous dispersion oil is about 50% w/w or more; and/or the concentration of the one or more hydrofluoroethers in the fluorous dispersion oil is about 50% w/w or less.

In some embodiments: a) the perfluorocarbon is a perfluoroalkane selected from the group consisting of perfluorooctane, perfluoroheptane, perfluorohexane (FC-72), perfluoro-1,3-dimethyl-cyclohexane, octadecafluorodecahydronaphthalene (perfluorodecalin); and/or b) the perfluorinated oil is selected from the group consisting of perfluoro 2-butyltetrahydrofuran, perfluoro-N-methylmorpholine (FC-3284), perfluorotripentylamine (FC-70), perfluorotributylamine (FC-43), perfluorotripropylamine (FC-3283), a perfluorotributylamine and perfluoro(dibutylmethylamine) mixture (FC-40) and/or c) the hydrofluoroether is selected from the group consisting of 2-(trifluoromethyl)-3-ethoxydodecafluorohexane (HFE-7500), ethyl perfluorobutyl ether (HFE-7200), 3-methoxyperfluoro(2-methylpentane) (HFE7300), a methyl perfluoroisobutyl ether/methyl perfluorobutyl ether mixture, a mixture of methoxynonafluorobutane and methoxynonafluoroisobutane (HFE7100), methoxy-nonafluorobutane, methoxyheptafluoropropane (HFE7000), HFE712, HFE649, EIFE7100DL, HFE 71DE, HFE 71IPA, HFE7200DL, HFE72DA, HFA72DE, HFE72FL, HFE73DE, HFE7700, and HFE8200.

In some embodiments the perfluorocarbon is a perfluoroalkane selected from the group consisting of perfluorooctane, perfluoroheptane, perfluorohexane (FC-72), perfluoro-1,3-dimethyl-cyclohexane, octadecafluorodecahydronaphthalene (perfluorodecalin); and/or the perfluorinated oil is selected from the group consisting of perfluoro 2-butyltetrahydrofuran, perfluoro-N-methylmorpholine (FC-3284), perfluorotripentylamine (FC-70), perfluorotributylamine (FC-43), perfluorotripropylamine (FC-3283), perfluorotributylamine and perfluoro(dibutylmethylamine) mixture (FC-40); and/or the hydrofluoroether is selected from the group consisting of 2-(trifluoromethyl)-3-ethoxydodecafluorohexane (HFE-7500), ethyl perfluorobutyl ether (HFE-7200), 3-methoxyperfluoro(2-methylpentane) (HFE7300), methyl perfluoroisobutyl ether/methyl perfluorobutyl ether mixture (HFE7100), and methoxy-nonafluorobutane (HFE7000).

In some embodiments the perfluorocarbon is a perfluoroalkane selected from the group consisting of perfluorooctane, perfluoroheptane, perfluorohexane (FC-72), perfluoro-1,3-dimethyl-cyclohexane, octadecafluorodecahydronaphthalene (perfluorodecalin); and the perfluorinated oil is selected from the group consisting of perfluoro 2-butyltetrahydrofuran, perfluoro-N-methylmorpholine (FC-3284), perfluorotripentylamine (FC-70), perfluorotributylamine (FC-43), perfluorotripropylamine (FC-3283), perfluorotributylamine and perfluoro(dibutylmethylamine) mixture (FC-40); and the hydrofluoroether is selected from the group consisting of 2-(trifluoromethyl)-3-ethoxydodecafluorohexane (HFE-7500), ethyl perfluorobutyl ether (HFE-7200), 3-methoxyperfluoro(2-methylpentane) (HFE7300), methyl perfluoroisobutyl ether/methyl perfluorobutyl ether mixture (HFE7100), and methoxy-nonafluorobutane (HFE7000).

In some embodiments the perfluorocarbon is a perfluoroalkane selected from the group consisting of perfluorooctane, perfluoroheptane, perfluorohexane (FC-72), perfluoro-1,3-dimethyl-cyclohexane, octadecafluorodecahydronaphthalene (perfluorodecalin).

In some embodiments the perfluorinated oil is selected from the group consisting of perfluoro 2-butyltetrahydrofuran, perfluoro-N-methylmorpholine (FC-3284), perfluorotripentylamine (FC-70), perfluorotributylamine (FC-43), perfluorotripropylamine (FC-3283), perfluorotributylamine and perfluoro(dibutylmethylamine) mixture (FC-40).

In some embodiments the hydrofluoroether is selected from the group consisting of 2-(trifluoromethyl)-3-ethoxydodecafluorohexane (HFE-7500), ethyl perfluorobutyl ether (HFE-7200), 3-methoxyperfluoro(2-methylpentane) (HFE7300), methyl perfluoroisobutyl ether/methyl perfluorobutyl ether mixture (HFE7100), and methoxy-nonafluorobutane (HFE7000).

In some embodiments, the fluorous dispersion oil consists of perfluorohexane (FC-72), perfluorooctane, and 2-(trifluoromethyl)-3-ethoxydodecafluorohexane (HFE-7500), each present in an amount ranging from 10-90% w/w.

In some embodiments, the fluorous dispersion oil is selected from the group consisting of: perfluorohexane(FC-72):perfluorooctane: 2-(trifluoromethyl)-3-ethoxydodecafluorohexane (HFE-7500) in a 1:1:1 w/w ratio or about a 1:1:1 w/w ratio, respectively; perfluorohexane(FC-72):perfluorooctane: 2-(trifluoromethyl)-3-ethoxydodecafluorohexane (HFE-7500) in a 2:2:1 w/w ratio or about a 2:2:1 w/w ratio, respectively; and perfluorohexane(FC-72):perfluorooctane: 2-(trifluoromethyl)-3-ethoxydodecafluorohexane (HFE-7500) in a 1:3:1 w/w ratio or about a 1:3:1 w/w ratio, respectively.

In some embodiments, the triblock and/or diblock copolymer is fluorinated. In some embodiments, the triblock or diblock copolymer comprises: a perfluoropolyether (PFPE) and a polyethylene glycol (PEG) (e.g., a perfluoropolyether (PFPE), a polypropylene glycol (PPG) and a polyethylene glycol (PEG); two perfluoropolyethers (PFPEs) and a polyethylene glycol (PEG); or two perfluoropolyethers (PFPEs), two polypropylene glycols (PPG) and a polyethylene glycol (PEG).

In some embodiments, a diblock copolymer has the formula 1

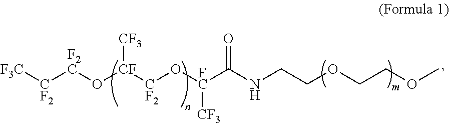

wherein n and m are exact values or average values of polydisperse building blocks, the average molecular weight of the diblock copolymer is between 1,000-10,000 Da, n is from 35-45, and m is from 2-24. In some embodiments, the triblock copolymer has a formula selected from a group consisting of

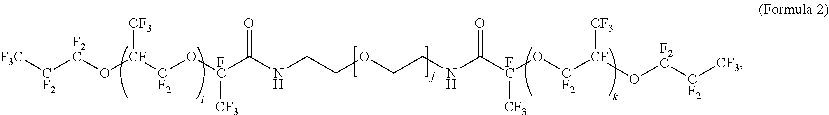

wherein i, j and k are exact values or average values of polydisperse building blocks, the average molecular weight of the triblock copolymer is between 2,000-20,000 Da, i and k are independently from 35-45, and j is 1-23, and

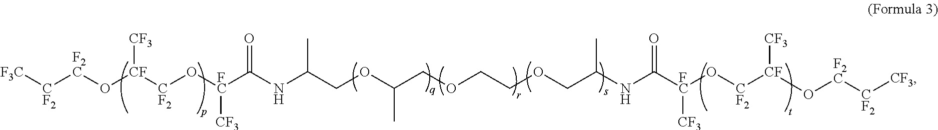

wherein p, q, r, s and t are exact values or average values of polydisperse building blocks, the average molecular weight of the triblock copolymer is between 2,000-20,000 Da, p and t are independently 35-45, q and s are each greater than zero, the exact or average of the sum q+s is 3-6, and r is 1-23.

In some embodiments, the emulsifier comprises a diblock copolymer and a triblock copolymer at a ratio of about 1:1 to 1:9 (w/w), respectively. In such embodiments, the diblock copolymer and triblock copolymer are present in the continuous phase formulation at a combined concentration of about 0.3-4 wt % (e.g., about 2% w/w).

In some embodiments, the droplet stabilizer comprises a fluorinated (e.g., partially fluorinated, comprising a fluorinated alkyl side chain) silica nanoparticle.

In some embodiments, fluorinated silica nanoparticle can include those as described in US 2016/0114325 A1.

In some embodiments, the fluorinated silica nanoparticle comprises one or more substituents selected from the group consisting of substituents of the formulas:

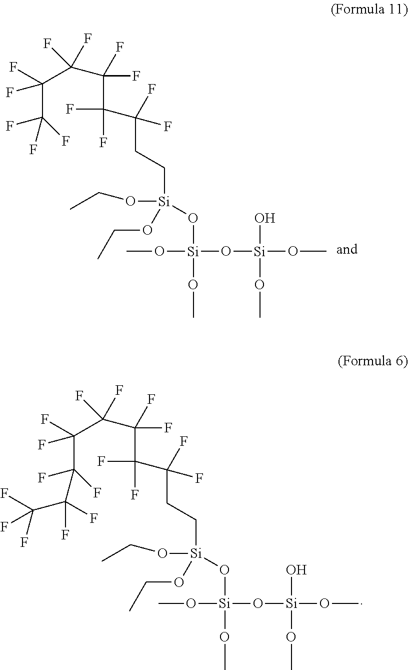 [SMILES: CCO[Si](CCC(F)(F)C(F)(F)C(F)(F)C(F)(F)C(F)(F)C(F)(F)F)(OCC)O[Si](OC)(OC)O[Si](O)(OC)OC ; CCO[Si](CCC(F)(F)C(F)(F)C(F)(F)C(F)(F)C(F)(F)C(F)(F)C(F)(F)C(F)(F)F)(OCC)O[Si](OC)(OC)O[Si](O)(OC)OC]

In some embodiments, the fluorinated silica nanoparticle is present in the continuous phase formulation at a concentration of about 2-8% w/w.

In some embodiments, the fluorinated silica nanoparticle is a Pickering emulsifier.

In some embodiments, the Pickering emulsifier is 8% wt fluorinated silica nanoparticle (100 nm) of Formula 6,

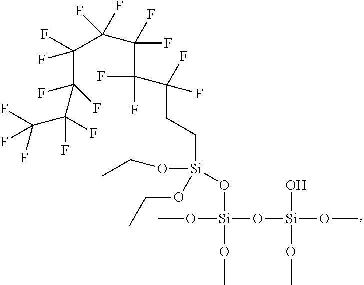 [SMILES: CCO[Si](CCC(F)(F)C(F)(F)C(F)(F)C(F)(F)C(F)(F)C(F)(F)C(F)(F)C(F)(F)F)(OCC)O[Si](OC)(OC)O[Si](O)(OC)OC]

dispersed in perfluoro 2-butyltetrahydrofuran: 2-(trifluoromethyl)-3-ethoxydodecafluorohexane (HFE-7500) in a 1:1 (w/w) ratio.

In some embodiments, the methods of preparing a monodisperse PEGA co-polymer resin further include coating the PEGA co-polymer resin with a hydrophilic material (e.g., a hydrophilic polymer or a hydrogel, such as polyethylene glycol (PEG), polypropylene glycol (PPG), hyaluronic acid, polylactic acid, polyacrylamide, alginate, agarose, or collagen).

In some embodiments, the methods of preparing a monodisperse PEGA co-polymer resin further include linking a ligand and/or a barcode (e.g., nucleic acid, DNA) to the PEGA co-polymer resin (e.g., attachment to the functionalization handle) either reversibly (e.g. photo-cleavable linker) or irreversibly). In some embodiments, the methods of preparing a monodisperse PEGA co-polymer resin further include linking a ligand and a barcode (e.g., nucleic acid, DNA) to the PEGA co-polymer resin (e.g., attachment to the functionalization handle) either reversibly (e.g. photo-cleavable linker) or irreversibly). In some embodiments, the methods of preparing a monodisperse PEGA co-polymer resin further include linking a ligand or a barcode (e.g., nucleic acid, DNA) to the PEGA co-polymer resin (e.g., attachment to the functionalization handle) either reversibly (e.g. photo-cleavable linker) or irreversibly).

In some embodiments, the methods of preparing a monodisperse PEGA co-polymer resin further include reversibly linking a ligand and irreversibly linking a barcode (e.g., nucleic acid, DNA) to the PEGA co-polymer resin (e.g., attachment to the functionalization handle). In some embodiments, the methods of preparing a monodisperse PEGA co-polymer resin further include irreversibly linking a ligand and irreversibly linking a barcode (e.g., nucleic acid, DNA) to the PEGA co-polymer resin (e.g., attachment to the functionalization handle). In some embodiments, the methods of preparing a monodisperse PEGA co-polymer resin further include irreversibly linking a ligand and reversibly linking a barcode (e.g., nucleic acid, DNA) to the PEGA co-polymer resin (e.g., attachment to the functionalization handle). In some embodiments, the methods of preparing a monodisperse PEGA co-polymer resin further include reversibly linking a ligand and reversibly linking a barcode (e.g., nucleic acid, DNA) to the PEGA co-polymer resin (e.g., attachment to the functionalization handle).

In some embodiments, the ligand is reversibly linked to the PEGA co-polymer resin, the barcode is irreversibly linked to the PEGA co-polymer resin, and the barcode is DNA.

In some embodiments, the method of preparing a monodisperse PEGA co-polymer resin further includes embedding magnetic particles in the PEGA co-polymer resin by covalent linkage or by physical encapsulation. In such embodiments, the magnetic particles can have a size of 1 nanometer to 10 micron in diameter.

In some embodiments, the monodisperse PEGA co-polymer resin has a diameter between 1-100 micron, or the at least one microdroplet is a plurality of monodisperse microdroplets and the size distribution (e.g., within 10%, 9%, 8%, 7%, 6%, 5%, 4%, 3%, 2% or 1%) of the PEGA co-polymer resins is within 5%.

In some embodiments of the methods of preparing a monodisperse PEGA co-polymer resin: the bis-acrylamide PEG has an exact or average molecular weight of 250-5,000 Daltons (e.g., 800-2,000); and/or the mono-acrylamide PEG has an exact or average molecular weight of 150-5,000 Daltons. In some embodiments of the methods of preparing a monodisperse PEGA co-polymer resin: the bis-acrylamide PEG has an exact or average molecular weight of 250-5,000 Daltons (e.g., 800-2,000), and the mono-acrylamide PEG has an exact or average molecular weight of 150-5,000 Daltons.

In some embodiments of the methods of preparing a monodisperse PEGA co-polymer resin, the bis-acrylamide PEG has a structure of the following Formula 7:

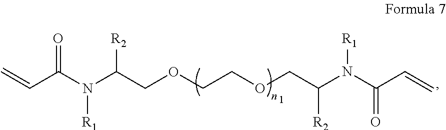

wherein in Formula 7, R₁ is H or —CH₃ and R₂ is H or —CH₃, and the exact or average n₁ is 1-108. In such embodiments, the mono-acrylamide PEG has a structure of the following Formula 8:

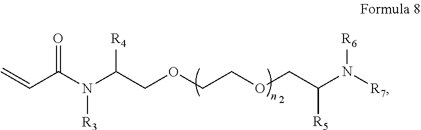

or the mono-acrylamide diamine has a structure of Formula 9:

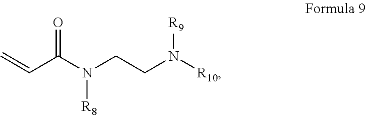

wherein:
in Formula 8, R₃-R₆ are independently H or —CH₃, R₇ is hydrogen, Boc or Fmoc, and the exact or average n₂ is 1-109; and
in Formula 9, R₈ and R₉ are independently H or —CH₃, and R₁₀ is selected from the group consisting of H, Boc and Fmoc.

In some embodiments of the methods of preparing a monodisperse PEGA co-polymer resin, the plurality of monomers dispersed in the aqueous buffer comprise N,N-dimethylacrylamide, Bis-PEG-acrylamide (2000 Daltons), and Boc-amino-PEG-acrylamide.

In some embodiments of the methods of preparing a monodisperse PEGA co-polymer resin, the functionalization handle is selected from the group consisting of a protected amine (e.g., a Boc protected amine, or an Fmoc protected amine), an unprotected amine (e.g., a free amine), an alcohol, an acid, an ester, an azide, an acetylene, and a tetrazine.

In some embodiments of the methods of preparing a core-shell bead, the core bead is linked to a monomer corresponding to a monomer of the plurality of monomers. In such embodiments, polymerizing the monomers comprises covalently linking the core bead to the hydrogel encapsulating the bead.

In other embodiments, the thin-shell (e.g. PEG coated) core-shell bead is prepared by grafting hydrophilic polymer coating on the solid support. In some embodiments, the solid support is a polystyrene matrix, e.g. a low cross linked polystyrene matrix, on which polyethylene glycol is grafted. In some examples, the hydrophilic polymer coating comprises PEG. In some examples, PEG is attached by acetylene-azide click chemistry.

It is known that the swelling capacity (degree of swelling) of the resulting networks is influenced by the amount of cross-links (cross-linking density). The ability of the resin to swell in both organic and aqueous media is especially important when the chemistry is performed in organic solvents while DNA ligation is performed in aqueous buffer. For light cross linking, sufficient amount of the crosslinking monomer will be used to give dimensional stability to the polymer bead so that it will swell rather than dissolve in aqueous and/or organic media. Lower cross linking levels usually provide higher surface area and adsorption capacity in the final products but optimum performance will depend also upon the type of monomers and other conditions such as the degree of swelling, as well as upon other process conditions. Thus, the low (or lightly) cross linked polystyrene matrix of the present disclosure with PEG grafting is chosen such that the swelling capacity of the polymer is sufficient in both aqueous and organic media.

In some embodiments, forming a core-shell bead includes forming a mixture of core-shell beads and empty beads. In such embodiments, the method further includes enriching (e.g., by flow cytometry) the mixture of core-shell beads and empty beads for core-shell beads encapsulated at one core-bead per one core-shell bead.

In some embodiments, forming a core-shell bead includes forming a plurality of core-shell beads that are sufficiently stable and compressible to allow packing of the core-shell beads in microfluidic channels such that the core-shell beads are encapsulated in microdroplets with super-Poisson encapsulation efficiency.

In some embodiments of the methods of preparing a core-shell bead, the hydrogel is selected from the group consisting of PEGA, poly-acrylamide, alginate, agarose, and collagen.

In some embodiments of the methods of preparing a core-shell bead, the at least one core bead includes a ligand and/or a barcode; or the method further includes linking a ligand and/or a barcode to the at least one core bead of the core-shell bead. In some embodiments of the methods of preparing a core-shell bead, the at least one core bead comprises a ligand and/or a barcode; or the method further comprises linking a ligand and/or a barcode to the at least one core bead of the core-shell bead. In some embodiments of the methods of preparing a core-shell bead, the at least one core bead comprises a ligand and a barcode; or the method further comprises linking a ligand and a barcode to the at least one core bead of the core-shell bead. In some embodiments of the methods of preparing a core-shell bead, the at least one core bead comprises a ligand or a barcode; or the method further comprises linking a ligand or a barcode to the at least one core bead of the core-shell bead.

In some embodiments of the methods of preparing a core-shell bead, the method further includes linking a ligand and/or a barcode to the hydrogel encapsulating the core bead.

In some embodiments of the methods of preparing a core-shell bead, the method further comprises linking a ligand and/or a barcode to the hydrogel encapsulating the core bead.

In some embodiments of the methods of preparing a core-shell bead, the method further comprises linking a ligand or a barcode to the hydrogel encapsulating the core bead.

In some embodiments of the methods of preparing a core-shell bead, the method further comprises linking a ligand and a barcode to the core bead. In some embodiments of the methods of preparing a core-shell bead, the method further comprises linking a ligand to the core bead and linking a barcode to hydrogel encapsulating the core bead. In some embodiments of the methods of preparing a core-shell bead, the method further comprises linking a ligand to the hydrogel encapsulating the core bead and linking a barcode to the core bead.

In some embodiments, the at least one core bead is selected from the group consisting of a hydrogel bead, a magnetic hydrogel bead, a divinyl benzene cross-linked polystyrene bead, a low crosslinked polystyrene matrix on which polyethylene glycol is grafted, a magnetic bead, a silica bead, glass and a ceramic bead.

In some embodiments, the diameter of the core-shell bead is about 1-70 microns (e.g., about 10 microns, about 15 microns, about 20 microns, about 30 microns, about 33 microns, about 40 microns, about 50 microns, about 60 microns, about 70 microns, about 20-50 microns, about 5-40 microns, about 10-35 microns, or about 30-40 microns); or the diameter of the core-shell bead is 70% or less of the diameter of the droplet diameter.

In some embodiments, the core-shell bead comprises a core bead encapsulated by polyacrylamide. In such embodiments, the core bead is a low crosslinked polystyrene matrix on which polyethylene glycol is grafted.

In some embodiments of the methods of preparing a core-shell bead, the at least one microdroplet is a water in oil (w/o) single emulsion microdroplet.

In some embodiments, the sorter further includes a sensor configured to detect a target composition having a selected characteristic flowing through the inlet channel upstream of the junction. In such embodiments, the controller is configured to switch the state of the first and second electrodes from the first state to the second state in response to the sensor detecting the target composition.

In some embodiments, the sensor is a fluorescent intensity sensor comprising at least one photomultiplier tube.

In some embodiments, the selected characteristic is selected from the group consisting of emission of a threshold amount of fluorescence intensity, threshold range of fluorescence intensity, emission of a particular combination of fluorescent signals and their threshold intensities and emission of a particular combination of fluorescent signal intensities within a threshold ratiometric range.

In some embodiments, the controller is configured to return the first and second electrodes to the first state after the target compound has passed through the junction.

In some embodiments, the junction has a symmetric geometry and wherein the first and second electrodes have a third state, in which both the first and second electrodes receive no voltage, that causes a plurality of target compounds flowing through the junction to enter both the first and second outlet channels.

In some embodiments, a diameter of the inlet channel is between 1 and 200 microns.

In some embodiments, in the first state the second electrode receives no voltage and in the second state the first electrode receives no voltage.

In some embodiments, the inlet channel and the first outlet channel both have straight geometries and are aligned with each other. In such embodiments, the second outlet channel has a curved geometry.

In some embodiments, in the first state the first electrode receives a first amount of voltage. In such embodiments, in the second state the second electrode receives a second amount of voltage greater than the first amount of voltage.

In some embodiments, the first side of the junction is opposite the second side of the junction.

### EXAMPLES

### Example 1: Perfluorpolypropylene-Polyethylene Glycol (PFPE-PEG)

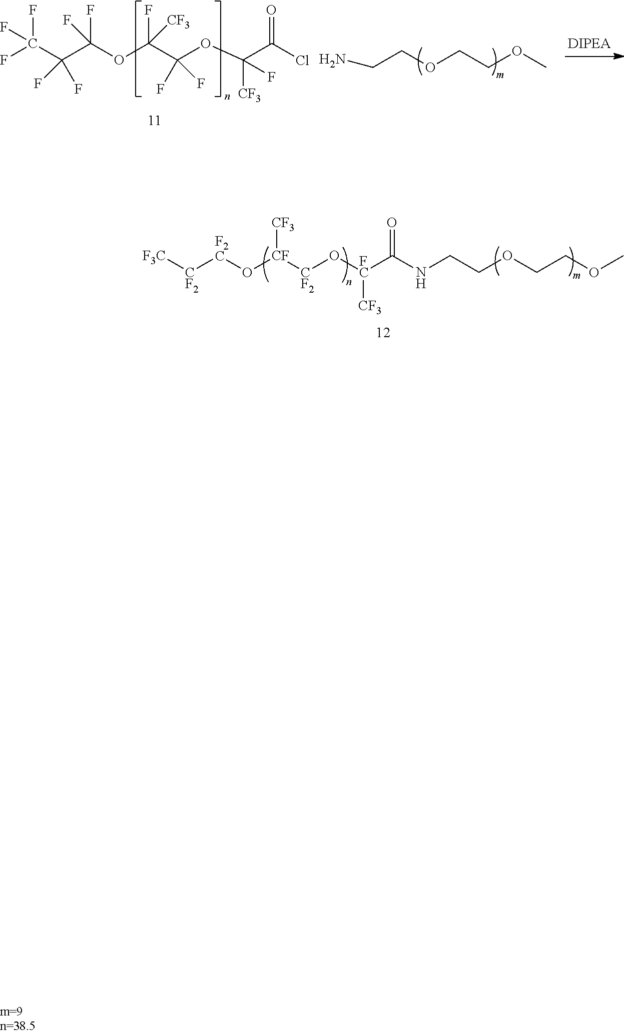

To an oven dried 100 mL two neck round bottom flask equipped with a stir bar and findensor was charged with Krytox 157-FSH (a carboxylic acid-terminated perfluoropolyether) (51.07 g, 7.60 mmol) in 50 mL of HFE-7100. Reaction mixture cooled to 0° C. under a N₂ line. Oxalyl chloride (9.98 mL, 114 mmol) added dropwise at 0° C. ice bath removed and heated to 70° C. for 5 hrs. Solvent was evaporated and placed under high vacuum for 18 hrs to give the acid chloride 11 (average molecular weight=about 6739) as an opaque oil, which was used in the next step.

To an oven dried 100 mL two neck round bottom flask equipped with a stir bar and findensor was charged with poly(ethyleneglycol) methyl ether 500 (1812 mg, 3.85 mmol) in 10 mL of THF and DIPEA (672 μl, 3.85 mmol) under N₂ atmosphere. 11 (7628 mg, 1.132 mmol) in 10 mL of HFE-7100 was added dropwise and heated to 60° C. for 3 hrs. The reaction mixture was cooled to room temperature and stirred overnight under N₂ atmosphere.

To remove unreacted amines, 6 mL of DCM followed by 6 mL of FC-72 was added to the reaction mixture and the content transferred to a separatory funnel. The separatory funnel was shaken and was left standing for a few hours until two clear layers were obtained. The top layer containing organics was discarded, and the bottom layer was evaporated to give an opaque oil.

To remove PEG amine salts, the latter oil was washed with 1 N HCl, DI water followed by MeOH. The resulting oil was dissolved in 7 mL of EIFE-7100 and 10 mL of THF followed by 4 mL of MeOH was added. The resulting mixture was heated to 75° C. for 10 minutes and the top organic layer removed. The bottom fluorous layer was evaporated to give the desired diblock copolymer 12 as an opaque oil (74% yield). FT-IR (cm−1): 2871 (CH), 1720 (CO). ¹⁹F NMR (376 MHz, Benzene-d₆) δ−76.32-−84.77 (m), −131.29 (s), −133.19-—133.79 (m), —145.16-—146.81 (m).

### Example 2: Perfluorpolypropylene-Polyethylene Glycol-Perfluorpolypropylene (PFPE-PEG-PFPE)

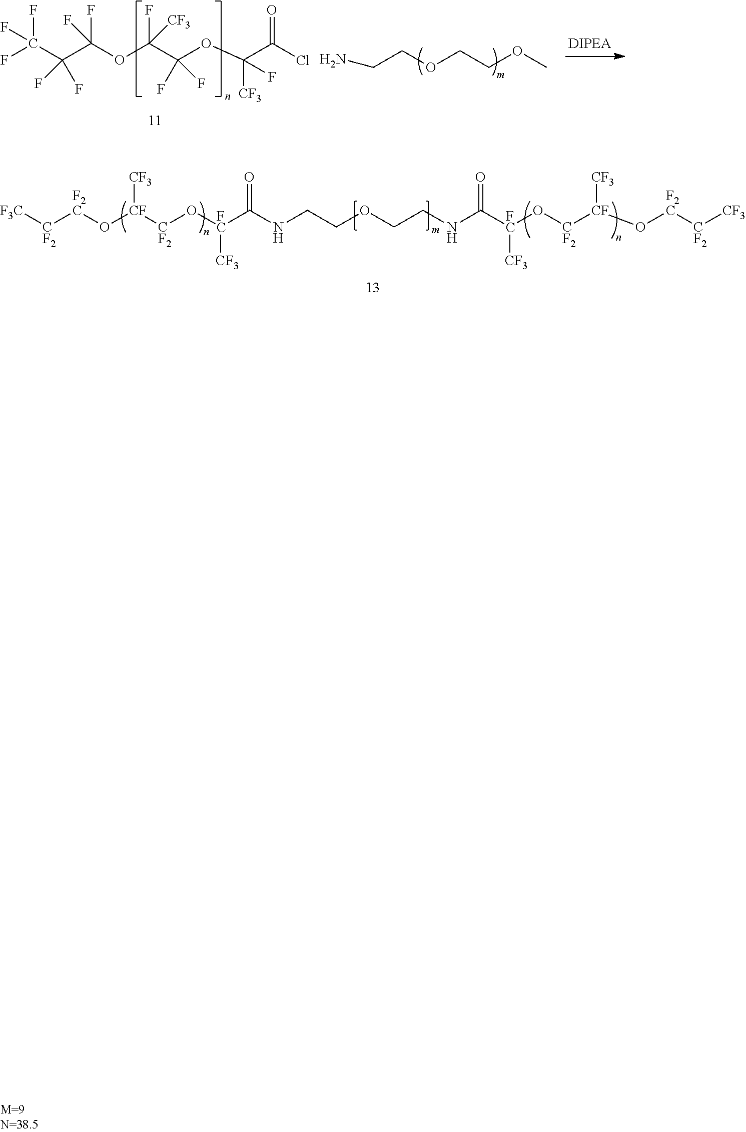

To an oven dried 100 mL two neck round bottom flask equipped with a stir bar and findensor was charged with Krytox 157-FSH (a carboxylic acid-terminated perfluoropolyether) (51.07 g, 7.60 mmol) in 50 mL of HFE-7100. Reaction mixture was cooled to 0° C. under a N₂ line. Oxalyl chloride (9.98 mL, 114 mmol) was added dropwise at 0° C. The ice bath was removed and the reaction heated to 70° C. for 5 h. The solvent was evaporated and the reaction was placed under high vacuum for 18 hrs to give 11 (average molecular weight=about 6739) as an opaque oil, which was used in the next step.

To an oven dried 100 mL two neck round bottom flask equipped with a stir bar and findensor was charged with poly(ethylene glycol) diamine 400 (156 mg, 0.389 mmol) in 10 mL/5 mL of THF/DMF and DIPEA (0.340 mL, 1.945 mmol) under N₂ atmosphere. 11 (6553 mg, 0.972 mmol) in 10 mL of HFE-7100 was added dropwise and heated to 60° C. for 30 min. Poly(ethylene glycol) methyl ether amine 500 (694 mg, 1.389 mmol) in 1 mL of THF was added. The mixture was heated to 60° C. for 2.5 hrs, cooled to room temperature and stirred overnight under N₂ atmosphere.

To remove unreacted amines, 10 mL of DCM followed by 10 mL of FC-72 (perfluorohexane) was added to the reaction mixture and the content transferred to a separatory funnel. Separatory funnel was shaken and was left standing until two clear layers were obtained. The top layer containing organics was discarded. The bottom layer was evaporated to give an opaque oil.

To remove PEG amine salts, the latter oil was washed with 1 N HCL, DI water followed by MeOH. The resulting oil was dissolved in 5 mL of HFE-7100 and 8 mL of THF was added. The resulting mixture was heated to 75° C. for 10 minutes and the top organic layer removed. 3 mL of MeOH was added, and the resulting mixture heated to 75° C. for 10 minutes. The top layer was removed and the bottom fluorous layer was evaporated to give the desired triblock copolymer 13 as pale yellow oil (79% yield). FT-IR (cm−1): 2870 (CH), 1721 (CO). ¹⁹F NMR (376 MHz, Benzene-d₆) δ−80.08-—86.48 (m), −131.41 (s), −133.18-−133.84 (m), −144.83-−147.14 (m).

### Example 3: Dye Retention in Droplets

To enable screening in picoliter droplets, each screening vessel is a stable and closed entity. Droplets can be stabilized by adding emulsifiers and/or nanoparticles in the continuous phase for the duration of the bioassay and screening, which can range from minutes to weeks. The emulsion formulation is prepared by dissolving the required amount of emulsifier such as either or both di- and tri-block copolymers and/or partially fluorinated silica nanoparticles in the fluorinated oil. The water in oil droplets are then generated by microfluidic devices such as the one shown in FIG. 3, wherein the water phase contains the bioassay and its media, and the continuous phase contains the oil and the emulsifier(s).

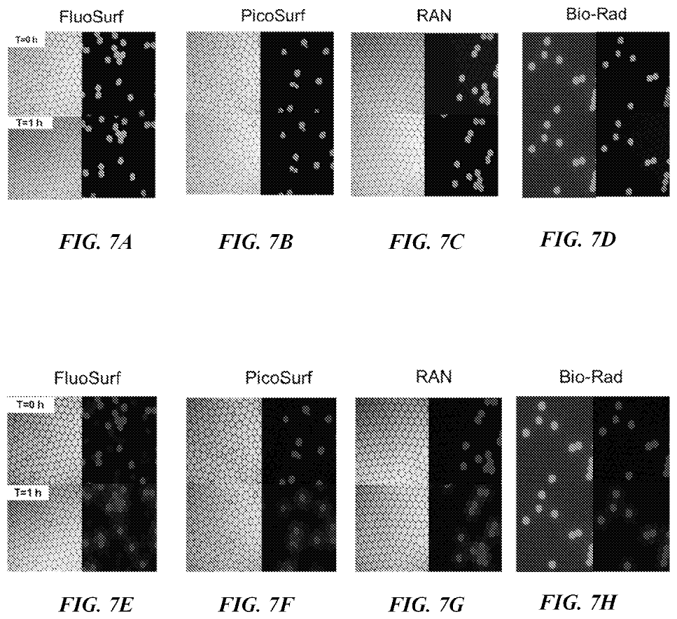

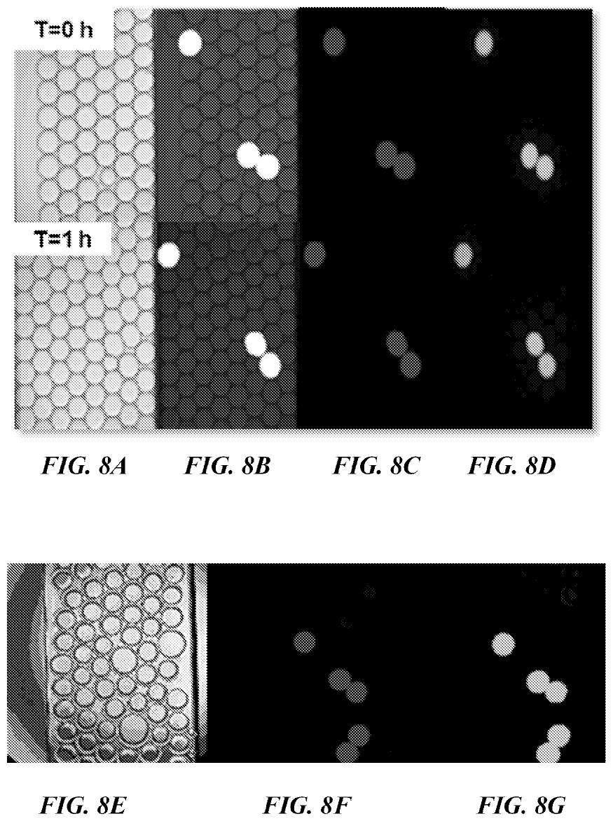

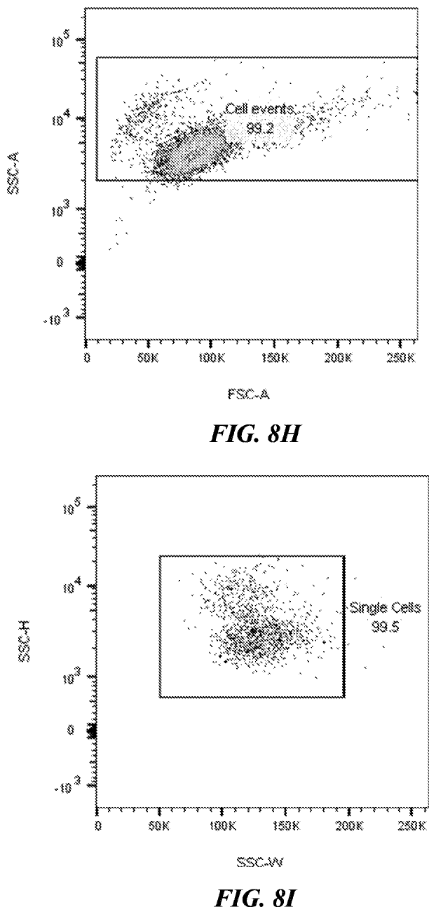

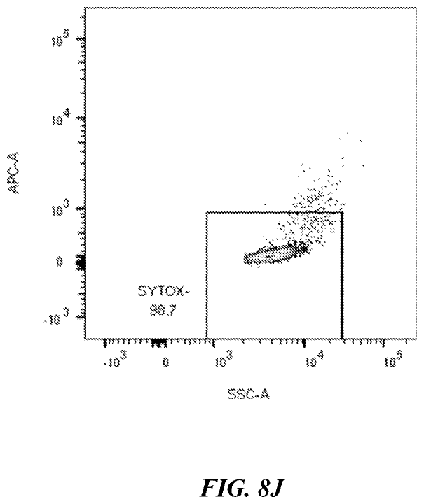

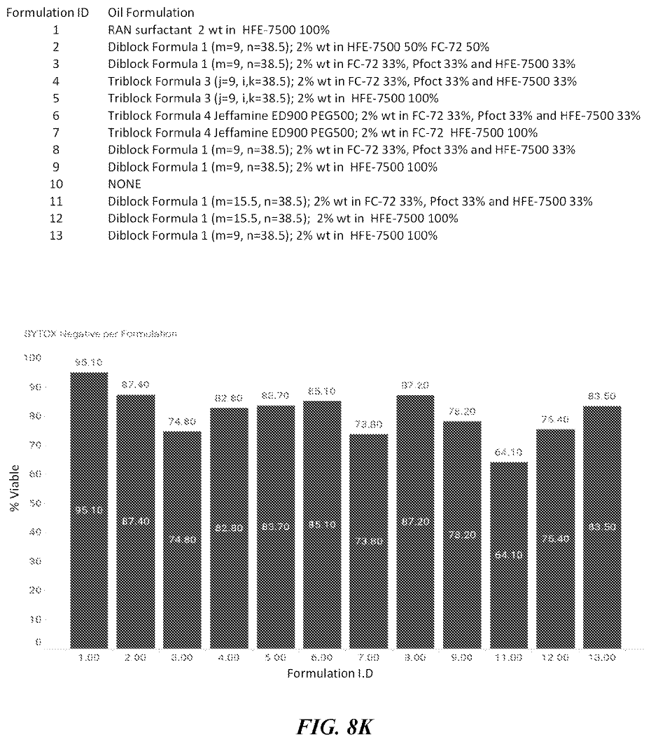

FIGS. 7A-7H show droplet retention of 100 μM fluorescein and 100 μM resorufin (in 1 M HEPES buffer) for four formulations, FluoSurf (Emulseo) (FIGS. 7A and 7E), PicoSurf (Sphere Fluidics, Ltd.) (FIGS. 7B and 7F), 008-FluoroSurfactant (RAN Biotechnologies) (FIGS. 7C and 7G), and droplet generation oil 1864006 (Bio-Rad) (FIGS. 7D and 7H), at time zero (top) and after one hour (bottom). While all showed good retention of hydrophilic and negatively charged dye fluorescein (FIGS. 7A-7D), all failed to retain neutral and more hydrophobic dyes such as resorufin (FIGS. 7E-7H).

Reducing the net dipole moment of an oil composition in the continuous phase can limit partitioning of organic molecules across droplet boundaries, and can also simultaneously achieve biocompatibility including cell viability as well as mechanical stability for droplet manipulations. Fluorophilicity of 2-(trifluoromethyl)-3-ethoxydodecafluorohexane (HFE-7500) (fluorine content 66%) was increased by wetting with co-solvent perfluorocarbons/perfluorinated oils (perfluorohexane (FC-72):perfluorooctane: 2-(trifluoromethyl)-3-ethoxydodecafluorohexane (HFE-7500) in a 1:1:1 w/w ratio, respectively; perfluorohexane(FC-72):perfluorooctane: 2-(trifluoromethyl)-3-ethoxydodecafluorohexane (HFE-7500) in a 2:2:1 w/w ratio, respectively; and perfluorohexane(FC-72):perfluorooctane: 2-(trifluoromethyl)-3-ethoxydodecafluorohexane (HFE-7500) in a 1:3:1 w/w ratio, respectively, resulting fluorine content>75%) resulting in increased compound retention. Formulations contained 2% wt of 1:1 ratio of copolymer of Formula 1 (average n is about 38 and average m is about 9) and a copolymer of Formula 2 (average i and k are about 38, and average j is about 9-11). No leakage of resorufin (100 μM) or fluorescein (100 μM) in HEPES buffer was observed. FIGS. 8A-8D show molecular retention of fluorescein (green; FIG. 8D) and resorufin (red; FIG. 8C) in droplets in the compositions containing perfluorohexane (FC-72):perfluorooctane: 2-(trifluoromethyl)-3-ethoxydodecafluorohexane (HFE-7500) in a 1:3:1 w/w ratio, respectively, and 2% wt block copolymers described above).

The use of conventional di- or tri-block co-polymer emulsifiers (C. Holtze et al., 2008; Christian Holtze et al., 2008), including commercial formulations described above, with these highly non-polar hydrofluoroether/perfluorocarbon carrier oil systems did not provide adequate droplet stability (IFT γ>10 mN/m), while the use of the formulations described above containing the 2% wt mixture of block co-polymers achieved excellent droplet stability (>1 week).

The effectiveness of the formulation perfluorohexane(FC-72):perfluorooctane:HFE-7500, 1:1:1 w/w ratio, with 2% wt copolymer of Formula 1 (average n is about 38 and average m is about 9), on retaining commonly used water soluble dyes (fluorescein derivatives, rhodamine derivatives and resorufins) shown below was determined. Excellent molecular retention in droplets was achieved for compounds with a range of physiochemical properties (Mol wt. 200->500 Da, TPSA 50-150 Å², hydrophobicity logD-2 to+4 and net charge of −1 to+1).

Fluorescent Markers: Fluorescein Derivative

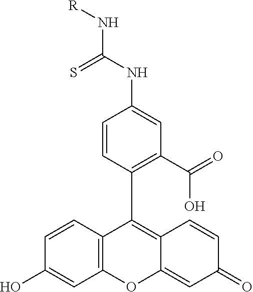

| R | 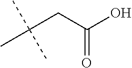 | 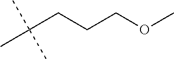 | 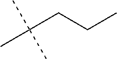 | 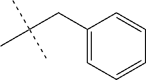 | 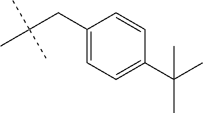 |
|---|---|---|---|---|---|
| MW | 464 | 476 | 448 | 496 | 562 |
| TPSA | 149 | 121 | 111 | 111 | 111 |
| logD (pH 7.4) | 2.3 | 1.2 | 1.8 | 2.2 | 3.8 |
| moka | | | | | |
| clogp | 1.7 | 2.4 | 3.0 | 3.7 | 5.5 |
| NBR | | | | | |

Fluorescent Markers: Rhodamine Derivatives

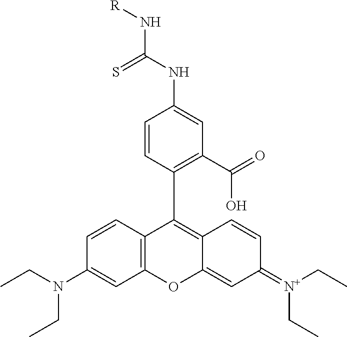

| R | 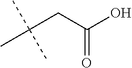 | 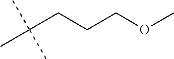 | 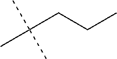 | 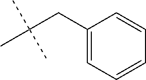 | 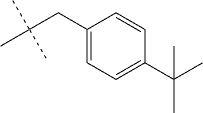 |
|---|---|---|---|---|---|
| MW | 576 | 590 | 560 | 608 | 664 |
| TPSA | 118 | 90 | 81 | 81 | 81 |
| logD (pH 7.4) | −1.5 | 0.6 | 3.7 | 2 | 3.6 |
| moka | | | | | |
| clogp | 1.0 | 1.7 | 2.3 | 3.0 | 4.6 |
| NBR | | | | | |

Fluorescent Markers: Resorufin Derivatives

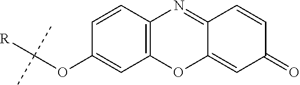

| R | 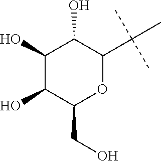 | 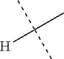 | 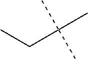 | 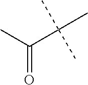 | 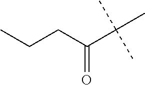 |
|---|---|---|---|---|---|
| MW | 375 | 213 | 241 | 255 | 263 |
| TPSA | 142 | 63 | 52 | 69 | 69 |
| logD (pH 7.4) | −0.7 | 0.5 | 2.4 | 1.8 | 2.8 |
| moka | | | | | |
| clogp | −0.2 | 1.6 | 1.9 | 1.5 | 2.4 |
| NBR | | | | | |

In addition, retention of resorufin (100 μM) and fluorescein (100 μM) was evaluated in droplets containing different buffer systems with varying salt concentrations (PBS 1×-10×, Tris 100 mM-1M and HEPES 100 mM-1M) and assay media (RPMI cell culture media). With the formulation perfluorohexane(FC-72):perfluorooctane: 2-(trifluoromethyl)-3-ethoxydodecafluorohexane (HFE-7500) in a 1:1:1 w/w ratio, with 2% wt copolymer of Formula 1 (average n is about 38 and average m is about 9), described above), no detectable leakage was observed, and retention was independent of the buffer system used. Also, the nature of the buffer system had little impact on droplet stability.

### Example 4: Cell Viability in Presence of Di- and/or Tri-Block Co-Polymer Emulsifiers

The effect of di- and tri-block copolymers on the viability of cells was determined by encapsulating Jurkat cells in 100 micron drops and incubating on bench top for 24 hours. Cell concentration was adjusted to 2.0×10\hat{ }6/mL in fresh media, RPMI 10% FBS 1% Pen Strep 2.5% Ficoll Type 400 (Sigma-Aldrich F5415-50ML) before encapsulation and drops were collected into eppendorf tubes. Drops were then broken using a final concentration of 10% 1H,1H,2H,2H-Perfluoro-1-octanol (PFO). The aqueous layer containing cells was collected, washed, and stained with at 1:1000 dilution of SYTOX RED (ThermoFisher S348969) and analyzed on a BD Fortessa (BD Bioscience 647645) flow cytometer (excitation 633nm, emission filter 670+/−15 nm).

### Example 5: Mechanical Stability and Surface Tension of Emulsion Formulations

Mechanical stability was assessed by repeated pipetting and spinning emulsion droplets at 16900 rcf after which the remaining vs. coalesced droplets were assessed under microscope. The surface tension was determined by pendant drop method (DSA 30, Kruss, Germany)).

| | | Interfacial | Interfacial | Interfacial | | |
|---|---|---|---|---|---|---|
| | Surrounding | tension (mN/m) | tension (mN/m) | tension (mN/m) | | |
| Name (formulation) | Phase | Run 1 | Run 2 | Run 3 | Average | Std |
| PFPE(7500)-PEG(400)- | RPMI | 6.84 | 6.92 | 6.83 | 6.863333333 | 0.04027682 |
| PFPE(7500):PFPE(7500)- | | | | | | |
| PEG(500) (1:1) 2 wt in | | | | | | |
| 33% HFE-7500, 33% FC- | | | | | | |
| 72 and 33% Pfoctane | | | | | | |
| PFPE(7500)-PEG(400)- | RPMI | 2.31 | 2.4 | 2.21 | 2.306666667 | 0.077602978 |
| PFPE(7500):PFPE(7500)- | | | | | | |
| PEG(500) (1:1) 2 wt | | | | | | |
| in 100% HFE-7500 | | | | | | |
| PFPE(7500)-PEG(400)- | RPMI | 5.83 | 5.86 | 5.77 | 5.82 | 0.037416574 |
| PFPE(7500):PFPE(7500)- | | | | | | |
| PEG(500) (1:1) 2 wt in | | | | | | |
| 20% HFE-7500, 40% FC- | | | | | | |
| 72 and40% Pfoctane | | | | | | |
| PFPE(7500)-PEG(400)- | RPMI | 5.7 | 5.6 | 5.78 | 5.693333333 | 0.07363574 |
| PFPE(7500):PFPE(7500)- | | | | | | |
| PEG(500) (1:1) 2 wt in | | | | | | |
| 20% HFE-7500, 20% FC- | | | | | | |
| 72 and 60% Pfoctane | | | | | | |
| PFPE(7500)-PEG(600)- | RPMI | 5.57 | 5.58 | 5.82 | 5.656666667 | 0.115566239 |
| PFPE(7500):PFPE(7500)- | | | | | | |
| PEG(500) (1:1) 2 wt in | | | | | | |
| 20% HFE-7500, 20% FC- | | | | | | |
| 72 and 60% Pfoctane | | | | | | |
| PFPE(7500)-ED(900)- | RPMI | 6.1 | 6.15 | 6.27 | 6.173333333 | 0.071336449 |
| PFPE(7500):PFPE(7500)- | | | | | | |
| PEG(500) (1:1) 2 wt in | | | | | | |
| 20% HFE-7500, 20% FC- | | | | | | |
| 72 and 60% Pfoctane | | | | | | |
| PFPE(7500)-PEG(500)- | RPMI | 4.81 | 4.89 | 4.84 | 4.846666667 | 0.032998316 |
| PFPE(7500):PFPE(7500)- | | | | | | |
| PEG(500) (1:1) 2 wt in | | | | | | |
| 20% HFE-7500, 20% FC- | | | | | | |
| 72 and 60% Pfoctane | | | | | | |
| Fluorosurf 2 wt HFE-7500 | RPMI | 8.02 | 7.94 | 7.91 | 7.956666667 | 0.046427961 |
| RAN 2 wt HFE-7500 | RPMI | 3.12 | 3.35 | 3.39 | 3.286666667 | 0.118977122 |

### Example 6: Exchange with Emulsifier-Free Continuous Phase to Minimize Compound Cross-Contamination

2 μL of 100 micron diameter fluorescence labeled droplets (100 μM Fluorescein & 100 μM Resorufin in RPMI buffer) were mixed with 18 μL of 100 micron diameter unlabeled droplets (RPMI buffer). Oil layer 20% HFE-7500, 20% FC-72 and 60% Perfluoroctane) containing emulsifiers (Formula 1 (n is about 38, and m is about 9): Formula 2 (i and k are about 38, and j is about 9-11) 1:1, 2 wt %) was removed from the emulsion. Droplets were washed with 20 μL of emulsifier free oil blend (20% HFE-7500, 20% FC-72 and 60% Perfluroctane). The oil removal and washing process was repeated 3×. Droplets were incubated in an eppi tube for>5 days and leakage monitored by fluorescence spectroscopy (CY3 10 ms & FITC 10 ms exposure). No leakage of resorufin or fluorescein to the unlabeled droplets was observed (FIG. 8E-8G).

### Example 7: Synthesis of Boc-Amino-PEG Functionalized Monodisperse PEGA Resin

PEGA hydrogel microbeads were synthesized through microfluidic encapsulation. A 1 mL aqueous phase was prepared containing 100 μL TBSET buffer, 30 μL 10% (w/v) APS (Sigma-Aldrich, A9164), 37. 6 mg dimethyl acrylamide (Sigma-Aldrich, 274135), 25.1 mg acrylamide-PEG-acrylamide 2KD (Biochempeg, 10060), 19.7 mg Boc-NH-PEG4-acrylamide (Biochempeg, 12310), 787.6 mL of water. This solution was filtered using 0.2 micron syringe filter before loading the solution into a 1-mL syringe (Becton Dickinson, 309628). 2.5 mL carrier oil (RAN Biotechnologies, 008-FluoroSurfactant-2wtH-50G) and 10 μL of TEMED (Sigma-Aldrich, T9281-25ML) were mixed and loaded into a 3-mL syringe (Becton Dickinson, 309657). These two syringes were connected with inlets of the droplet generation device by PE2 tubing (Scientific Commodities, BB31695-PE/2). The aqueous solution was pumped with 900 μL/h and the oil with 1800 μL/h. The emulsion droplets were collected at the outlet of the microfluidics chip in the eppendorf tube containing 50 μL mineral oil (Sigma-Aldrich, M5310-1L) and incubated at 65° C. for overnight. The eppendorf tube was centrifuged and the oil phases are discarded. The beads were washed twice with 500 μL 20% (vol/vol) PFO (Alfa Aesar, B20156) in HFE 7500 (Novec 7500) to break the drops. The beads in the aqueous phase were washed with 1% Span-80 (Sigma-Aldrich, S6760-250ML) in hexane (Sigma-Aldrich, 227064-1L) twice and then with TBSET buffer 3 times. The beads were filtered through 70 μm cell strainer (Corning, 352350) and then stored in TET buffer at 4 degrees for up to 6 months.

### Example 8: Preparation of 10 um TentaGel® and Monodisperse 33 Micron PEGA Resin Bearing Fluorescein Through a Photocleavable Linker

In order to determine the loading capacity and photorelease compatibility of TentaGel® and PEGA resin, a fluorescein probe was loaded adopting standard solid-phase organic synthesis protocols with a few modifications. Briefly, the Boc protecting group on freshly prepared 33 micron diameter monodisperse PEGA resin was removed by treatment with HCl in methanol for a couple of hours. The resin was washed by decanting the supernatant after centrifugation and then acylated with an acid linker bearing fluorescein through a photocleavable linker using standard coupling condition using DIC/HOAt, again washing the resin by decanting the supernatant and exchanging the solvent repeatedly. The fluorescein loaded 33 micron amino PEGA resin thus prepared was kept in the dark under refrigerated conditions until further use.

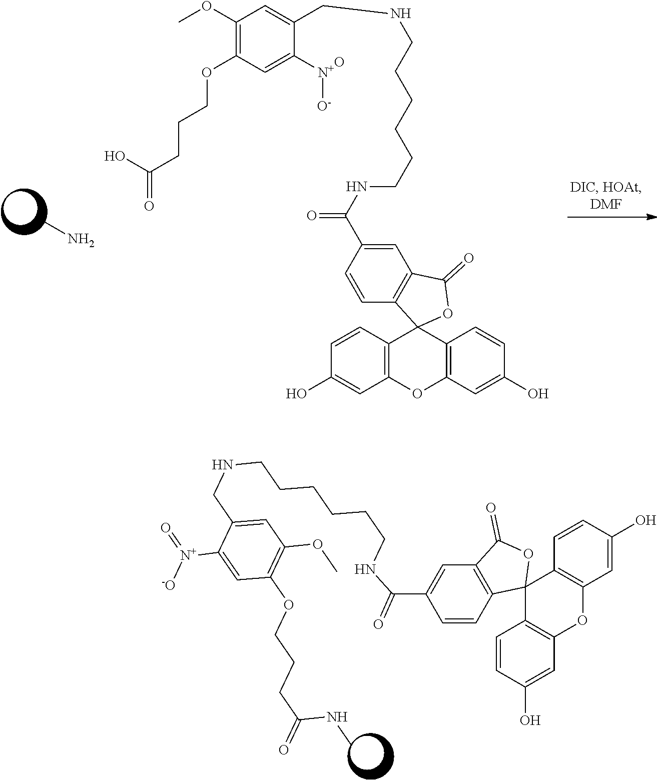

### Example 9: Loading Capacity of Amino Polystyrene-PEG Hybrid (TentaGel®) and Amino-PEGA Resin

The loading capacity of 10 micron TentaGel® NH2 (Rapp Polymere) (amino polystyrene-PEG hybrid) and 33 micron amino-PEGA resin was be determined by loading fluorescein to the resin through a photocleavable linker, individually encapsulating beads in single droplets of known volume through microfluidic device, photoreleasing fluorescein from the beads within the droplet, and determining the fluorescence intensity of the droplet. In 100 micron droplets, the loading capacity of 10 micron TentaGel® NH2 (Rapp Polymere) was determined to be at least 5 femtomoles per bead achieving at least 10 micromolar concentration. The loading capacity of 33 micron amino-PEGA resin prepared as described in Example 7 was determined to be approximately 20 femtomoles per bead, achieving roughly 35 micromolar concentration in 100 micron diameter droplets. PEGA resin achieved complete release of fluorescein from the bead into the droplet (FIGS. 9C-9D (before and ˜10 sec after release, respectively)), while amino polystyrene-PEG hybrid (TentaGel®) resin did not release fluorescein completely8(FIGS. 9A-9B, (before and —10 sec after release, respectively)).

### Example 10: Quantitative 1:1 Encapsulation of PEGA Resin into Droplets

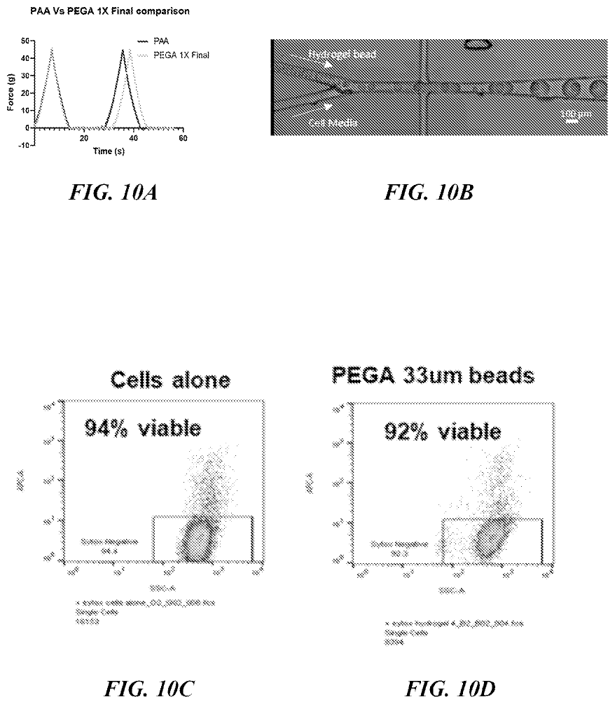

33 micron PEGA 1×hydrogel beads were washed multiple times with TET buffer and HBW buffer by vortexing, centrifuging at 1000 g for 3 minutes, and carefully removing the supernatant between washes. Resulting washed beads were mixed with equal volumes of 2×bead conc. mix, vortexed, centrifuged and all supernatant was removed to prepare close-packed PEGA 1×beads. To a 1 mL syringe was attached PE-2 tubing with a 25-gauge needle. The beads were loaded into the tubing by inserting the open end of tubing into the beads and gently pulling the plunger. After bead loading, the open end of the tubing was attached to the syringe with the 25-gauge needle filled with HF-7500 carrier oil. These beads were encapsulated in the droplets using a microfluidic device containing three inlets (2 aqueous, 1 oil) and one outlet. The two aqueous inlets were used to connect beads and cell media and one organic inlet was used to connect carrier oil (RAN Biotechnologies, 008-FluoroSurfactant-2wtH-50G). The flow rates for three inlets were optimized to get one bead per one droplet encapsulation as shown in FIG. 10B.

### Reagents

1. Tris-EDTA-Tween Buffer (TET)
   a. 480 mL nuclease-free water
   b. 5 mL 1M Tris-HCl (pH 8.0)
   c. 10 mL 0.5M EDTA
   d. 5 mL 10% (vol/vol) Tween-20 in nuclease-free water
   e. Filter solution through 0.2 um membrane
2. Hydrogel bead wash buffer (HBW)
   a. 980 mL nuclease-free water
   b. 10 mL 1M Tris-HC1 (pH 8.0)
   c. 200 uL 0.5M EDTA
   d. 10 mL 10% (vol/vol) Tween-20 in nuclease-free water
   e. Filter solution through 0.2 um membrane
3. 2×bead concentration mix
   a. 6.1 mL nuclease-free water
   b. 4.2 mL 5×First Strand Buffer
      i. Thermo Fisher Scientific cat. No. 18080-044
         1. 250 mM Tris-HCl (pH 8.3 at room temperature)
         2. 375 mM KCl
         3. 5 mM MgCl2
   c. 210 uL 10% (vol/vol) Igepal CA-60

FIG. 10A shows compressibility of reference polyacrylamide resin for DropSeq (PAA) vs. PEGA 1×rods as measured by texture analyzer—The compressibility of PEGA 1×roughly matches that of polyacrylamide reference gel (PAA).

FIG. 10B shows tight packing of PEGA 1×resin in one channel and quantitative 1:1 encapsulation into droplets.

### Example 11: Cell Viability in Presence of PEGA Resin

Jurkat cells suspended RPMI 20% FBS 1% Pen Strep and resins suspended in water at 1×10⁶ resins or cells/mL were mixed 1:1 in a 96 well micro titer plate in a final volume of 200 μL then incubated for 24 hours at 37° C., 5% CO₂. Cells were also mixed in the same way with water. Appropriate samples were stained at a 1:1,000 dilution with SYTOX RED (ThermoFisher Scientific S348959) and read on a BD Fortessa flow cytometer. FIGS. 10C and 10D show FACS results for biocompatibility of 33 micron PEGA resin. PEGA resin had minimal impact on the cell viability as determined by FACS after co-incubation in microtiter well plates for 24 hours.

Cells cultured in the presence of PEGA 32 μM 2000 PEG 1×survived similarly to cells cultured with 50% water, while cells cultured with PEGA 32 μM 3700 PEG 2×showed about a 70% decrease in viability.

### Example 12: Compound and DNA-Tag Loading onto 10 Micron TentaGel® and 33 Micron PEGA Resin

Reference compound beads were prepared on 10 micron TentaGel® NH2 and 33 micron PEGA resin by adopting the protocol described by Paegel et al (Paegel et al., 2020) with some modifications. Briefly, the native resin was functionalized with Glycine, pbf-protected arginine, Glycine, azidoLysine and Glycine by the successive loading of the respective Fmoc-protected amino acids using DIC/Oxyma/DIPEA in DMF. Each loading step was followed by a capping step with a 20% Acetic anhydride solution in DMF followed by a Fmoc deprotection with a 20% 4-Methylpiperidine solution in DMF. The resin was then reacted with the reference compound derivatized with the photocleavable linker using DIC in a DCM/DMF 1/1 mixture. The DNA Headpiece was then loaded by click chemistry between the azide handle on the resin and the DBCO-derivatized Headpiece. Multiple simultaneous enzymatic ligations using T4 ligase were finally performed to fully encode the beads in Bis-Tris buffer amended with NaCl, ATP and MgCl₂.

### Example 13: Encapsulation of Fluorescein Loaded TentaGel® in Polyacrylamide Hydrogel Bead, Droplet Encapsulation and Intra-Droplet Photo-Release and Loading Capacity Determination

0.15 mg of Fluorescein labeled TentaGel® (TG) bead (attached through a photolabile linker) was dispersed in 1.5 mL of hydrogel precursor (PAA/APS and water). The fluorescein labeled TG beads were encapsulated in polyacrylamide hydrogels using a dolomite microfluidic device. The aqueous line contained the hydrogel precursor and TEMED was dispersed in the oil (008-fluorsurfactant (RAN Biotechnologies) 2 wt % in HFE). 60 micron Hydrogels were generated by incubating droplets at 65° C. for 24 hrs.

The hydrogels were encapsulated in 100 micron droplets (FIG. 9E) and subjected to 365 nm UV light. Homogenous diffusion of the fluorescein from TG to the hydrogel and the surrounding droplet was observed (FIG. 9F). A 10 μM concentration was achieved after 100 ms of exposure.

### Example 14: FACS Enrichment of TentaGel® in Polyacrylamide Hydrogel Bead

10 μl of TentaGel® in Polyacrylamide beads were loaded into a countess slide (Countess Cell counting Chamber Slide C10228) and imaged under bright field at 4×magnification using an EVOS FLoid Imaging System (ThermoFisher Scientific 4471136). Beads in image were manually counted and co encapsulation rate was calculated. Crude TentaGel® in Polyacrylamide beads were enriched using the SONY SH800 FACS sorter configured with a 130 μM sorting chip at 9 PSI. Beads sorted at a moderate flow rate (6/10). All events flowing through the machine were analyzed for FITC (ex. 488 nM em. 525/50 nm) and PE (ex. 561 nm em. 600/60 nm) fluorescence. Beads were enriched for those that had higher FITC and PE fluorescence comparatively to other events being analyzed. FIG. 9I shows the scatter plot and gated population. Sub population of beads were sorted into a 96 well micro titer plate containing 100 ul of water, 10K beads/well. Samples were collected and pooled and imaged and quantified in the same way as described above. Images show an enrichment of co encapsulated beads from 6% to 75% (FIGS. 9G and 9H, respectively).

### Example 15: Quantitative PCR on PEGA Resin, TentaGel® Resin and TentaGel® in Polyacrylamide Resin

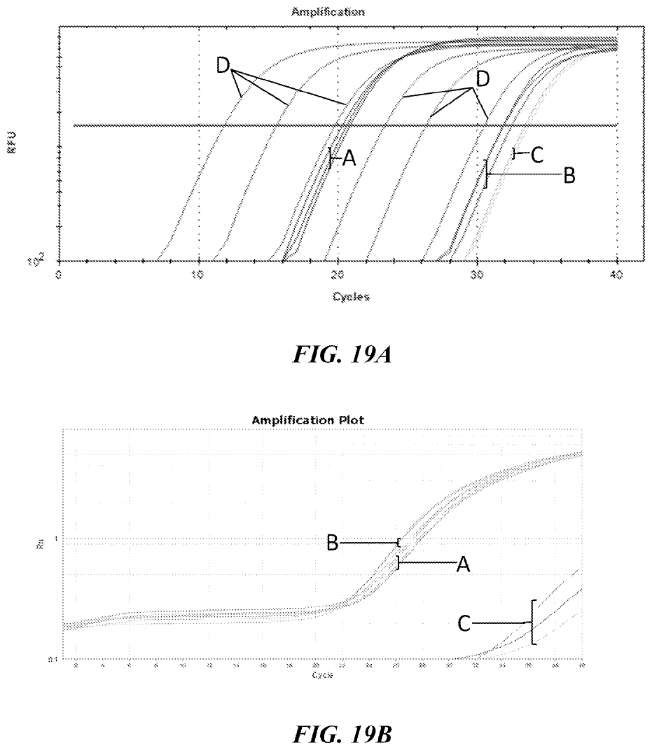

FIG. 19 shows amplification curves of different samples against a standard curve (in green). 3 samples are analyzed: a blank made of MilliQ Water (cyan curves), a control sample (beads that were mixed with DNA tags without T4 DNA ligase-pink curves) and sample beads ( fully encoded beads-purple curves). Whereas the control beads displays only low amplification compared to the blank samples, the sample beads displays an unambiguous amplification compared with the blank and the control, confirming the enzymatic ligation success. All samples were run at least in triplicates. Based on the number of beads in the sample, the amount per beads can be estimated using the standard curve.

### Example 16: UV Photo-Cleavage and Image Acquisition

A 25 μL aliquot of 100 micron water in oil droplets without mineral oil overlay (to avoid cracking/degradation of ibidi polymeric slide bottom) was loaded into one channel of an uncoated ibidi 100 um channel slide (ibidi cat. #80661) and sealed with Kwik-Cast sealant (World Precision Instruments cat. #KWIK-CAST). The sample was placed on a Zeiss Axio Observer Z1 microscope with hydrogel beads in focus and a snapshot of the sample was acquired on a widefield (WF) detector prior to UV exposure. UV photo-cleavage was carried out with 10 msec intervals of UV exposure (385 nm Colibri LED at 10%, which yields 20.7 mW at 365 nm), modifying total number of cycles to yield the total exposure time of interest up to a maximum of 10 sec (e.g., 100 cycles=1 sec). 10 msec 2% 488 nm Colibri LED excitation was also used to capture videos of fluorescein release from bead into droplet interior. Total image acquisition time was much longer than the sum of all cycles of 10 msec bursts due to switching time for optics.

### Example 17: TentaGel® Bead Validation and Encapsulation in Polyacrylamide Hydrogel UV Photo-Cleavage and Image Acquisition

A 25 uL aliquot of 100 um water in oil droplets containing TentaGel® amino polystyrene-PEG hybrid beads without mineral oil overlay (to avoid cracking/degradation of ibidi polymeric slide bottom) was loaded into one channel of an uncoated ibidi 100 um channel slide (ibidi cat. #80661) and sealed with Kwik-Cast sealant (World Precision Instruments cat. #KWIK-CAST). The sample was placed on a Zeiss Axio Observer Z1 microscope with beads in focus, and a snapshot of the sample was acquired on a widefield (WF) detector prior to UV exposure. WF UV photo-cleavage acquisition template was loaded, and UV photo-cleavage experiments were carried out with 10 msec intervals of UV exposure (385 nm Colibri LED at 10%, which yields 20.7 mW at 365 nm), modifying total number of cycles to yield the total exposure time of interest up to a maximum of 10 sec e.g., 100 cycles=1 sec). 10 msec 2% 488 nm Colibri LED excitation was also used to capture videos of fluorescein release from bead into droplet interior. Total image acquisition time was much longer than the sum of all cycles of 10 msec bursts due to switching time for optics.

### Example 17a: PEG Coating of Fluorescein Loaded TentaGel® Beads to Make Thin-Shell Beads

To a suspension of 20 million of fluorescein labeled TentaGel® (TG) bead (attached through a photolabile linker) in 7:3 mixture of acetonitrile and 30 mM TEAA pH 7.4 with 1% Pluronic F127 (a block polymer of PEG and PPG, also called Poloxamer or Poloxamer 407) was added 20.8 mg of PEG 40K DBCO (Creative PEGworks, #PSB-707). The suspension was mixed on a shaker at room temperature for 5 days. The suspension was then centrifuged at 6000 rcf for 2 min, supernatant discarded, and re-suspended in the cell culture media. The process was repeated three times to ensure complete buffer exchange and removal of excess PEG-DBCO. The suspension was kept in fridge until further use.

The thin-shell bead with PEG10K coating was prepared from 20 million fluorescein labeled TentaGel® (TG) beads (attached through a photolabile linker) in a similar manner, except using 26 mg of PEG 10K DBCO (BroadPharm #BP-22462) and 1:1 mixture of DMSO and 30 mM TEAA pH 7.4 and with overnight shaking.

### Example 17b: UV Photo-Cleavage and Image Acquisition of PEGylated Thin-Shell Fluorescein Loaded TentaGel® Beads

An analogous protocol as described in Example 17 was used to confirm the UV photo-cleavage of the fluorescein probe and image acquisition with 10K or 40K PEG loaded fluorescein loaded TentaGel beads. The approximate loading was determined to be up to 25 fmoles per bead for 10K PEG coated beads, and up to 36 fmoles per bead for 40K PEG coated beads.

### Example 17c: PCR of PEGylated (Thin-Shell) TentaGel® Beads (FIG. 19B)

The same protocol as described in Example 15 was used to confirm amplification of the DNA tags with 40K PEG coated null library beads. While the amplification of the control bead, no PEG, is low, there is clear amplification when compared with the negative control the MilliQ water. The sample beads with the 40K PEG have equal amplification with the control beads which have the same DNA tags but no PEG. The overlapping curves clearly indicate that the conjugation of 40K PEG post synthesis does not impact the amplification of the DNA tags when compared with the control samples with no PEG. The two samples with beads were run five times and the MiliQ water was run in triplicate. Based on the number of beads per sample, the amount of DNA per beads can be estimated using the standard curve.

### Example 18: Emulsion Array

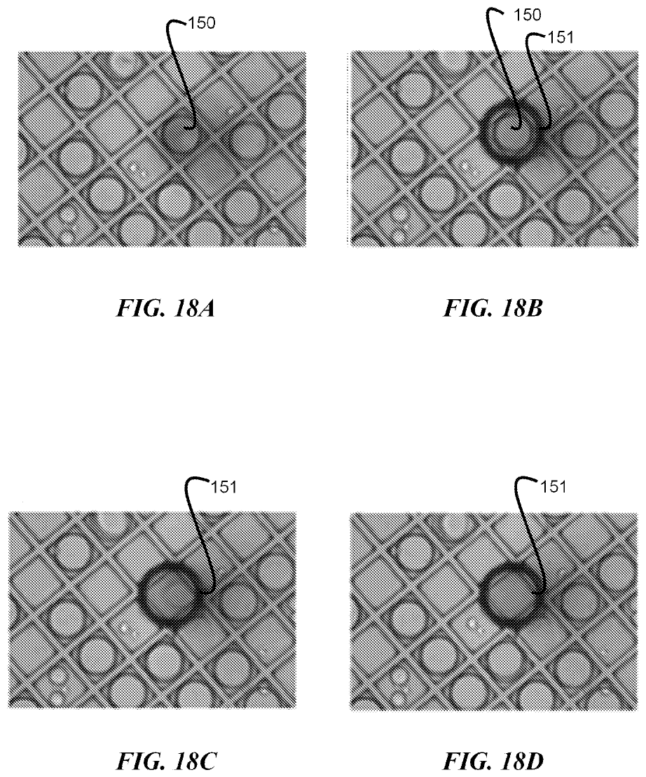

FIGS. 18A-18D are a microwell plate containing an aqueous solution in which water in fluorinated oil in water double emulsion droplets were loaded. The double emulsions sank to the bottom occupying a maximum one double emulsion per well. FIG. 18A is microwell plate containing a double emulsion 150 to be removed. FIG. 18B is the microwell plate in which capillary 151 that is slightly bigger than the double emulsion (150) is lowered. A volume of solution is aspirated to remove the double emulsion from the well (FIGS. 18C and 18D). A single detected emulsion was aspirated from the micro well plate with a CELLector tool from Molecular Machines & Industries (Eching, Germany), with a modified aspiration capillary tube designed for droplet aspiration from a grid, without disturbing neighboring droplets. The CELLector tool included a modified aspiration capillary tube designed for droplet aspiration from a grid, vs. aspiration of cells from a flat bottom microwell plate.

### Example 19: Next-Generation Sequencing (NGS) and Deconvolution of DNA-Encoded One-Bead-One-Compound Library

NGS and informatics for bead barcode counting and hit deconvolution was performed on a mock encoded library screen set consisting of 1% of a mixture of positive and negative controls and 99% of roughly 10K null library. Next generation sequencing and data science was used to deconvolute hits. DNA barcodes from encoded beads were sequenced. Described herein is, among several approaches, a method of directly performing PCR on DNA linked to bead.

Barcodes where recovered from bead libraries through PCR and NGS workflows. PCR was performed using, KAPA HiFi HotStart ReadyMix PCR kit (KAPA BiosystemsKR0370). Libraries of beads were combined at a 96:1 ratio and PCR reactions were performed on 2,500 beads in a 50 μl reaction. PCR product was purified using AMpure XP beads (Beckman Coulter Life sciences, A63882) and analyzed with the Agilent D1000 ScreenTape System. Library preparation for NGS was prepared using NEBNext Ultra II DNA Library Prep Kit for Illumina EB#e7545S/L Version 5. New England BioLabs Inc., according to the “Miseq System Denature and Dilute Libraries guide” Document #15039740 version 10 Illumina.

### NGS Data Pre-Processing

Following sequencing runs on the Miseq system (paired-end 150base reads sequenced), NGS data in the form of pooled raw sequencing BCL files were demultiplexed into separate paired-end reads (R1 and R2) fastq files (e.g. sample1.Read1.fastq and sample1.Read2.fastq) for each sample using Bcl2Fastq (Illumina) and Illumina adapter sequences were trimmed in the process. FASTQC was used to generate sequencing quality reports for each R1/R2 fastq files pairs (www.bioinformatics.babraham.ac.uk/projects/fastqc/).

Tools from the BBTools suite (jgi.doe.gov/data-and-tools/bbtools/) were used for subsequent processing steps. Remnant Illumina adapter sequences were trimmed using BBTools/bbduk. BBTools/dedupe was used to collapse read pairs with same sequence containing the same UMI (Unique Molecular Index) to remove sequencing bias potentially introduced by the PCR step and the deduplicated read pairs were reported as combined fastq files. Reads R1 and R2 were then merged into unique sequences using BBTools/bbmerge, requiring an overlap of the pairs of at least 145 bases, using default quality filters. A majority (75%) of reads were conserved at this point.

Sequences common to the 5′ and 3′ end of all reads were further trimmed using BBTools/bbduk prior to counting bead-specific and compound-specific barcodes.

### Decoding/Hit Calling

Pre-processed barcode sequences were decoded into the compound specific barcode (CSB) portion (˜39 bp) and the associated bead-specific barcode portion (BSB; ˜45 bp) allowing up to 2 mismatches over the ˜85 bp trimmed sequences. The majority (81%) of pre-processed sequences map to expected barcodes at this mismatch level.

CSB+BSB pairs with a read count below a background read number of 2 (can vary depending on sequencing read depth) were not considered.

The number of unique bead barcodes with 2 or more read count were counted for each compound and the compounds (CSB) were ranked by the number of unique beads.

### Example 20: Acrylation of Amino-Functionalized Polystyrene-Coated Iron Oxide Magnetic Nanoparticles

A 15-mL Falcon tube was charged with amino-functionalized polystyrene-coated iron oxide magnetic nanoparticles (TurboBeads, Zurich, Switzerland) (200 mg, 0.086 mmol amine equivalents). The nanoparticles were suspended in 5 mL of 20% N-methylmorpholine in DMF, vortexed, and sonicated in sonication bath for 1 hour. The nanoparticles were centrifuged (1000 rcf, 5 min), supernatant was removed, 3 mL of DMF was added and the tube was vortexed. This wash process was repeated two more times with DMF (3 mL each).

The magnetic nanoparicles washed above were suspended in 3 mL DMF, and treated with NHS ester functionalized PEG acrylate (Laysan Bio, ACRL-PEG-SVA-2000, 123 mg) in DMF (3 mL) followed by DIPEA (50 uL). The suspension was sonicated for 5 min then mixed on shaker overnight. The beads were washed 3×with DMF (3 mL each) followed by 3×with water (3 mL each) and the final suspension was adjusted to 150 mg/mL concentration in water.

### Example 21: Preparation of Magnetic PEGA Hydrogel Beads

A 100 uL aliquot of acrylated magnetic beads prepared in Example 20 (150 mg/mL in water) was added to 900 uL of PEGA hydrogel mix as described in Example 7. The suspension was chilled on ice bath and probe sonicated at full amplitude (55W) with QSonica Q55 Sonicator Ultrasonic Processor (Qsonica, Vernon Hills, IL, USA), with 4 cycles of 15 second pulses. The suspension was then passed through 20 um cell strainer (CellTrics 20 um, Sysmex, Kobe, Japan) and the filtrate was loaded into a 1 mL syringe (Beckton Dickinson, Vaud, Switzerland). Droplets were generated using a custom PDMS device as described in Example 7. The continous phase was 2% RAN in HFE-7500 (RAN biotechnologies, Beverly, MA). The flow rate was 500-600 uL/hr for the disperse phsae and 1000 uL/hr for the continuous phase. The generated droplets were collected in a total of two 1.5 mL Eppendorf tubes each topped with 50 uL of light mineral oil. The tubes were then incubated at 60° C. for 18 hours.

The fluorous oil in each of the Eppendorf tube was removed by syringe, and the emulsion was treated with 20% pefluorooctanol in HFE7500 and vortexed. The tubes were centrifuged (1000 rcf, 3 min) and the fluorous oil was removed by syringe. The beads were washed again with 20% PFO, followed by another two washes with Span 80 in heptanes. The beads were then transferred to two 15 mL Falcon tubes with 1% Pluronic F127 in water, vortexed, then centrifuged at 1000 rcf for 5 min. The supernatant was removed, and the beads were suspended in 1% Pluronic F127 in 1×PBS (˜3 mL each).

The large hydrogel particles were removed by vortexing the Falcon tubes, then letting the large, heavy particle settle for ˜30 seconds then transferring the supernatant to one 15 mL Falcon tube. The supernatant thus collected containing smaller suspended magnetic hydrogel beads were then collected on 50 um mesh cell strainer (CellTrics, Sysmex, Kobe, Japan) by transferring the suspension with syringe. The beads were washed 3×with 1% Pluronic F127 in 1×PBS (3 mL each). The beads were then recovered into a 1.5 mL Eppendorf tube by re-suspending the beads in 1% Pluronic F127 in 1×PBS, centrifuging and removing supernatant as needed. The average size and % CV were determined by observing the magnetic beads under microscope, with 5 fields of view at 20×magnification. A total of 46 beads were analyzed which gave average diameter of 120 um with 16% CV.

### Example 22: Assessment of Magnetic PEGA Beads

Next, the magnetic PEGA beads were tested for their magnetic properties by standing on a magnetic rack (MagJET Separation Rack, Thermo Scientific, Waltham, MA). By visual inspection, most of the hydrogels were collected on the side of the tube in approximately 3 minutes.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

### References

Auzanneau, F.-I, Meldal, M., & Bock, K. (1995). Synthesis, characterization and biocompatibility of PEGA resins. In Journal of Peptide Science. https://doi.org/10.1002/psc.310010106
Brower, K. K., Brower, K. K., Carswell-Crumpton, C., Klemm, S., Cruz, B., Kim, G., Calhoun, S. G. K., Nichols, L., Fordyce, P. M., Fordyce, P. M., Fordyce, P. M., & Fordyce, P. M. (2020). Double emulsion flow cytometry with high-throughput single droplet isolation and nucleic acid recovery. Lab on a Chip. https://doi.org/10.1039/d0lc00261e
Brower, K. K., Carswell-Crumpton, C., Klemm, S., Cruz, B., Kim, G., Calhoun, S. G. K., Nichols, L., & Fordyce, P. M. (2019). Optimized double emulsion flow cytometry with high-throughput single droplet isolation. In bioRxiv (p. 803460). Cold Spring Harbor Laboratory. https://doi.org/10.1101/803460
Cabantous, S., Nguyen, H. B., Pedelacq, J. D., Koraichi, F., Chaudhary, A., Ganguly, K., Lockard, M. A., Favre, G., Terwilliger, T. C., & Waldo, G. S. (2013). A new protein-protein interaction sensor based on tripartite split-GFP association. Scientific Reports. https://doi.org/10.1038/srep02854
Di Carlo, D., Wu, C., Destgeer, G., & Ouyang, M. (2019). PARTICLE-DROP STRUCTURES AND METHODS FOR MAING ANDUSING THE SAME (Patent No. US20190381497A1).
Duarte, J. M., Barbier, I., & Schaerli, Y. (2017). Bacterial Microcolonies in Gel Beads for High-Throughput Screening of Libraries in Synthetic Biology. ACS Synthetic Biology. https://doi.org/10.1021/acssynbio.7b00111
Gai, Y., Kim, M., Pan, M., & Tang, S. K. Y. (2017). Amphiphilic nanoparticles suppress droplet break-up in a concentrated emulsion flowing through a narrow constriction. Biomicrofluidics. https://doi.org/10.1063/1.4985158
Gillies, E. R. (2020). Reflections on the Evolution of Smart Polymers. In Israel Journal of Chemistry. https://doi.org/10.1002/ijch.201900075
Grass, R. N., Athanassiou, E. K., & Stark, W. J. (2007). Covalently functionalized cobalt nanoparticles as a platform for magnetic separations in organic synthesis. Angewandte Chemie-International Edition. https://doi.org/10.1002/anie.200700613
Hackler, A. L., Fitzgerald, F. G., Dang, V. Q., Satz, A. L., & Paegel, B. M. (2020). Off-DNA DNA-Encoded Library Affinity Screening. ACS Combinatorial Science. https://doi.org/10.1021/acscombsci.9b00153
Holtze, C., Rowat, A. C., Agresti, J. J., Hutchison, J. B., Angilè, F. E., Schmitz, C. H. J., Köster, S., Duan, H., Humphry, K. J., Scanga, R. A., Johnson, J. S., Pisignano, D., & Weitz, D. A. (2008). Biocompatible surfactants for water-in-fluorocarbon emulsions. Lab on a Chip. https://doi.org/10.1039/b806706f
Holtze, Christian, Guerra, R. E., Agresti, J., Weitz, D. A., Ahn, K., HUTCHISON, J. B., Griffiths, A., HARRAK, A. EL, MILLER, O. J., BARET, J.-C., TALY, V., RYCHELLYNCK, M., & MERTEN, C. (2008). Fluorocarbon emulsion stabilizing surfactants (Patent No. US9012390B2).
Inglese, J., Auld, D. S., Jadhav, A., Johnson, R. L., Simeonov, A., Yasgar, A., Zheng, W., & Austin, C. P. (2006). Quantitative high-throughput screening: A titration-based approach that efficiently identifies biological activities in large chemical libraries. Proceedings of the National Academy of Sciences of the United States of America. https://doi.org/10.1073/pnas.0604348103
Joseph de Rutte, Robert Dimatteo, Mark van Zee, Robert Damoiseaux, D. D. C. (2020). Massively parallel encapsulation of single cells with structured microparticles and secretion-based flow sorting. BioRxiv. https://doi.org/10.1101/2020.03.09.984245; t
Kloxin, A. M., Kasko, A. M., Salinas, C. N., & Anseth, K. S. (2009). Photodegradable hydrogels for dynamic tuning of physical and chemical properties. Science. https://doi.org/10.1126/science.1169494
MacConnell, A. B., McEnaney, P. J., Cavett, V. J., & Paegel, B. M. (2015). DNA-Encoded Solid-Phase Synthesis: Encoding Language Design and Complex Oligomer Library Synthesis. ACS Combinatorial Science. https://doi.org/10.1021/acscombsci.5b00106
MacConnell, A. B., Price, A. K., & Paegel, B. M. (2017). An Integrated Microfluidic Processor for DNA-Encoded Combinatorial Library Functional Screening. ACS Combinatorial Science. https://doi.org/10.1021/acscombsci.6b00192
Meldal, M. (1992). Pega: a flow stable polyethylene glycol dimethyl acrylamide copolymer for solid phase synthesis. Tetrahedron Letters. https://doi.org/10.1016/S0040-4039(00)79604-3
Meldal, M., & Christensen, S. F. (2010). Microparticle matrix encoding of beads. Angewandte Chemie-International Edition. https://doi.org/10.1002/anie.200906563
Ofner, A., Moore, D. G., Rühs, P. A., Schwendimann, P., Eggersdorfer, M., Amstad, E., Weitz, D. A., & Studart, A. R. (2017). High-Throughput Step Emulsification for the Production of Functional Materials Using a Glass Microfluidic Device. Macromolecular Chemistry and Physics. https://doi.org/10.1002/macp.201600472
Paegel, B. M., MacConnell, A. B., Kodadek, T., & McEnaney, P. J. (2020). Encoded Solid Phase Compound Library with Polynucleotide Based Barcoding (Patent No. US20200190507A1).
Price, A. K., MacConnell, A. B., & Paegel, B. M. (2016). HvSABR: Photochemical Dose-Response Bead Screening in Droplets. Analytical Chemistry. https://doi.org/10.1021/acs.analchem.5b04811
Raman, R., Hua, T., Gwynne, D., Collins, J., Tamang, S., Zhou, J., Esfandiary, T., Soares, V., Pajovic, S., Hayward, A., Langer, R., & Traverso, G. (2020). Light-degradable hydrogels as dynamic triggers for gastrointestinal applications. Science Advances. https://doi.org/10.1126/sciadv.aay0065
Rana, S., White, P., & Bradley, M. (1999). Synthesis of magnetic beads for solid phase synthesis and reaction scavenging. Tetrahedron Letters. https://doi.org/10.1016/S0040-4039(99)01572-5
Sievers, Q. L., Petzold, G., Bunker, R. D., Renneville, A., Slabicki, M., Liddicoat, B. J., Abdulrahman, W., Mikkelsen, T., Ebert, B. L., & Thomä, N. H. (2018). Defining the human C2H2 zinc finger degrome targeted by thalidomide analogs through CRBN. Science. https://doi.org/10.1126/science.aat0572
Tang, S., Pan, M., Lyu, F., & Derda, R. (2016). Fluorinated pickering emulsion (Patent No. US20160114325A1). USPTO.
Townsend, J., Do, A., Lehman, A., Dixon, S., Sanii, B., & Lam, K. S. (2010). 3-nitro-tyrosine as an internal quencher of autofluorescence enhances the compatibility of fluorescence based screening of OBOC combinatorial libraries. Combinatorial Chemistry & High Throughput Screening.
Toy, P. H. (2004). Tentagel™. Encyclopedia of Reagents for Organic Synthesis. https://doi.org/10.1002/047084289X.RN00470
Yanakieva, D., Elter, A., Bratsch, J., Friedrich, K., Becker, S., & Kolmar, H. (2020). FACS-Based Functional Protein Screening via Microfluidic Co-encapsulation of Yeast Secretor and Mammalian Reporter Cells. Scientific Reports. https://doi.org/10.1038/s41598-020-66927-5
Zilionis, R., Nainys, J., Veres, A., Savova, V., Zemmour, D., Klein, A. M., & Mazutis, L. (2017). Single-cell barcoding and sequencing using droplet microfluidics. Nature Protocols. https://doi.org/10.1038/nprot.2016.154

1. A continuous phase formulation for stable emulsions, comprising:
at least one fluorous dispersion oil, wherein the fluorous dispersion oil has an average fluorine content of about 70 wt % or more; and
a droplet stabilizer comprising an emulsifier selected from the group consisting of a triblock copolymer, a diblock copolymer, a fluorinated silica nanoparticle, and a combination thereof.

2. (canceled)

3. The continuous phase formulation of claim 1, wherein the fluorous dispersion oil comprises:
one or more oils selected from the group consisting of perfluorocarbons and perfluorinated oils; and/or
one or more hydrofluoroethers.

4. The continuous phase formulation of claim 3, wherein:
the total concentration of the perfluorocarbon(s) and/or perfluorinated oil(s) in the fluorous dispersion oil is about 50% w/w or more; and/or
the concentration of the one or more hydrofluoroethers in the fluorous dispersion oil is about 50% w/w or less,
and wherein
the perfluorocarbon is a perfluoroalkane selected from the group consisting of perfluorooctane, perfluoroheptane, perfluorohexane (FC-72), perfluoro-1,3-dimethyl-cyclohexane, octadecafluorodecahydronaphthalene (perfluorodecalin); and/or
the perfluorinated oil is selected from the group consisting of perfluoro 2-butyltetrahydrofuran, perfluoro-N-methylmorpholine (FC-3284), uerfluorotripentylamine (FC-70), perfluorotributylamine (FC-43), perfluorotripropylamine (FC-3283), perfluorotributylamine and perfluoro(dibutylmethylamine) mixture (FC-40); and/or
the hydrofluoroether is selected from the group consisting of 2-(trifluoromethyl)-3-ethoxydodecafluorohexane (HFE-7500), ethyl perfluorobutyl ether (HFE-7200), 3-methoxyperfluoro(2-methylpentane) (HFE7300), methyl perfluoroisobutyl ether/methyl perfluorobutyl ether mixture (HFE7100), and methoxy-nonafluorobutane (HFE7000).

5. (canceled)

6. The continuous phase formulation of claim 5, wherein the fluorous dispersion oil consists of perfluorohexane (FC-72), perfluorooctane, and 2-(trifluoromethyl)-3-ethoxydodecafluorohexane (HFE-7500), each present in an amount ranging from 10-90% w/w,
and wherein
the perfluorohexane(FC-72):perfluorooctane: 2-(trifluoromethyl)-3-ethoxydodecafluorohexane (HFE-7500) is in a 1:1:1 w/w ratio or about a 1:1:1 w/w ratio, respectively;
the perfluorohexane(FC-72):perfluorooctane: 2-(trifluoromethyl)-3-ethoxydodecafluorohexane (HFE-7500) is in a 2:2:1 w/w ratio or about a 2:2:1 w/w ratio, respectively;
or
the perfluorohexane(FC-72):perfluorooctane: 2-(trifluoromethyl)-3-ethoxydodecafluorohexane (HFE-7500) in a 1:3:1 w/w ratio or about a 1:3:1 w/w ratio, respectively.

7. (canceled)

8. The continuous phase formulation of claim 6, wherein the triblock or diblock copolymer comprises:
a perfluoropolyether (PFPE) and a polyethylene glycol (PEG);
two perfluoropolyethers (PFPEs) and a polyethylene glycol (PEG); or
two perfluoropolyethers (PFPEs), two polypropylene glycols (PPG) and a polyethylene glycol (PEG).

9. The continuous phase formulation of claim 8, wherein:
a) the diblock copolymer has the formula 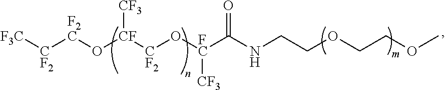
wherein n and m are exact values or average values of polydisperse building blocks, the average molecular weight of the diblock copolymer is between 1,000-10,000 Da, n is from 35-45, and m is from 2-24; and/or
b) the triblock copolymer has a formula selected from a group consisting of 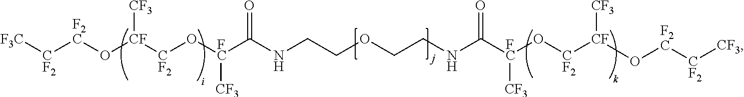
wherein i, j and k are exact values or average values of polydisperse building blocks, the average molecular weight of the triblock copolymer is between 2,000-20,000 Da, i and k are independently from 35-45, and j is 1-23, and 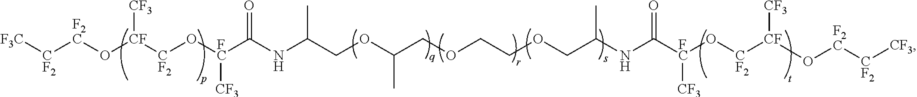
wherein p, q, r, s and t are exact values or average values of polydisperse building blocks, the average molecular weight of the triblock copolymer is between 2,000-20,000 Da, p and t are independently 35-45, q and s are each greater than zero, the exact or average of the sum q+s is 3-6, and r is 1-23.

10. The continuous phase formulation of claim 9, wherein:
the emulsifier comprises a diblock copolymer and a triblock copolymer at a ratio of about 1:1 to 1:9 (w/w), respectively; and
the diblock copolymer and triblock copolymer are present in the continuous phase formulation at a combined concentration of about 0.3-4 wt %.

11-15. (canceled)

16. A water-in-oil (w/o) single emulsion comprising an aqueous dispersed phase and a continuous phase according to claim 1, or a water-in-oil-in-water (w/o/w) double emulsion comprising an aqueous dispersed phase and a continuous phase according to claim 1.

17. (canceled)

18. The water-in-oil single emulsion according to claim 16 or the water-in-oil-in-water double emulsion according to claim 16, wherein the aqueous phase comprises an assay mixture, and barcoded compound bead.

19. The water-in-oil single emulsion or the water-in-oil-in-water double emulsion according to claim 18, wherein the bead is selected from the group consisting of a hydrogel bead, a magnetic hydrogel bead, a divinyl benzene cross-linked polystyrene bead, a low crosslinked polystyrene matrix on which polyethylene glycol is grafted, a magnetic bead, a silica bead, glass and a ceramic bead, or wherein the bead is a core-shell bead which comprises a bead encapsulated by polyacrylamide where the core is a low crosslinked polystyrene matrix on which polyethylene glycol is grafted, or the bead is a thin-shell bead which comprises a bead coated with hydrophilic polymer, where in the core is a low crosslinked polystyrene matrix on which polyethylene glycol is grafted.

20. The water-in-oil single emulsion or the water-in-oil-in-water double emulsion according to claim 19, wherein the diameter of the bead is about 1-70 microns; or the diameter of the bead is 70% or less of the diameter of the droplet diameter.

21-26. (canceled)

27. A method of preparing a monodisperse polyethylene glycol acrylamide (PEGA) co-polymer resin, comprising:
dispersing a plurality of monomers into an aqueous buffer;
combining the aqueous buffer and the plurality of monomers with a continuous phase formulation comprising an oil and a emulsifier, wherein the oil is selected from the group consisting of a fluorous oil, hydrocarbon oil, mineral oil, and silicone oil;
forming at least one microdroplet from the aqueous buffer and plurality of monomers; and
polymerizing the monomers in the at least one microdroplet to form a PEGA co-polymer resin,
wherein the monomers of the plurality of monomers comprise:
an acrylamide;
a bis-acrylamide PEG; and
a mono-acrylamide PEG comprising a functionalization handle, and/or a mono-acrylamide diamine comprising a functionalization handle.

28. (canceled)

29. The method of claim 27, wherein:
the at least one microdroplet is formed in a microfluidic device; and
forming the at least one microdroplet comprises forming, in parallel, a plurality of monodisperse microdroplets.

30-31. (canceled)

32. The method of claim 27, further comprising, linking a ligand and/or a barcode to the PEGA co-polymer resin.

33. The method of claim 32, wherein:
the ligand is reversibly linked to the PEGA co-polymer resin;
the barcode is irreversibly linked to the PEGA co-polymer resin; and
the barcode is DNA.

34. The method of claim 27, further comprising, embedding magnetic particles in the PEGA co-polymer resin by covalent linkage or by physical encapsulation, wherein the magnetic particles have a size of 1 nanometer to 10 micron in diameter.

35. The method of claim 27, wherein:
the monodisperse PEGA co-polymer resin has a diameter between 1-100 micron; or
the at least one microdroplet is a plurality of monodisperse microdroplets and the size distribution of the PEGA co-polymer resins is within a % CV of 5%.

36. The method of claim 27, wherein:
the bis-acrylamide PEG has an exact or average molecular weight of 250-5,000 Daltons; and/or
the mono-acrylamide PEG has an exact or average molecular weight of 150-5,000 Daltons.

37. The method of claim 27, wherein:
the bis-acrylamide PEG has a structure of the following Formula 7: 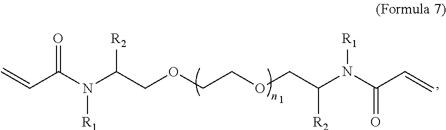
wherein in Formula 7, R₁ is H or —CH₃ and R₂ is H or —CH₃, and the exact or average n₁ is 1-108;
and
the mono-acrylamide PEG has a structure of the following Formula 8: 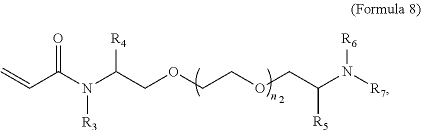
wherein in Formula 8, R₃-R₆ are independently H or —CH₃, R₇ is hydrogen, Boc or Fmoc, and the exact or average n₂ is 1-109
or
the mono-acrylamide diamine has a structure of Formula 9: 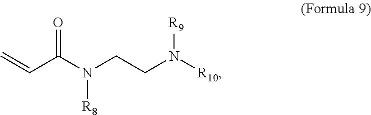
wherein in Formula 9, R₈ and R₉ are independently H or —CH₃, and R₁₀ is selected from the group consisting of H, Boc and Fmoc.

38-50. (canceled)

51. A method of preparing a thin-shell bead, comprising grafting hydrophilic polymer to the compound loaded, encoded core-bead.

52. The method of claim 51 wherein the grafted hydrophilic polymer is polyethyelene glycol.

53. The method of claim 52 wherein the polyethylene glycol is grafted through strained cyclooctyne-azide click chemistry.

54. The method of claim 52 or 53 wherein the polyethylene glycol is approximately 10,000 Daltons or larger.

55. (canceled)

56. A core-shell bead obtained by a method, comprising:
dispersing a plurality of monomers and at least one core bead into an aqueous buffer;
forming at least one microdroplet from the aqueous buffer, plurality of monomers, and core bead, wherein the at least one microdroplet includes the at least one core bead; and
polymerizing the monomers in the at least one microdroplet to form a hydrogel encapsulating the bead to form a core-shell bead.

57-68. (canceled)

69. A system for performing high throughput screening, comprising a continuous phase formulation, a solid support, and a sorter, wherein the continuous phase formulation is defined according to claim 1, and wherein the solid support is selected from the group consisting of a monodisperse polyethylene glycol acrylamide (PEGA) co-polymer resin, a thin-shelled bead and a core-shell bead, wherein:
the monodisperse polyethylene glycol acrylamide (PEGA) co-polymer resin is prepared by:
dispersing a first plurality of monomers into a first aqueous buffer;
combining the first aqueous buffer and the first plurality of monomers with a continuous phase formulation comprising an oil and an emulsifier, wherein the oil is selected from the group consisting of a fluorous oil, hydrocarbon oil, mineral oil, and silicone oil;
forming at least one first microdroplet from the first aqueous buffer and first plurality of monomers; and
polymerizing the monomers in the at least one first microdroplet to form a PEGA co-polymer resin, wherein the monomers of the first plurality of monomers comprise:
an acrylamide;
a bis-acrylamide PEG; and
a mono-acrylamide PEG comprising a functionalization handle, and/or
a mono-acrylamide diamine comprising a functionalization handle;
the core-shell bead is prepared by:
dispersing a second plurality of monomers and at least one core bead into a second aqueous buffer;
forming at least one second microdroplet from the second aqueous buffer, second plurality of monomers, and core bead, wherein the at least one second microdroplet includes the at least one core bead; and
polymerizing the monomers in the at least one second microdroplet to form a hydrogel encapsulating the core bead to form a core-shell bead;
or
the thin-shell bead is prepared by:
grafting a hydrophilic polymer onto a core bead.

70. The system for performing high throughput screening of claim 69, wherein:
the continuous phase formulation comprises:
at least one fluorous dispersion oil, wherein the fluorous dispersion oil has an average fluorine content of about 70 wt % or more; and
a droplet stabilizer comprising an emulsifier selected from the group consisting of a triblock copolymer, a diblock copolymer, a fluorinated silica nanoparticle, and a combination thereof;
the solid support is selected from the group consisting of a monodisperse polyethylene glycol acrylamide (PEGA) co-polymer resin, a thin-shell bead and a core-shell bead, wherein:
i) the monodisperse polyethylene glycol acrylamide (PEGA) co-polymer resin is prepared by:
dispersing a first plurality of monomers into a first aqueous buffer;
combining the first aqueous buffer and the first plurality of monomers with a continuous phase formulation comprising an oil and an emulsifier, wherein the oil is selected from the group consisting of a fluorous oil, hydrocarbon oil, mineral oil, and silicone oil;
forming at least one first microdroplet from the first aqueous buffer and first plurality of monomers; and
polymerizing the monomers in the at least one first microdroplet to form a PEGA co-polymer resin, wherein the monomers of the first plurality of monomers comprise:
an acrylamide;
a bis-acrylamide PEG; and
a mono-acrylamide PEG comprising a functionalization handle, and/or a mono-acrylamide diamine comprising a functionalization handle;
and
ii) the core-shell bead is prepared by:
dispersing a second plurality of monomers and at least one core bead into a second aqueous buffer;
forming at least one second microdroplet from the second aqueous buffer, second plurality of monomers, and core bead, wherein the at least one second microdroplet includes the at least one core bead; and
polymerizing the monomers in the at least one second microdroplet to form a hydrogel encapsulating the core bead to form a core-shell bead;
or
the thin-shell bead is prepared by:
grafting a hydrophilic polymer onto a core bead,
and
the sorter comprises:
an inlet channel;
first and second outlet channels meeting the inlet channel at a junction;
first and second electrodes proximate to respective first and second sides of the junction, the first and second electrodes configured to have:
a first state, in which the first electrode receives more voltage than the second electrode, that causes one or more target compositions flowing through the junction to enter the first outlet channel, and
a second state, in which the second electrode receives more voltage than the first electrode, that causes one or more target compositions flowing through the junction to enter the second outlet channel; and
a controller configured to switch the first and second electrodes between the first state and the second state.

71. The system for performing high throughput screening of claim 69, wherein:
the continuous phase formulation comprises:
at least one fluorous dispersion oil, wherein the fluorous dispersion oil has an average fluorine content of about 70 wt % or more; and
a droplet stabilizer comprising an emulsifier selected from the group consisting of a triblock copolymer, a diblock copolymer, a fluorinated silica nanoparticle, and a combination thereof;
the solid support is selected from the group consisting of a monodisperse polyethylene glycol acrylamide (PEGA) co-polymer resin, a thin-shell bead and a core-shell bead, wherein:
i) the monodisperse polyethylene glycol acrylamide (PEGA) co-polymer resin is prepared by:
dispersing a first plurality of monomers into a first aqueous buffer;
combining the first aqueous buffer and the first plurality of monomers with a continuous phase formulation comprising an oil and an emulsifier, wherein the oil is selected from the group consisting of a fluorous oil, hydrocarbon oil, mineral oil, and silicone oil;
forming at least one first microdroplet from the first aqueous buffer and first plurality of monomers; and
polymerizing the monomers in the at least one first microdroplet to form a PEGA co-polymer resin, wherein the monomers of the first plurality of monomers comprise:
an acrylamide;
a bis-acrylamide PEG; and
a mono-acrylamide PEG comprising a functionalization handle, and/or a mono-acrylamide diamine comprising a functionalization handle; and
ii) the core-shell bead is prepared by:
dispersing a second plurality of monomers and at least one core bead into a second aqueous buffer;
forming at least one second microdroplet from the second aqueous buffer, second plurality of monomers, and core bead, wherein the at least one second microdroplet includes the at least one core bead; and
polymerizing the monomers in the at least one second microdroplet to form a hydrogel encapsulating the core bead to form a core-shell bead;
or
the thin-shell bead is prepared by:
grafting a hydrophilic polymer onto a core bead;
and
the sorter comprises:
a microwell array plate configured to host one microdroplet per microwell;
a fluorescence microscope;
an imager configured to automatically image assay droplets and identify desired droplets,
and
an automated microcapillary-based droplet sampling device configured to continuously select multiple desired droplets and deposit them to hit wells.

72. (canceled)
